(19) United States
(12) Patent Application Publication
(10) Pub. No.: US 2006/0057512 A1
(43) Pub. Date: Mar. 16, 2006

(54) Photothermographic material

(75) Inventors: Seiichi Yamamoto, Kanagawa (JP); Yoshihisa Tsukada, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/212,709

(22) Filed: Aug. 29, 2005

(30) Foreign Application Priority Data
Sep. 14, 2004 (JP) 2004-267445
Jun. 9, 2005 (JP) 2005-170145

(51) Int. Cl. G03C 1/00

(52) U.S. Cl. 430/619

(57) ABSTRACT

A photothermographic material which includes, on at least one side of a support, an image forming layer containing a photosensitive silver halide, a non-photosensitive organic silver salt and a reducing agent for the organic silver salt, and at least one non-photosensitive layer, wherein the photothermographic material contains a water-soluble dye and a fixing agent for the water-soluble dye.

### CROSS-REFERENCE TO RELATED APPLICATION

This application claims priority under 35 USC 119 from Japanese Patent Application Nos. 2004-267445 and 2005-170145, the disclosures of which are incorporated by reference herein.

### BACKGROUND OF THE INVENTION

1. Field of the Invention

The present invention relates to a photothermographic material, and in particular to a photothermographic material which gives high image quality and an excellent image storability.

2. Description of the Related Art

Recently, a decrease in the amount of processing liquid waste has been strongly desired in the medical field in view of environmental conservation and space saving. In these circumstances, there is a need for technology relating to photosensitive thermal development photographic materials used for medical diagnosis and photographic technology, which photosensitive thermal development photographic materials can be efficiently exposed by a laser image setter or a laser imager, so that a clear black-toned image having high resolution and good sharpness can be formed. According to such photosensitive thermal development photographic materials, use of solution-based processing chemicals can be eliminated, and thus a thermal development processing system which is simpler and does not damage the environment can be provided to customers.

Although similar needs also exist in the field of general image forming materials, images for medical use require a high image quality excellent in sharpness and granularity because fine depiction is necessary for medical images, and further, an image of a blue-black tone is desired in view of easy diagnosis. A variety of hard copy systems including inkjet printers, electrophotographic systems and the like, wherein pigments or dyes are applied, are widely utilized as general image forming systems. However, these are not satisfactory as medical image output systems.

Thermal image forming systems in which organic silver salts are used are known. In particular, a photothermographic material generally has an image forming layer prepared by dispersing a catalytically active amount of a photocatalyst (e.g. silver halide), a reducing agent, a reducible silver salt (e.g. an organic silver salt) and, if necessary, a toner for controlling the color tone of silver, into a matrix of a binder. Such a photothermographic material forms a black silver image when heated to a high temperature (for example, 80° C. or higher) after imagewise exposure to cause an oxidation-reduction reaction between the silver halide or the reducible silver salt (functioning as an oxidizing agent) and the reducing agent. The oxidation-reduction reaction is promoted by a catalytic action of a latent image of the silver halide produced by the exposure. As a result, a black silver image is formed in an exposed region. This system is disclosed in much of the literature. The Fuji Medical Dry Imager FM-DPL (trade name) has been put on the market as a medical image forming system using a photothermographic material.

Thermal development has an advantage that any processing solution for wet development is unnecessary and the development can be simply and rapidly attained. However, thermal development still has problems to be solved which are not caused in wet development processing. One of these is a problem pertaining to dye. A dye is usually added to a photographic sensitive material in order to adjust the color tone thereof, attain filtering function, and prevent halation and irradiation.

It is important to fix the dye in a specific layer. Hitherto, a water-insoluble dye made into a fine particle solid dispersion has generally been added to the layer (see Japanese Patent Application Laid-Open (JP-A) Nos. 9-146220 and 11-228698). When a photographic photosensitive material is achromatized, an achromatizing agent is also added as a fine particle solid dispersion. In general, however, there arises the problem that the solid particles increase cloudiness of the film since the particles have a broad absorption spectrum and cause light scattering.

Hitherto, in a silver halide photosensitive material to which wet development is applied, water-soluble dyes have been used. From various dyes, an appropriate dye having a preferable absorption spectrum and a high vividness can easily be selected. From the photographic photosensitive material, the dye therein can easily be removed by discoloration with various processing solutions or the elution of the dye into the processing solutions in a wet processing step. However, photothermographic material can be colored only in a limited manner since a dye remains in the film. The water-soluble dye is not fixed in a specific layer and diffuses into layers adjacent to the layer containing the dye; therefore, the effects of preventing halation and irradiation are not effectively exhibited. Furthermore, the addition amount of the dye increases thus deteriorating residual color in the image. In particular, a dye for adjusting the color tone of the photothermographic material is used in a necessary and sufficient amount in order to render the color tone a preferred color tone. Accordingly, if coloration based on such a dye becomes uneven, the unevenness is acutely perceived as color unevenness. Thus, evenness of the coloration of the material is an important theme.

However, images obtained from photothermographic material are handled and stored in various environments. In order to make coloration based on dye constantly even under any such environment and keep the color tone of images based on the dye stable, conventional coloring methods are insufficient. Consequently, further improvement has been desired.

### SUMMARY OF THE INVENTION

In light of the above-mentioned circumstances, the present invention has been made and provides a photothermographic material which gives a high image quality and has excellent image storability.

An aspect of the invention provides a photothermographic material comprising, on at least one side of a support, an image forming layer comprising a photosensitive silver halide, a non-photosensitive organic silver salt and a reducing agent for the organic silver salt, and at least one non-photosensitive layer, wherein the photothermographic material comprises a water-soluble dye and a fixing agent for the water-soluble dye.

The color tone of images is an important property for, in particular, an image recording material for medical diagnosis. Medical diagnosis using such an image is performed on the basis of a difference or change in density or color tone in the image; therefore, image density and image color tone must be stably produced at any time and be stably maintained without being changed during storage thereof. However, a water-soluble dye used for adjustment of color tone in photothermographic materials is diffusible and is easily diffused, in particular, by water. Accordingly, the photothermographic materials are problematic in that when a formed image is subjected to attachment of water droplets thereto or is exposed to high humidity, the image becomes uneven in response to the water content. This phenomenon is rarely caused in conventional silver halide photosensitive materials which are to be wet-developed even if a dye remains therein, and is a problem peculiar to photothermographic materials. The cause therefor is unclear, but the following may be a basic cause: photothermographic materials each include, in the film thereof, all of many materials that are directly or indirectly necessary for image-formation; therefore, the protective colloid effect of the binder therein is insufficient. It is effective against color unevenness to use a hydrophobic dye, make the dye into the form of various dispersions, and incorporate the dispersions into a photothermographic material. However, it is difficult to reproduce a necessary color tone.

The inventors have made intensive efforts to succeed in the attainment of both necessary color tone and storage stability by using a water-soluble dye and a fixing agent for the dye together, and have made the above-mentioned photothermographic material, which is an aspect of the invention.

### DETAILED DESCRIPTION OF THE INVENTION

1. Photothermographic Material

The photothermographic material of the present invention is a photothermographic material including, on at least one side of a support, an image forming layer containing a photosensitive silver halide, a non-photosensitive organic silver salt and a reducing agent for the organic silver salt, and at least one non-photosensitive layer, wherein the photothermographic material contains a water-soluble dye and a fixing agent for the water-soluble dye. The fixing agent is preferably at least one selected from compounds having a tertiary amino group or a quaternary amino group, and polyvalent metal salts, and is more preferably a compound including a vinyl monomer unit having a tertiary amino group or a quaternary amino group and represented by the following formulae (FX-1), (FX-2), (FX-3) or (FX-4).

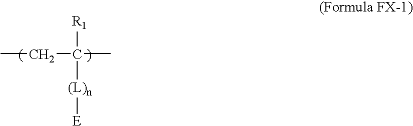

In the formula (FX-1), R₁ represents a hydrogen atom or a lower alkyl group having 1 to 6 carbon atoms; L represents a bivalent linking group having 1 to 20 carbon atoms; E represents a heterocyclic group containing, as a constituent component thereof, a nitrogen atom having a double bond to a carbon atom; and n is 0 or 1.

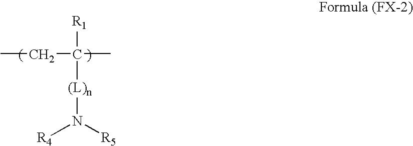

In the formula (FX-2), R₁, L and n have the same respective meanings as in the formula (FX-1); and R₄ and R₅ each independently represent an alkyl group having 1 to 12 carbon atoms, or an aralkyl group having 7 to 20 carbon atoms, and R₄ and R₅ may link to each other to form, together with a nitrogen atom, a cyclic structure.

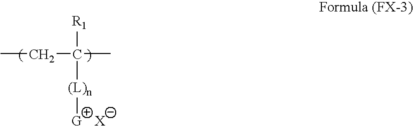

In the formula (FX-3), R₁, L and n have the same respective meanings as in the formula (FX-1); G⁺ represents a heterocycle containing, as a constituent component thereof, a quaternary nitrogen atom having a double bond to a carbon atom; and X represents a monovalent anion.

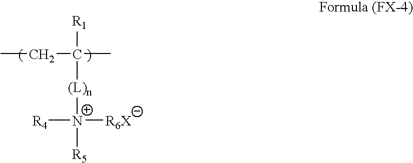

In the formula (FX-4), R₁, L and n have the same respective meanings as in the formula (FX-1); R₄ and R₅ have the same respective meanings as in the formula (FX-2); R₆ is selected from the same groups as represented by R₄ and R₅; X has the same meaning as in the formula (FX-3); and any of R₄, R₅ and R₆ may link to each other to form, together with a nitrogen atom, a cyclic structure.

The water-soluble dye and the fixing agent for the water-soluble dye are contained preferably in the image forming layer or the non-photosensitive layer, more preferably contained in a back layer.

The water-soluble dye is preferably a metal phthalocyanine dye represented by the formula (PC-1) described below.

The invention will be described in detail hereinafter.

(Water-Soluble Dye)

Examples of the water-soluble dye which can be used in the invention include azo dyes, azomethine dyes, quinone dyes (such as anthraquinone and naphthoquinone dyes), quinoline dyes (such as a quinophthalone dye), methine dyes (such as cyanine, melocyanine, oxonol, styryl, arylidene, aminobutadiene and polymethine dyes), carbonium dyes (such as cationic dyes, e.g., diphenylmethane, triphenylmethane, xanthene and acridine dyes), azine dyes (such as cationic dyes, e.g., thiazine dyes, oxazine dyes, and phenazine dyes), aza[18] π electron system dyes (such as porphin, tetraazaporphin and phthalocyanine dyes), indigoid dyes (such as indigo, and thioindigo dyes), squalilium dyes, croconium dyes, pyrromethene dyes, nitro/nitroso dyes, benzotriazol dyes, and triazine dyes. Azomethine, methine, pyrazolone or electron system dyes are preferred.

More preferred are metal phthalocyanine dyes, in particular, those represented by the following formula (PC-1).

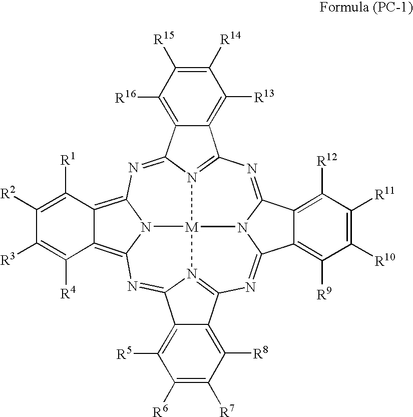

In the formula (PC-1), M represents a metal atom. The metal atom may be any metal that can form a stable complex. Examples thereof include Li, Na, K, Be, Mg, Ca, Ba, Al, Si, Cd, Hg, Cr, Fe, Co, Ni, Cu, Zn, Ge, Pd, Cd, Sn, Pt, Pb, Sr, and Mn. Preferred are Mg, Ca, Co, Zn, Pd and Cu. More preferred are Co, Pd, Zn and Cu, and even more preferred is Cu.

In the formula (PC-1), R¹, R⁴, R⁵, R⁸, R⁹, R¹², R¹³ and R¹⁶ each independently represent a hydrogen atom or a substituent. At least one of R¹, R⁴, R⁵, R⁸, R⁹, R¹², R¹³ and R¹⁶ is an electron-attracting group.

The electron-attracting group referred to herein is a group selected from halogen atoms, a cyano group, a nitro group, and groups represented by —C(═O)—R, —C(═O)—C(═O)—R, —S(═O)—R, —S(═O)₂—R, —C(═N—R′)—R, —S(═NR′)—R, —S(═NR′)₂—R, —P(═O)R₂, —O—R″, —S—R″, —N(—R′)—C(═O)—R, —N(—R′)—S(═O)—R, —N(—R′)—S(═O)₂—R, —N(—R′)—C(═N—R′)—R, —N(—R′)—S(═NR′)₂—R, and —N(—R′)—P(═O)R₂ wherein R represents a hydrogen atom, an alkyl group, an aryl group, a heterocyclic group, an amino group, an alkyloxy group, an aryloxy group, a heterocyclic oxy group, an OH group, an alkylthio group, an arylthio group, a heterocyclic thio group, or an SH group. R′ represents a hydrogen atom, an alkyl group, an aryl group, a heterocyclic group, an acyl group, a sulfonyl group, a sulfinyl group, or a phosphoryl group, and R″ represents a perfluoroalkyl group, a cyano group, an acyl group, a sulfonyl group or a sulfinyl group.

The substituent represented by each of R, R′ and R″ may be substituted, and specific examples of the substituent include halogen atoms (fluorine, chlorine, bromine and iodine atoms), alkyl groups (examples of which include aralkyl, cycloalkyl and active methine groups also), alkenyl groups, alkynyl groups, aryl groups, heterocyclic groups (the position at which the substitution is performed being arbitrary), heterocyclic groups containing a quaternary nitrogen atom (such as pyridinio, imidazolio, quinolinio, isoquinolinio groups), acyl groups, alkoxycarbonyl groups, aryloxycarbonyl groups, carbamoyl groups, carboxyl groups and salts thereof, sulfonylcarbamoyl groups, acylcarbamoyl groups, sulfamoylcarbamoyl groups, carbazoyl groups, an oxalyl group, an oxamoyl group, a cyano group, thiocarbamoyl groups, a hydroxyl group, alkoxy groups (examples of which include a group containing ethyleneoxy groups or propyleneoxy groups as repeating units), aryloxy groups, heterocyclic oxy groups, acyloxy groups, (alkoxy or aryloxy)carbonyloxy groups, carbamoyloxy groups, sulfonyloxy groups, an amino group, (alkyl, aryl or heterocyclic)amino groups, acylamino groups, sulfonamide groups, ureido groups, thioureido groups, imide groups, (alkoxy or aryloxy)carbonylamino groups, sulfamoylamino groups, semicarbazide groups, thiosemicarbazide groups, hydrazino groups, an ammonio group, oxamoylamino groups, (alkyl or aryl)sulfonylureiod groups, acylureido groups, acylsulfamoylamino groups, a nitro group, a mercapto group, (alkyl, aryl or heterocyclic)thio groups, (alkyl or aryl)sulfonyl groups, (alkyl or aryl)sulfinyl groups, a sulfo group and salts thereof, sulfamoyl groups, acylsulfamoyl groups, sulfonylsulfamoyl groups and salts thereof, groups containing a phosphoric amide or a phosphoric ester, silyloxy groups (such as trimethylsilyloxy and t-butyldimethylsilyloxy), and silyl groups (such as trimethylsilyl, t-butyldimethylsilyl, and phenyldimethylsilyl). These substituents may be further substituted with one or more out of these substituents.

In the formula (PC-1), the electron-attracting group is preferably a group represented by the following formula (II).
-L¹-R¹⁷ Formula (II)

In the formula (II), L¹ represents **—SO₂—*, **—SO₃—*, **—SO₂NR_{N}—*, **—SO—*, **—CO—*, **—CONR_{N}—*, **—COO—*, **—COCO—*,**—COC₂—*, or **—COCONR_{N}—* wherein ** means that the group links to the phthalocyanine skeleton at this position, * means that the group links to R¹⁷ at this position, and R_{N} represents a hydrogen atom, an alkyl group, an aryl group, a heterocyclic group, an acyl group, an alkoxycarbonyl group, a carbamoyl group, a sulfonyl group, or a sulfamoyl group. R_{N} may be substituted with a substituent which can be represented by R¹, R⁴, R⁵, R⁸, R⁹, R¹², R¹³ or R¹⁶ in the formula (PC-1). L¹ is preferably **—SO₂—*, **—SO₂NR—*, **—CO—*, **—CONR_{N}—*, or **—COO—*, more preferably **—SO₂—*, **—SO₂NR_{N}—*, or **—CONR_{N}—*, and even more preferably **—SO₂—*, **—SO₂NR_{N}—*.

R_{N} is preferably a hydrogen atom, an alkyl group, an aryl group or a heterocyclic group, more preferably a hydrogen atom, an alkyl group having 1 to 20 carbon atoms, an aryl group having 6 to 20 carbon atoms, or a heterocyclic group having 1 to 20 carbon atoms, even more preferably a hydrogen atom, an alkyl group having 1 to 10 carbon atoms, an aryl group having 6 to 10 carbon atoms, or a heterocyclic group having 1 to 10 carbon atoms, and even more preferably a hydrogen or an alkyl group having 1 to 6 carbon atoms.

R¹⁷ represents a hydrogen atom, an alkyl group, an aryl group or a heterocyclic group. When R¹⁷ is an alkyl group, an aryl group or a heterocyclic group, R¹⁷ may be substituted with a substituent which can be represented by R¹, R⁴, R⁵, R⁸, R⁹, R¹², R¹³ or R¹⁶ in the formula (PC-1). R¹⁷ is preferably an alkyl group or an aryl group, and more preferably an alkyl group. R¹⁷ has 1 to 30 carbon atoms, preferably 1 to 20 carbon atoms, and more preferably 1 to 10 carbon atoms.

R¹⁷ is preferably substituted with a hydrophilic group. The hydrophilic group herein is a carboxyl group, a sulfo group, a phosphoric acid group, a group having a quaternary salt structure of nitrogen, a group having a quaternary salt structure of phosphorus, or a polyethyleneoxy group. When the hydrophilic group is a carboxyl group, a sulfo group or a phosphate group, the hydrophilic group may have a counter ion if necessary. The counter ion may be a metal cation, an ammonium ion, a group having a quaternary salt structure of nitrogen, or a group having a quaternary salt structure of phosphorus.

When the hydrophilic group is a group having a quaternary salt structure of nitrogen or a group having a quaternary salt structure of phosphorus, the hydrophilic group may have a counter anion if necessary. The counter ion may be, for example, a halogen ion, a sulfate ion, a nitrate ion, a phosphate ion, an oxalate ion, an alkanesulfonate ion, an arylsulfonate ion, an alkanecarboxylate ion, an arylcarboxylate ion or the like. The hydrophilic group is preferably a carboxyl group, a sulfo group, or a phosphate group, and more preferably a carboxyl group or a sulfo group. In this case, the counter ion is preferably Li⁺, Na⁺, K⁺, Mg²⁺, Ca²⁺ or NH₄⁺, more preferably Li⁺, Na⁺, K³⁰ , or NH₄⁺, and even more preferably Li⁺ or Na⁺.

When R¹, R⁴, R⁵, R⁸, R⁹, R¹², R¹³ or R¹⁶ is a substituent in the formula (PC-1), the substituent may be a substituent selected from the groups of the same substituents as can be represented by R, R′ and R″ in the formula (PC-1). These substituents may be further substituted with one or more out of these substituents.

Preferred examples of the substituent include halogen atoms, alkyl groups, alkenyl groups, alkynyl groups, aryl groups, heterocyclic groups (the position at which the substitution is performed being arbitrary), heterocyclic groups containing a quaternary nitrogen atom (such as pyridinio, imidazolio, quinolinio, isoquinolinio groups), acyl groups, alkoxycarbonyl groups, aryloxycarbonyl groups, carbamoyl groups, carboxy groups and salts thereof, sulfonylcarbamoyl groups, acylcarbamoyl groups, sulfamoylcarbamoyl groups, carbazoyl groups, an oxalyl group, an oxamoyl group, a cyano group, thiocarbamoyl groups, sulfonyloxy groups, imide groups, sulfamoylamino groups, semicarbazide groups, thiosemicarbazide groups, a nitro group, (alkyl or aryl)sulfonyl groups, (alkyl or aryl)sulfinyl groups, a sulfo group and salts thereof, sulfamoyl groups, acylsulfamoyl groups, sulfonylsulfamoyl groups and salts thereof, and groups containing a phosphoric amide or phosphorus ester structure. More preferred examples thereof include alkyl groups, aryl groups, heterocyclic groups, acyl groups, alkoxycarbonyl groups, carbamoyl groups, carboxy groups and salts thereof, an oxalyl group, an oxamoyl group, a cyano group, imide groups, sulfamoylamino groups, (alkyl or aryl)sulfonyl groups, (alkyl or aryl)sulfinyl groups, a sulfo group and salts thereof, sulfamoyl groups, acylsulfamoyl groups, and sulfonylsulfamoyl groups and salts thereof,

Even more preferred examples of the substituent include aryl groups, heterocyclic groups, acyl groups, alkoxycarbonyl groups, carbamoyl groups, carboxy groups and salt thereof, (alkyl or aryl)sulfonyl groups, (alkyl or aryl)sulfinyl groups, a sulfo group and salts thereof, and sulfamoyl groups.

Preferably, four or more out of R¹, R⁴, R⁵, R⁸, R⁹, R¹², R¹³ and R¹⁶ in the compound represented by the formula (PC-1) are each a group represented by the formula (II). More preferably, at least one companion of each of a pair of R¹ and R⁴, that of R⁵ and R⁸, that of R⁹ and R¹² and that of R¹³ and R¹⁶ is a group represented by the formula (II). Even more preferably, one companion of each of the pair of R¹ and R⁴, that of R⁵ and R⁸, that of R⁹ and R¹² and that of R¹³ and R¹⁶ is a group represented by the formula (II), and the other companion is a hydrogen atom. When groups represented by the formula (II) are contained in the same molecule, the groups may be the same or different.

In the formula (PC-1), R², R³, R⁶, R⁷, R¹⁰, R¹¹, R¹⁴ and R¹⁵ each independently represent a hydrogen atom or a substituent. The substituent referred to herein is selected from the same substituents as can be represented by R¹, R⁴, R⁵, R⁸, R⁹, R¹², R¹³ and R¹⁶ in the formula (PC-1).

R¹, R⁴, R⁵, R⁸, R⁹, R¹², R¹³ and R¹⁶ are each preferably a hydrogen atom, a halogen atom, a carboxyl group, an alkoxycarbonyl group, an acyl group, a sulfo group, a sulfamoyl group, a sulfonyl group, an alkyl group, an aryl group, or a heterocyclic group; more preferably a hydrogen atom, a halogen atom, a sulfo group, a sulfamoyl group, or a sulfonyl group; and even more preferably a hydrogen atom, a sulfo group, or a halogen atom.

A phthalocyanine compound having plural substituents generally may have positional isomers, which are different from each other in the position to which the substituents are bonded.

The compound represented by the formula (PC-1) in the invention is not exceptional, either, and can have several positional isomers as the case may be. In the invention, the phthalocyanine compound may be used as a single compound or may be used as a mixture of positional isomers thereof. When the phthalocyanine compound is used as a mixture of positional isomers thereof, the number of the mixed isomers, the substitution position of the substituents in each of the positional isomers and the blend ratio between the positional isomers are each arbitrary.

The following illustrates examples of the compound represented by the formula (PC-1) used in the invention, but the compound is not limited to the following examples in the invention. In the compound examples, any mixture of positional isomers is illustrated as a single compound.

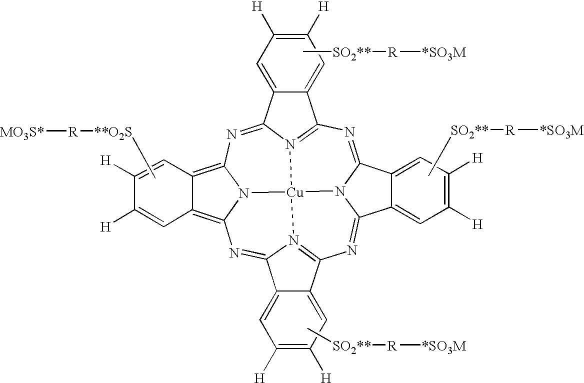

| | Exemplary compounds | | |
|---|---|---|---|
| | M = Li | M = Na | M = K |
| **—R—* = **—CH₂CH₂—* | 1 | 10 | 19 |
| **—CH₂CH₂CH₂—* | 2 | 11 | 20 |
| **—CH₂CH₂CH₂CH₂—* | 3 | 12 | 21 |
| **—CH₂CH₂CH₂CH₂CH₂—* | 4 | 13 | 22 |
| **—CH₂CH₂—(OCH₂CH₂)n—* | | | |
| n = 1 | 5 | 14 | 23 |
| 2 | 6 | 15 | 24 |
| 3 | 7 | 16 | 25 |
| 4 | 8 | 17 | 26 |
| 5 | 9 | 18 | 27 |
| | Exemplary compounds | | |
| | M = Li | M = Na | |
| 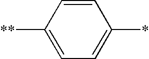 | 28 | 31 | |
| 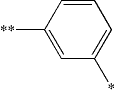 | 29 | 32 | |
| 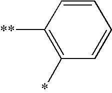 | 30 | 33 | |
| 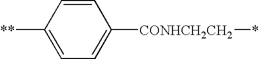 | 34 | 37 | |
| 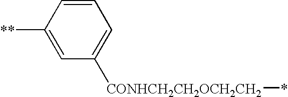 | 35 | 38 | |
| 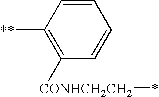 | 36 | 39 | |

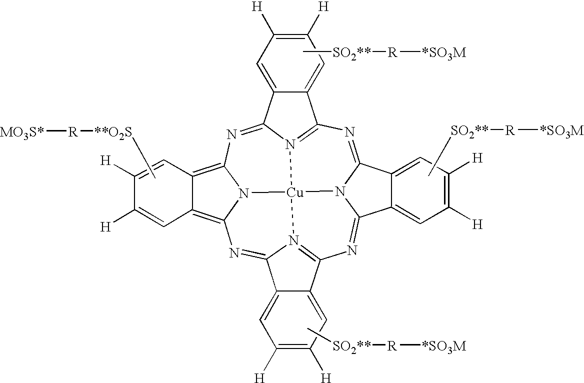

| | Exemplary compounds | |
|---|---|---|
| **—R—* = **—CH₂CH₂—* | 40 | M = Li & NH₄ (Li/NH₄ = 3/1) |
| | 41 | M = Li & NH₄ (Li/NH₄ = 2/2) |
| | 42 | M = Na & NH₄ (Na/NH₄ = 3/1) |
| | 43 | M = Na & NH₄ (Na/NH₄ = 2/2) |
| | 44 | M = Na & NH₄ (Na/NH₄ = 1/3) |
| **—CH₂CH₂CH₂—* | 45 | M = Li & NH₄ (Li/NH₄ = 3/1) |
| | 46 | M = Li & NH₄ (Li/NH₄ = 2/2) |
| | 47 | M = Li & NH₄ (Li/NH₄ = 1/3) |
| | 48 | M = Na & NH₄ (Na/NH₄ = 3/1) |
| | 49 | M = Na & NH₄ (Na/NH₄ = 2/2) |
| | 50 | M = Na & NH₄ (Na/NH₄ = 1/3) |
| | 51 | M = K & NH₄ (K/NH₄ = 3/1) |
| | 52 | M = K & NH₄ (K/NH₄ = 2/2) |
| | 53 | M = K & NH₄ (K/NH₄ = 1/3) |
| | 54 | M = Et₄N |
| **—CH₂CH₂CH₂CH₂—* | 55 | M = Li & NH₄ (Li/NH₄ = 3/1) |
| | 56 | M = Li & NH₄ (Li/NH₄ = 2/2) |
| | 57 | M = Na & NH₄ (Na/NH₄ = 3/1) |
| | 58 | M = Na & NH₄ (Na/NH₄ = 2/2) |
| | 59 | M = Na & NH₄ (Na/NH₄ = 1/3) |

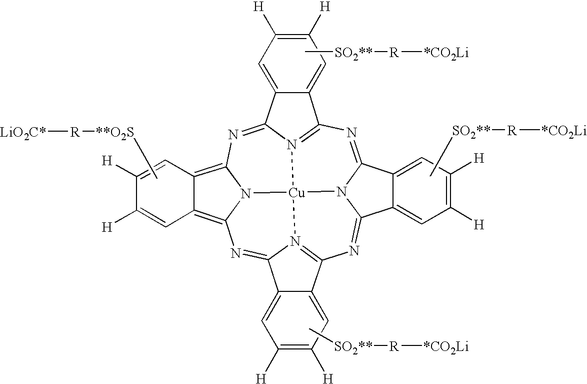

| | Exemplary compounds |
|---|---|
| **—R—* = **—CH₂CH₂—* | 60 |
| **—CH₂CH₂CH₂—* | 61 |
| **—CH₂CH₂CH₂CH₂—* | 62 |
| **—CH₂CH₂CH₂CH₂CH₂—* | 63 |
| **—CH₂CH₂—(OCH₂CH₂)n—* | 64 |
| n = 1 | 65 |
| 2 | 66 |
| 3 | 67 |
| 4 | 68 |
| 5 | 69 |
| 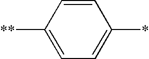 | 70 |
| 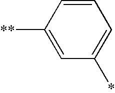 | 71 |
| 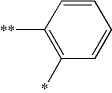 | 72 |
| 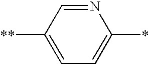 | 73 |
| 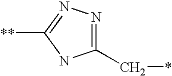 | 74 |
| 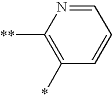 | 75 |

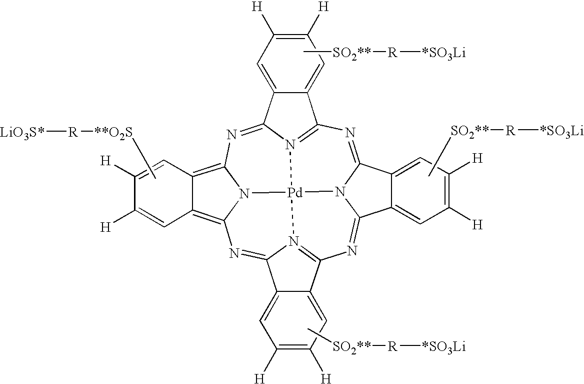

| | Exemplary compounds |
|---|---|
| **—R—* = **—CH₂CH₂—* | 76 |
| **—CH₂CH₂CH₂—* | 77 |
| **—CH₂CH₂CH₂CH₂—* | 78 |
| **—CH₂CH₂CH₂CH₂CH₂—* | 79 |
| **—CH₂CH₂—(OCH₂CH₂)n—* | |
| n = 1 | 80 |
| 2 | 81 |
| 3 | 82 |
| 4 | 83 |
| 5 | 84 |
| 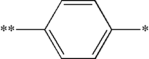 | 85 |
| 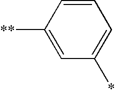 | 86 |
| 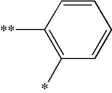 | 87 |
| 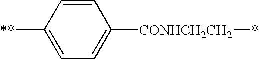 | 88 |
| 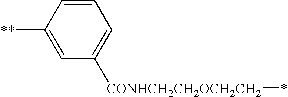 | 89 |
| 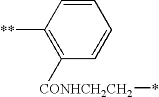 | 90 |

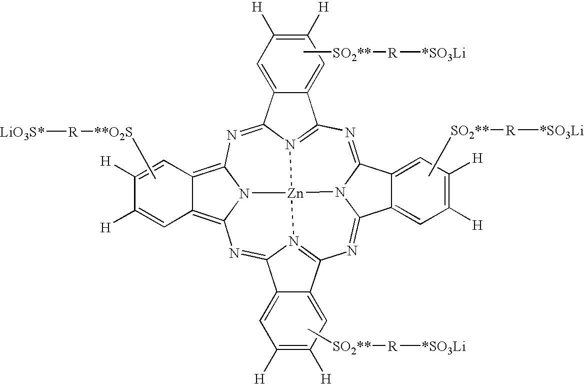

| | Exemplary compounds |
|---|---|
| **—R—* = **—CH₂CH₂—* | 91 |
| **—CH₂CH₂CH₂—* | 92 |
| **—CH₂CH₂CH₂CH₂—* | 93 |
| **—CH₂CH₂CH₂CH₂CH₂—* | 94 |
| **—CH₂CH₂—(OCH₂CH₂)n—* | |
| n = 1 | 95 |
| 2 | 96 |
| 3 | 97 |
| 4 | 98 |
| 5 | 99 |
| 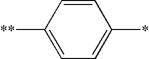 | 100 |
| 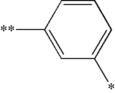 | 101 |
| 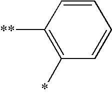 | 102 |
| 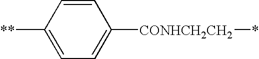 | 103 |
| 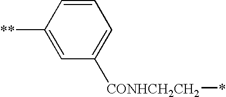 | 104 |
| 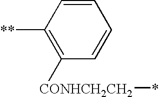 | 105 |

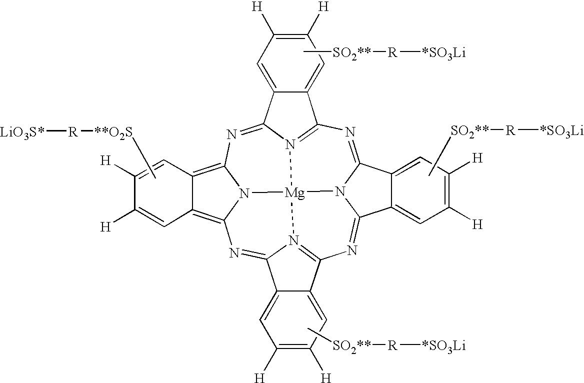

| | Exemplary compounds |
|---|---|
| **—R—* = **—CH₂CH₂—* | 106 |
| **—CH₂CH₂CH₂—* | 107 |
| **—CH₂CH₂CH₂CH₂—* | 108 |
| **—CH₂CH₂CH₂CH₂CH₂—* | 109 |
| **—CH₂CH₂—(OCH₂CH₂)n—* | |
| n = 1 | 110 |
| 2 | 111 |
| 3 | 112 |
| 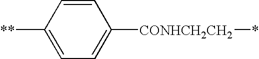 | 113 |
| 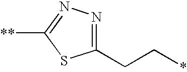 | 114 |
| 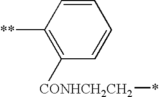 | 115 |

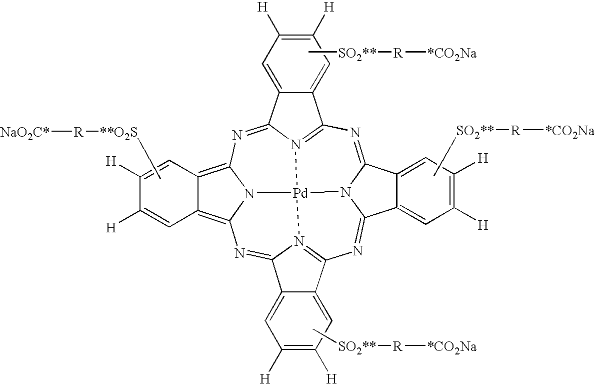

| | Exemplary compounds |
|---|---|
| **—R—* = **—CH₂CH₂CH₂—* | 116 |
| **—CH₂CH₂CH₂CH₂—* | 117 |
| **—CH₂CH₂CH₂CH₂CH₂—* | 118 |
| **—CH₂CH₂—(OCH₂CH₂)n—* | |
| n = 1 | 119 |
| 2 | 120 |
| 3 | 121 |
| 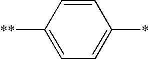 | 122 |
| 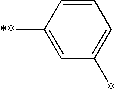 | 123 |
| 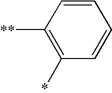 | 124 |
| 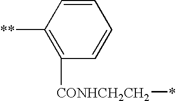 | 125 |

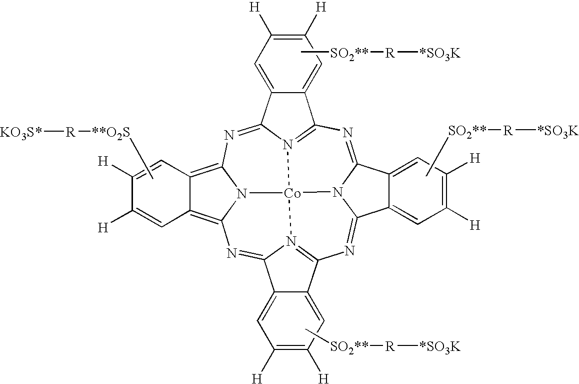

| | Exemplary compounds |
|---|---|
| **—R—* = **—CH₂CH₂CH₂—* | 126 |
| **—CH₂CH₂CH₂CH₂—* | 127 |
| **—CH₂CH₂CH₂CH₂CH₂—* | 128 |
| **—CH₂CH₂—(OCH₂CH₂)n—* | |
| n = 1 | 129 |
| 2 | 130 |
| 3 | 131 |
| 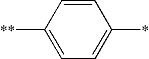 | 132 |
| 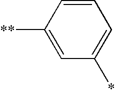 | 133 |
| 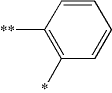 | 134 |
| 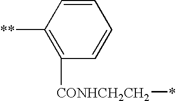 | 135 |

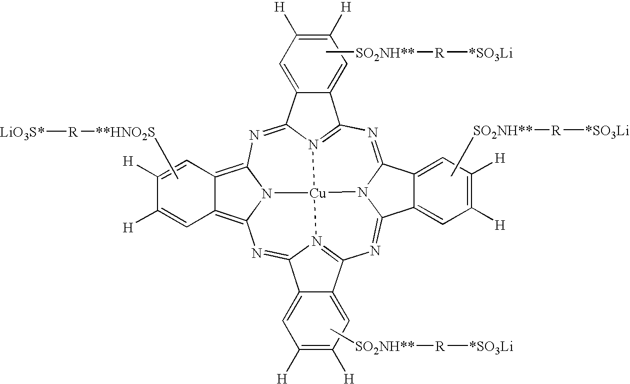

| | Exemplary compounds |
|---|---|
| **—R—* = **—CH₂CH₂—* | 136 |
| **—CH₂CH₂CH₂—* | 137 |
| **—CH₂CH₂CH₂CH₂—* | 138 |
| **—CH₂CH₂CH₂CH₂CH₂—* | 139 |
| **—CH₂CH₂—(OCH₂CH₂)n—* | |
| n = 1 | 140 |
| 2 | 141 |
| 3 | 142 |
| 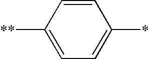 | 143 |
| 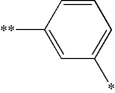 | 144 |
| 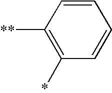 | 145 |
| 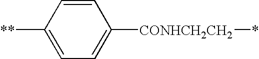 | 146 |
| 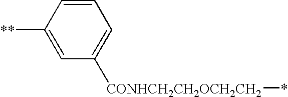 | 147 |
| 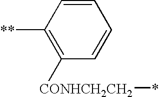 | 148 |

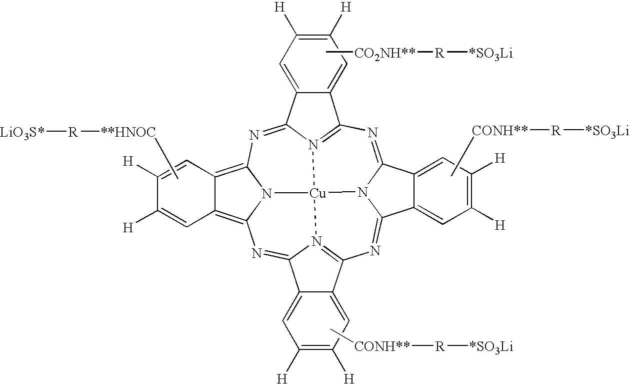

| | Exemplary compounds |
|---|---|
| **—R—* = **—CH₂CH₂—* | 149 |
| **—CH₂CH₂CH₂—* | 150 |
| **—CH₂CH₂CH₂CH₂—* | 151 |
| **—CH₂CH₂CH₂CH₂CH₂—* | 152 |
| **—CH₂CH₂—(OCH₂CH₂)n—* | |
| n = 1 | 153 |
| 2 | 154 |
| 3 | 155 |
| 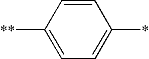 | 156 |
| 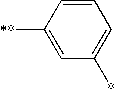 | 157 |
| 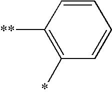 | 158 |
| 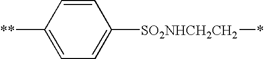 | 159 |
| 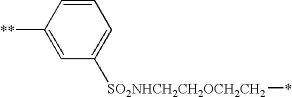 | 161 |
| 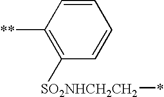 | 162 |

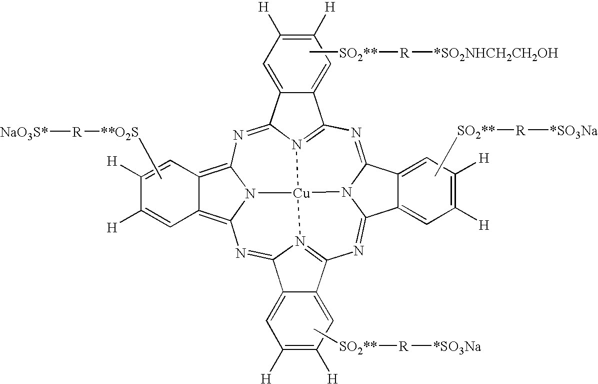

| | Exemplary compounds |
|---|---|
| **—R—* = **—CH₂CH₂CH₂—* | 163 |
| **—CH₂CH₂CH₂CH₂—* | 164 |
| **—CH₂CH₂CH₂CH₂CH₂—* | 165 |
| **—CH₂CH₂—(OCH₂CH₂)n—* | |
| n = 1 | 166 |
| 2 | 167 |
| 3 | 168 |
| 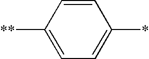 | 169 |
| 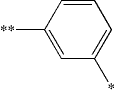 | 170 |
| 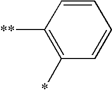 | 171 |
| 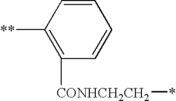 | 172 |

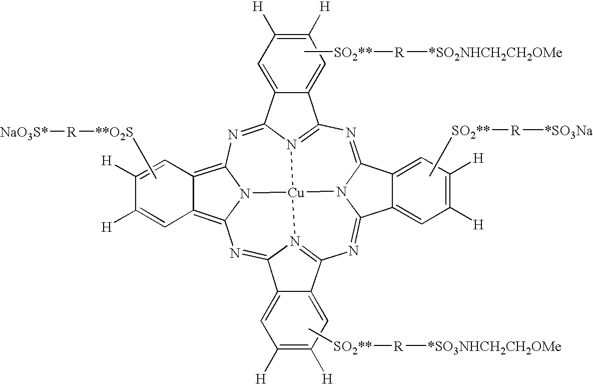

| | Exemplary compounds |
|---|---|
| **—R—* = **—CH₂CH₂CH₂—* | 173 |
| **—CH₂CH₂CH₂CH₂—* | 174 |
| **—CH₂CH₂CH₂CH₂CH₂—* | 175 |
| **—CH₂CH₂—(OCH₂CH₂)n—* | |
| n = 1 | 176 |
| 2 | 177 |
| 3 | 178 |
| 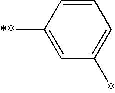 | 179 |
| 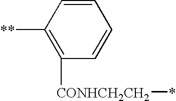 | 180 |

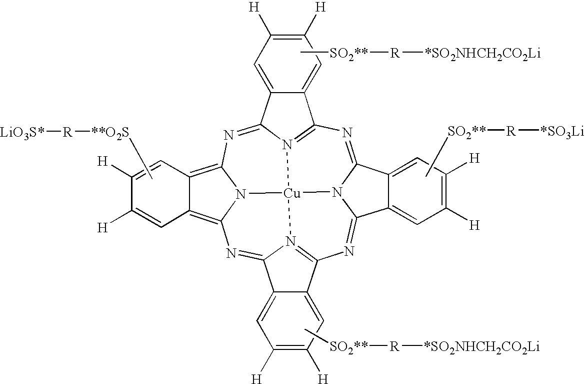

| | Exemplary compounds |
|---|---|
| **—R—* = **—CH₂CH₂CH₂—* | 181 |
| **—CH₂CH₂CH₂CH₂—* | 182 |
| **—CH₂CH₂CH₂CH₂CH₂—* | 183 |
| **—CH₂CH₂—(OCH₂CH₂)n—* | |
| n = 1 | 184 |
| 2 | 185 |
| 3 | 186 |
| 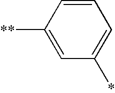 | 187 |
| 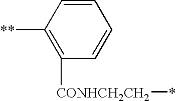 | 188 |

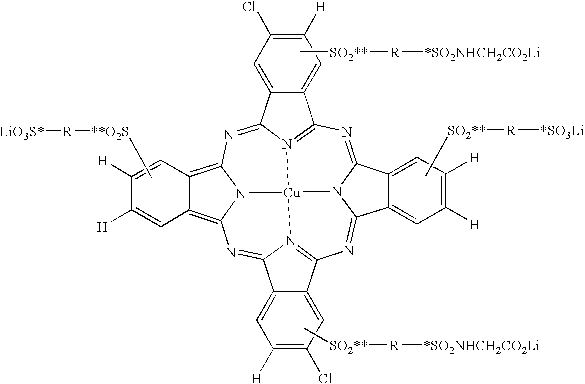

| | Exemplary compounds |
|---|---|
| **—R—* = **—CH₂CH₂CH₂—* | 189 |
| **—CH₂CH₂CH₂CH₂—* | 190 |
| **—CH₂CH₂CH₂CH₂CH₂—* | 191 |
| 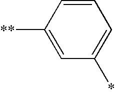 | 192 |
| 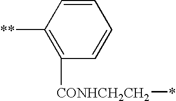 | 193 |

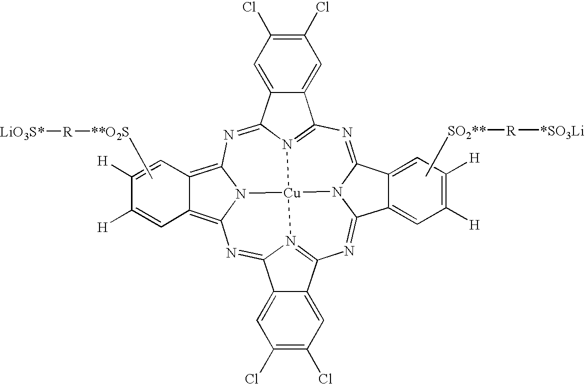

| | Exemplary compounds |
|---|---|
| **—R—* = **—CH₂CH₂CH₂—* | 194 |
| **—CH₂CH₂CH₂CH₂—* | 195 |
| **—CH₂CH₂CH₂CH₂CH₂—* | 196 |
| 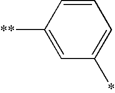 | 197 |
| 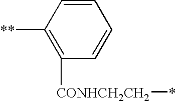 | 198 |

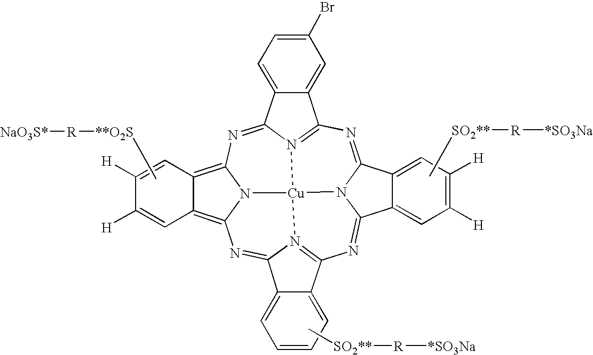

| | Exemplary compounds |
|---|---|
| **—R—* = **—CH₂CH₂CH₂—* | 199 |
| **—CH₂CH₂CH₂CH₂—* | 200 |
| **—CH₂CH₂CH₂CH₂CH₂—* | 201 |

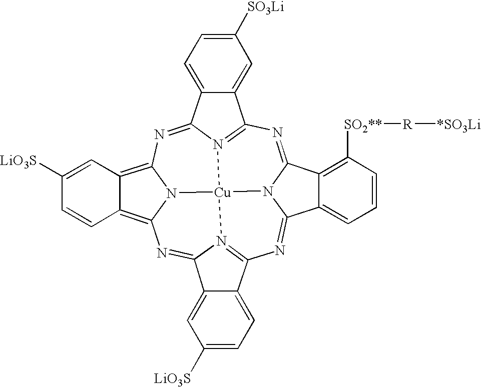

| | Exemplary compounds |
|---|---|
| **—R—* = **—CH₂CH₂CH₂—* | 202 |
| **—CH₂CH₂CH₂CH₂—* | 203 |
| **—CH₂CH₂CH₂CH₂CH₂—* | 204 |
| 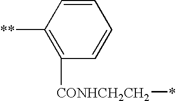 | 205 |

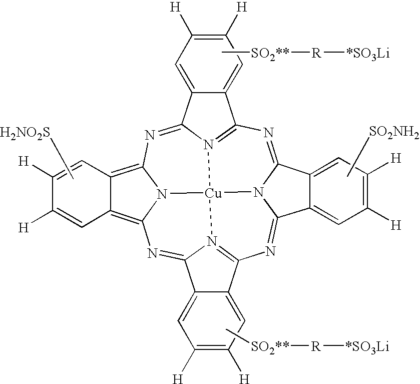

| | Exemplary compounds |
|---|---|
| **—R—* = **—CH₂CH₂—* | 206 |
| **—CH₂CH₂CH₂—* | 207 |
| **—CH₂CH₂CH₂CH₂—* | 208 |
| **—CH₂CH₂CH₂CH₂CH₂—* | 209 |
| **—CH₂CH₂—(OCH₂CH₂)n—* | |
| n = 1 | 210 |
| 2 | 211 |
| 3 | 212 |

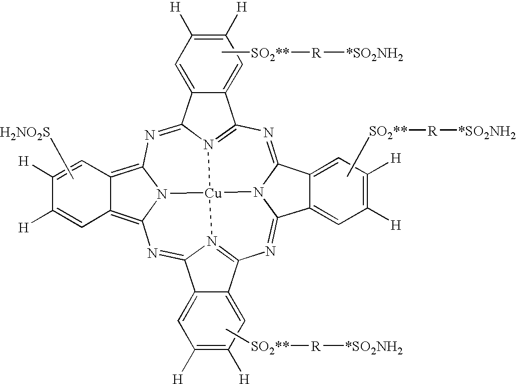

| | Exemplary compounds |
|---|---|
| **—R—* = **—CH₂CH₂—* | 213 |
| **—CH₂CH₂CH₂—* | 214 |
| **—CH₂CH₂CH₂CH₂—* | 215 |
| **—CH₂CH₂CH₂CH₂CH₂—* | 216 |
| **—CH₂CH₂—(OCH₂CH₂)n—* | |
| n = 1 | 217 |
| 2 | 218 |
| 3 | 219 |

<Synthesis of the Exemplary Compound 2>

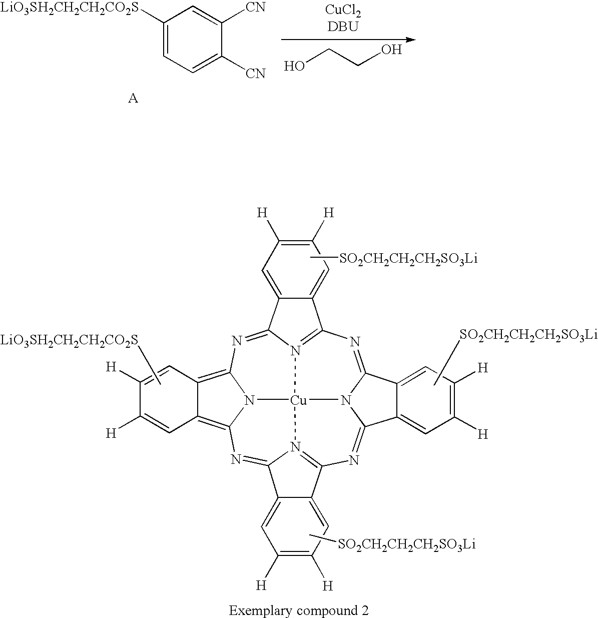

CuCl₂ (134 mg, 1 mmol) was added to a solution (10 mL) of a synthesis intermediate A (1.26 g, 4 mmol) in ethylene glycol, and the resultant was heated to 100° C. DBU (1.52 g, 10 mmol) was added to the reaction mixture, and the mixture was stirred at 100° C. for 10 hours. The reaction mixture was acidified with hydrochloric acid, and LiCl was added thereto so that a crude phthalocyanine product precipitated. The thus-obtained crude product was purified by column chromatography wherein Sephadex G-15 was used as a carrier, so as to yield 67 mg of a mixture of the exemplary compound 2 (yield: 5%).

<Adding Method>

The phthalocyanine compound of the invention is preferably water-soluble. The water-soluble phthalocyanine compound is preferably used as an aqueous solution prepared previously with water solvent at the production of photothermographic material. In the aqueous solution, the water-soluble phthalocyanine compound of the invention is contained in a range from 0.1% by mass to 30% by mass, preferably from 0.5% by mass to 20% by mass, and more preferably from about 1% by mass to 8% by mass. The aqueous solution may further contain water-soluble organic solvent or an auxiliary additive. As for water-soluble organic solvent, the content is about 0% by mass to 30% by mass, preferably 5% by mass to 30% by mass, and as for auxiliary additive, 0% by mass to 5% by mass, preferably 0% by mass to 2% by mass.

Specific examples of water-soluble organic solvent, which can be used at preparing an aqueous solution of water-soluble phthalocyanine compound according to the invention, include alkanols having 1 to 4 carbon atoms such as methanol, ethanol, propanol, isopropanol, butanol, isobutanol, sec-butanol, tert-butanol and the like, carboxylic amides such as N,N-dimethylformamide, N,N-dimethylacetamide and the like, lactams such as ε-caprolactam, N-methylpyrrolidine-2-one and the like, ureas, cyclic ureas such as 1,3-dimethylimidazolidine-2-one, 1,3-dimethylhexahydropyrnmide-2-one and the like, ketones or ketoalcohols such as acetone, methylethylketone, 2-methyl-2-hydroxypentan-4-one and the like, ethers such as tetrahydrofuran, dioxane and the like, monomers, oligomer or polyalkylene glycol or thioglycol having alkylene unit with 2 to 6 carbon atoms such as ethylene glycol, 1,2- or 1,3-propylene glycol, 1,2- or 1,4-butylene glycol, 1,6-hexylene glycol, diethylene glycol, triethylene glycol, dipropylene glycol, thiodiglycol, polyethylene glycol, polypropylene glycol and the like, polyol(triol) such as glycerin, hexane-1,2,6-triol and the like, alkylether having 1 to 4 carbon atoms of polyhydric alcohol such as ethylene glycol monomethyl ether, ethylene glycol monoethyl ether, diethylene glycol monomethyl ether, diethylene glycol monoethyl ether, triethylene glycol monomethyl ether, triethylene glycol monoethyl ether and the like, γ-butylolactone, dimethyl sulfoxide, and the like. Two or more kinds of these water-soluble organic solvents may be used in combination.

Among the aforementioned water-soluble organic solvents, urea, N-methylpyrrolizine-2-one, and mono, di, or trialkylene glycol having an alkylene unit with 2 to 6 carbon atoms are preferable, and more preferably used are mono, di, or triethylene glycol, dipropylene glycol, dimethyl sulfoxide and the like. Particularly, N-methylpyrrolidine-2-one, diethylene glycol, dimethyl sulfoxide, and urea are used preferably, and urea is especially preferable. Since the aqueous solution of the phthalocyanine compound of the invention is further diluted with other agents at the production of photothermographic material, a method of adding 1 to 500 mol of water-soluble organic solvent per 1 mol of the water-soluble metal phthalocyanine compound is also preferably used.

As the auxiliary additive, for example, an antiseptic agent, a pH control agent, a chelating agent, an antistain agent, a water-soluble ultraviolet ray absorbent, a water-soluble polymer, a dye solvent, a surfactant, and the like are added respectively, when necessary.

As the antiseptic agent, for example, sodium dehydroacetate, sodium sorbinate, sodium 2-pyridinethiol-1-oxide, sodium benzoate, sodium pentachloro phenol, benzoisothiazolinone and a salt thereof, p-hydroxybenzoic acid esters and the like can be used.

As the pH control agent, any compounds can be applied so long as they can control the pH of the prepared solution in a range of 4 to 11 without any bad effect. Preferred examples of the pH control agent include alkanolamines such as diethanolamine and triethanol amine, hydroxide of alkali metal such as lithium hydroxide, sodium hydroxide, and potassium hydroxide, and carbonate of alkali metal such as lithium carbonate, sodium carbonate, and potassium carbonate.

As the chelating agent, for example, sodium salts of ethylenediaminetetraacetic acid, sodium salts of nitrilotriacetic acid, sodium salts of hydroxyethyl ethylenediaminetriacetic acid, sodium salts of diethylene triaminepentaacetic acid, sodium salts of uracil diacetic acid and the like can be described. As the antistain agent, for example, hyposulfites, sodium thiosulfate, thioglycolic acid ammonium salt, diisopropyl ammonium nitrite, pentaerydirithol tetranitrate, and dicyclohexylammonium nitrite and the like can be described. As the water-soluble polymer, for example, polyvinyl alcohol, cellulose derivatives, polyamines, and polyimines and the like can be described. As the water-soluble ultraviolet ray absorbent, for example, sulfonated benzophenones, sulfonated benzotriazoles and the like can be described. As for the dye solvent, for example, ε-caprolactam, ethylene carbonate, urea and the like can be described. As the surfactant, for example, known surfactants such as anionic, cationic and nonionic surfactant and the like can be described, and surfactant of acetyleneglycols and the like are also used preferably.

<Layer to Which the Metal Phthalocyanine Compound was to be Added>

The metal phthalocyanine compound in the invention is incorporated preferably into the image forming layer or the non-photosensitive layer, more preferably into the non-photosensitive layer which is a back layer.

<Range of Addition Amount>

In connection with the addition amount of the dye in the invention, the optical density of the dye alone is preferably from 0.1 to 0.8, more preferably from 0.2 to 0.6 at an absorption maximum wavelength of the dye. The coating amount of the dye for giving such an optical density is generally from about 10 mg/m²to 150 mg/m², preferably from about 20 mg/m²to 80 mg/m².

(Fixing Agent)

There is no particular restriction on the fixing agent used in the invention, which may be referred to as the “dye fixing agent” hereinafter. Preferable examples of the fixing agent include a compound having a tertiary amino group or a quaternary amino group, and more preferably a polymer compound comprising a vinyl monomer unit having a tertiary amino group or a quaternary amino group and represented by the following formulae (FX-1), (FX-2), (FX-3) or (FX-4).

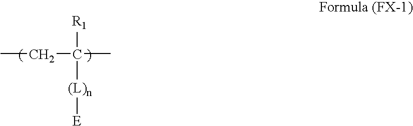

In the formula (FX-1), R₁ represents a hydrogen atom or a lower alkyl group having 1 to 6 carbon atoms; L represents a bivalent linking group having 1 to 20 carbon atoms; E represents a heterocyclic group containing, as a constituent component thereof, a nitrogen atom having a double bond to a carbon atom; and n is 0 or 1.

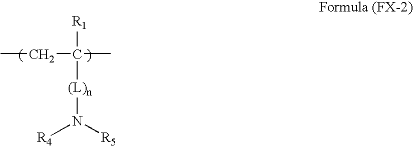

In the formula (FX-2), R₁, L and n have the same respective meanings as in the formula (FX-1); and R₄ and R₅ each independently represent an alkyl group having 1 to 12 carbon atoms, or an aralkyl group having 7 to 20 carbon atoms, and R₄ and R₅ may link to each other to form, together with a nitrogen atom, a cyclic structure.

In the formulae (FX-1) and (FX-2), R₁ preferably represents, a hydrogen atom, a methyl group, an ethyl group, a n-butyl group, a n-amyl group, a n-hexyl group or the like, and more preferably represents a hydrogen atom or a methyl group.

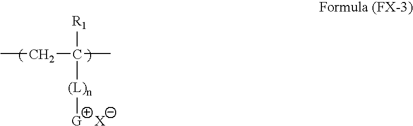

In the formula (FX-3), R₁, L and n have the same respective meanings as in the formula (FX-1); G⁺ represents a heterocycle containing, as a constituent component thereof, a quaternary nitrogen atom having a double bond to a carbon atom; and X represents a monovalent anion.

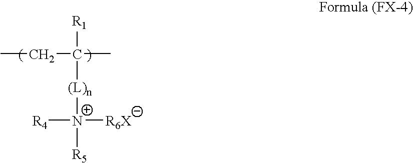

In the formula (FX-4), R₁, L and n have the same respective meanings as in the formula (FX-1); R₄ and R₅ have the same meanings as in the formula (FX-2); R₆ is selected from the same groups as represented by R₄ and R₅. X has the same meaning as in the formula (VI); and any of R₄, R₅ and R₆ may link to each other to form, together with a nitrogen atom, a cyclic structure.

L preferably represents an alkylene group (such as a methylene, ethylene, trimethylene or hexamethylene group); a phenylene group (such as an o-phenylene, p-phenylene, or m-phenylene group); an arylenealkylene group represented by any one of the following formulae: 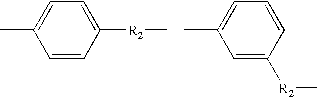
wherein R₂ represents an alkylene group having 1 to about 12 carbon atoms, a —CO₂— group; a —CO₂—R₃— group wherein R₃ represents an alkylene, phenylene or arylenealkylene group; a —CONH—R₃— group wherein R₃ has the same meaning as described above; an acylamino group represented by the following formula: 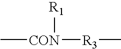
wherein R₁ and R₃ have the same respective meanings as described above; or some other group.

L is more preferably a bivalent group represented by any one of the following formulae.

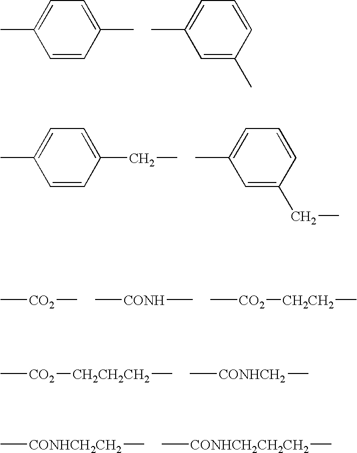

In the formula (FX-1), E represents a heterocyclic group containing, as a constituent component thereof, a nitrogen atom having a double bond to a carbon atom, and preferably represents an imidazole ring, a triazole ring, a pyrazole ring, a pyridine ring, a pyrimidine ring or the like (examples thereof are shown below), and more preferably represents an Imidazole ring, a pyridine ring.

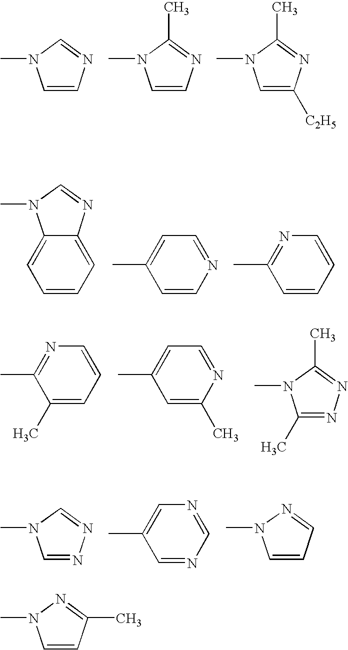

Preferred specific examples of the polymer which comprises a vinyl monomer unit having a tertiary amino group and represented by the formula (FX-1) include polymers described in U.S. Pat. Nos. 4,282,305, 4,115,124, and 3,148,061, and polymers illustrated below. However, the polymer is not limited thereto in the invention.

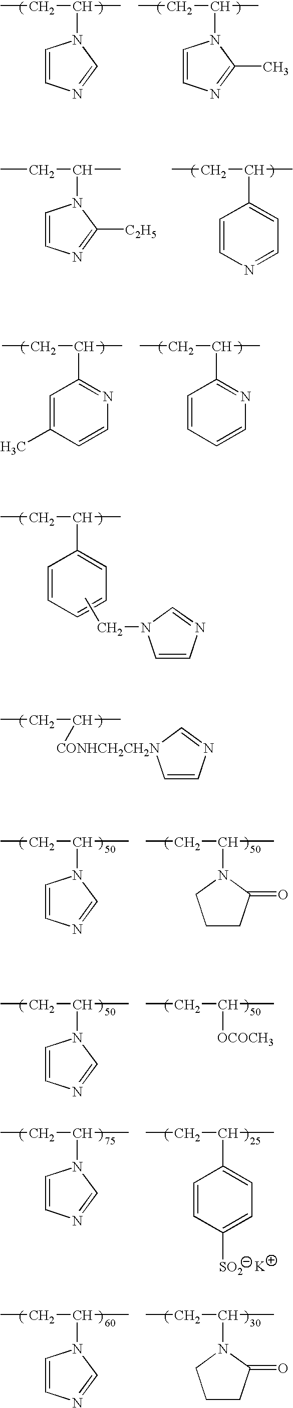

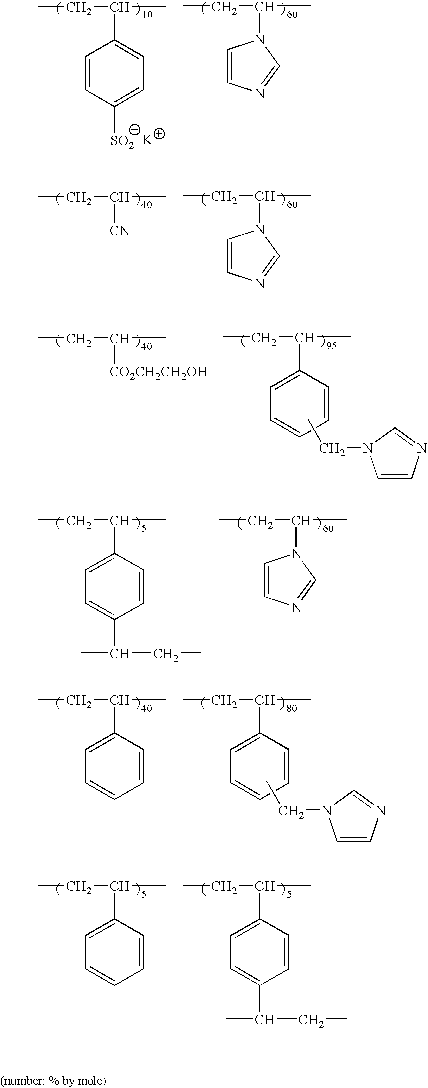

In the formula (FX-2), R₄ and R₅ each preferably represent an unsubstituted alkyl group (such as a methyl, ethyl, n-propyl, n-butyl, n-amyl, hexyl, n-nonyl, n-decyl or n-dodecyl group), a substituted alkyl group (such as a methoxyethyl, 3-cyanopropyl, ethoxycarbonylethyl, acetoxyethyl, hydroxyethyl, or 2-butenyl group), an unsubstituted aralkyl group (such as a benzyl, phenethyl, diphenylmethyl, or naphthylmethyl group), or a substituted aralkyl group (such as a 4-methylbenzyl, 4-isopropylbenzyl, 4-methoxybenzyl, 4-(4-methoxyphenyl)benzyl or 3-chlorobenzyl group).

Examples of the case that R₄ and R₅ link to each other to form, together with a nitrogen atom, a cyclic structure include the following:

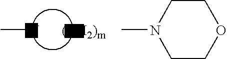

Preferred specific examples of the polymer which comprises a vinyl monomer unit having a tertiary amino group and represented by the formula (FX-2) include the following:

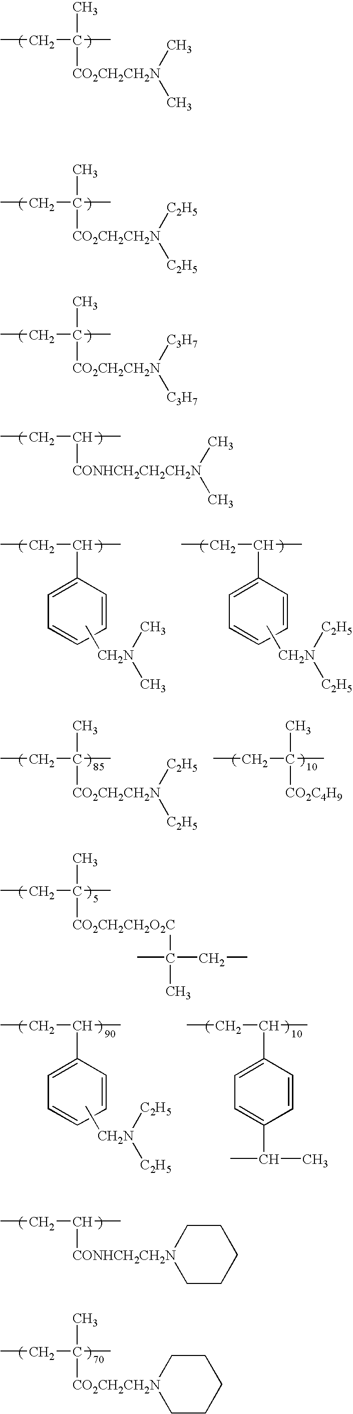

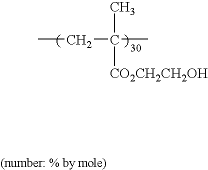

In the formula (FX-3), G⁺ represents a heterocycle containing, as a constituent component thereof, a quaternary nitrogen atom having a double bond to a carbon atom. Examples thereof include imidazoium salts, triazolium salts, pyridinium salts.

Examples of imidazolium salts include following.

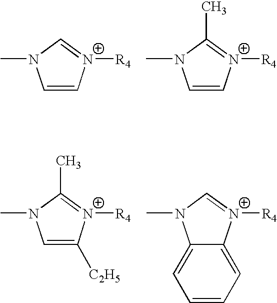

Example of triazolium salts include following.

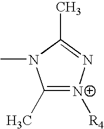

Examples of pyridinium salts include following.

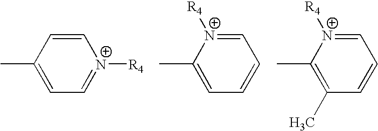

Of these, imidazolium salts and pyridinium salts are particularly preferred. R₄ herein represents the same as in the formula (FX-2), and is in particular preferably a methyl group, an ethyl group or a benzyl group.

In the formulae (FX-3) and (FX-4), X⁻ represents an anion, and examples thereof include halogen ions (such as chlorine, bromine and iodine ions), alkylsulfate ions (such as methylsulfate and ethylsulfate ions), alkyl or arylsulfonate ions (such as methanesulfonate, ethanesulfonate, benzenesulfonate and p-toluenesulfonate ions), an acetate ion, and a sulfate ion. A chlorine ion and a p-toluenesulfonate ion are particularly preferred.

Preferred specific examples of the polymer comprising a vinyl monomer unit having a quaternary ammonio group and represented by the formula (FX-3) include dye fixing agents described in U.S. Pat. Nos. 2,056,101, 2,093,041, 1,594,961, 4,124,386, 4,115,124, 4,273,853, and 4,450,224, and JP-A No. 48-288225, and polymers described blow.

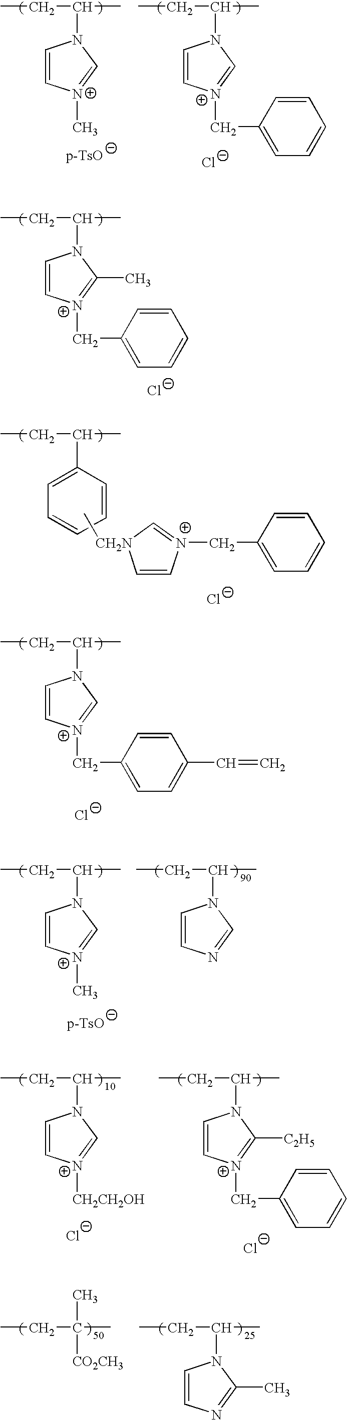

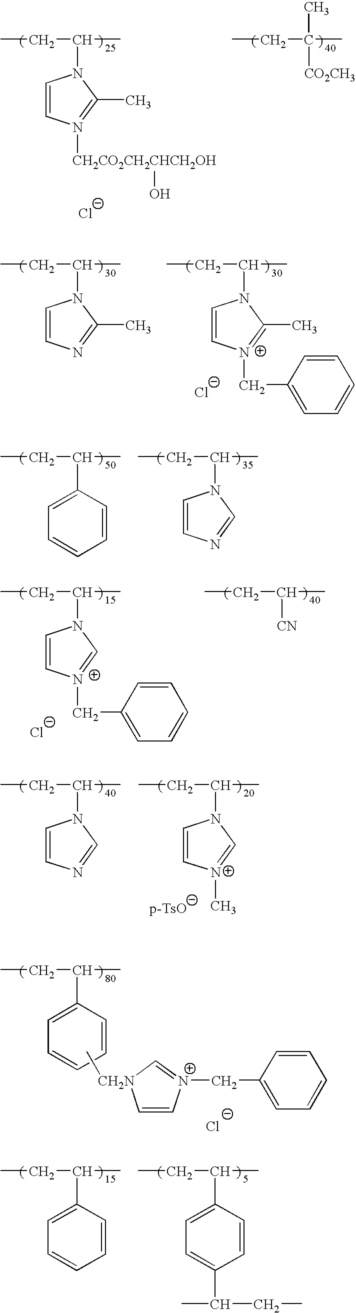

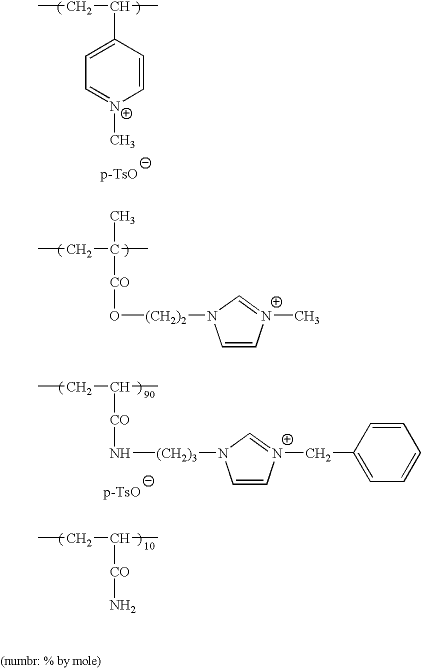

In the above formulae p-TsO represents the following.

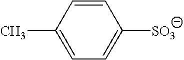

In the formula (FX-4), examples of the case that R₄ and R₅ link to each other to form, together with a nitrogen atom, a cyclic structure include the following: 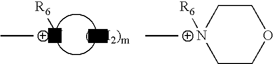
wherein m represents an integer of 4 to 12.

Examples of the case that R₄, R₅ and R₆ form a cyclic structure include the following.

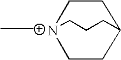

Preferred specific examples of the polymer comprising a vinyl monomer having a quaternary ammonio group and represented by the formula (FX-4) include dye fixing agents described in U.S. Pat. Nos. 3,709,690, 3,898,088, and 3,958,995, and polymers illustrated below.

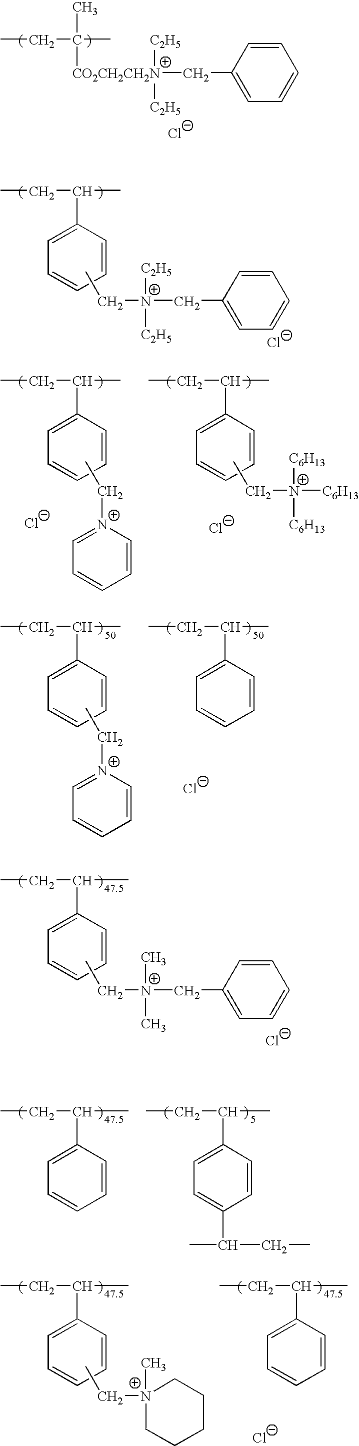

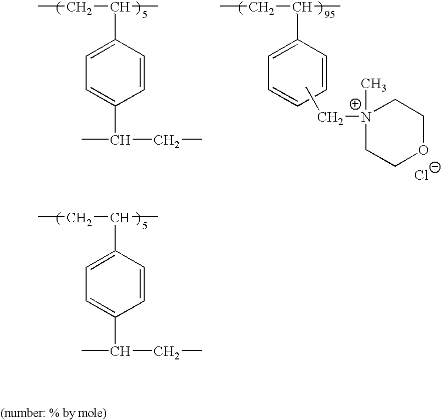

Other Examples of the dye fixing agent which can be used include vinylpyridine polymers disclosed in U.S. Pat. Nos. 2,548,564, 2,484,430, 3,148,061 and 3,756,814; dye fixing agents which are capable of being crosslinked with gelatin or the like and are disclosed in U.S. Pat. Nos. 3,625,694, 3,859,096 and 4,128,538 and U.K. Patent No. 1,277,453; water-soluble sol type dye fixing agents disclosed in U.S. Pat. Nos. 3,958,995, 2,721,852 and 2,798,063, and JP-A Nos. 54-115228, 54-145529 and 54-126027; water-insoluble dye fixing agents disclosed in U.S. Pat. No. 3,898,088; reactive dye fixing agents which can be covalently bonded to dyes and are disclosed in U.S. Pat. No. 4,168,976 (JP-A No. 54-137333); dye fixing agents disclosed in U.S. Pat. Nos. 3,709,690, 3,788,855, 3,642,482, 3,488,706, 3,557,066, 3,271,147 and 3,271,148, and JP-A Nos. 50-71332, 53-30328, 52-155528, 53-125 and 53-1024; and dye fixing agents described in U.S. Pat. Nos. 2,675,316, and 2,882,156.

The molecular weight of the dye fixing agent used in the invention is preferably from 1,000 to 1,000,000, more preferably from 10,000 to 200,000.

The dye fixing agent is used together with a hydrophilic colloid as a binder in a system containing a water-soluble dye. Typical examples of the hydrophilic colloid include natural materials such as proteins (such as gelatin and gelatin derivatives), and polysaccharides (such as cellulose derivatives, starch, and gum arabic), and synthetic rubbers such as polyvinyl alcohol, polyvinyl pyrrolidone, and polyacrylamide. Of these, gelatin and polyvinyl alcohol are particularly preferred.

The blend ratio between the dye fixing agent and the hydrophilic colloid and the coating amount of the dye fixing agent can easily be decided by those skilled in the art in accordance with the amount of a water-soluble dye to be fixed, the kind and composition of the dye fixing agent, and other factors. The ratio by mass of the dye fixing agent to the hydrophilic colloid is appropriately from 20/80 to 80/20, and the coating amount of the dye fixing agent is preferably from about 0.2 g/m² to about 15 g/m², more preferably from 0.5 g/m² to 8 g/m².

In the invention, a cationic surfactant can be preferably used as the dye fixing agent. The cationic surfactant used in the invention is a compound having, in the molecule thereof, at least a partial structure of a quaternary ammonium group or quaternary phosphonium group represented by the following formula

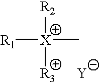

In the formula, R₁, R₂ and R₃ may be the same or different, and each represent a group selected from an alkyl group, an aralkyl group, a cycloalkyl group, an aryl group and a heterocyclic residue. These groups may each be substituted with an alkyl group, an alkoxy group, an aralkyl group, an aryl group, an aryloxy group, a hydroxyl group, a halogen atom, a carboxyl group, a sulfo group, a cyano group, an acyl group, an acyloxy group, an acylamino group, a sulfonylamino group, a carbamoyl group, a substituted carbamoyl group, a sulfamoyl group, a substituted sulfamoyl group, an amino group, a substituted amino group, a mercapto group, an alkylthio group, an arylthio group, an alkoxycarbonyl group or a heterocyclic residue. R₁ and R₂, R₁ and R₃, or R₂ and R₃ may link to each other to form a heterocycle. X represents a nitrogen atom or a phosphorus atom. Y⁻ represents a halogen ion, a sulfonate ion, an alkylsulfate ion, a nitrate ion, a hydrogensulfate ion, a perchlorate ion, a tetrafluoroborate ion, a carboxylate ion, and a ZuCl₃ ion. Any one of R₁, R₂ and R₃ may be bonded to Y.

The cationic surfactant used in the invention can be synthesized by a known process. For example, a target cationic compound is usually obtained in a high yield by heating a tertiary amine or tertiary phosphine together with any one of various alkylating agents in a polar solvent such as alcohol or acetonitrile or in a nonpolar solvent such as ether, ethyl acetate, benzene or toluene. Examples of the alkylating agents which can be used in this case include alkyl (or aralkyl)halides, alkyl (or aralkyl)esters of sulfuric acid or sulfonic acids, lactones, and sultones. The anionic moiety thereof can be directly introduced by use of an alkylating agent having the target anionic moiety, or the anionic moiety can be obtained by converting a different anion to the target anion.

Specific examples of the synthesis of the cationic compound are described in V. Migrdichian, “Organic Synthesis”, Vo. 1 (Rainhold, 1957), pp. 476-479, and others.

The following illustrates preferred specific examples of the cationic surfactant used in the invention:

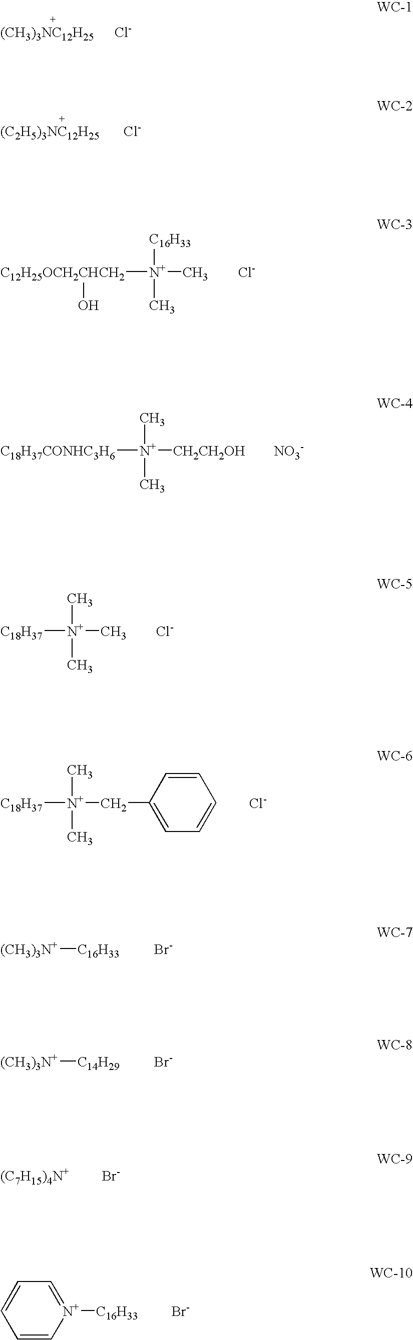

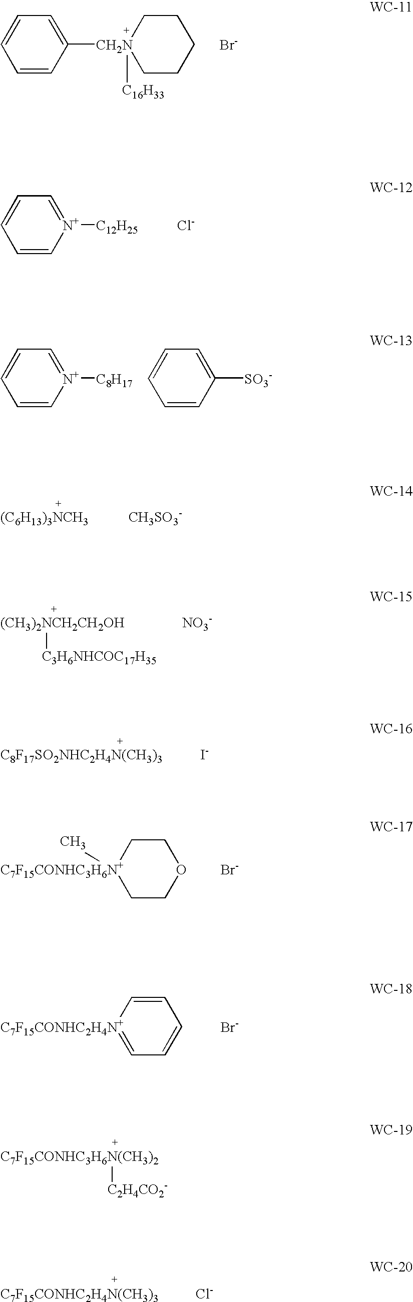

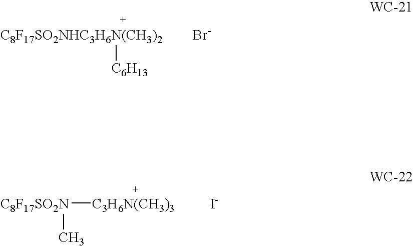

In the invention, a betaine surfactant can be preferably used as the dye fixing agent. The betaine surfactant used in the invention is a surfactant having, in a single molecule thereof, both of an anionic group and a cationic group which form a salt inside the molecule, and is represented by the following formula (C):
A⁻-C⁺ Formula (C)
wherein A⁻ represents an anionic residue containing an anionic group such as a sulfonate ion, a carboxylate group, or a phosphate group, and C⁺ represents an organic cationic residue.

The betaine surfactant used in the invention preferably contains, in a single molecule thereof, at least one selected from saturated or unsaturated hydrocarbon groups having 6 or more carbon atoms, and fluorine-substituted groups thereof. The surfactant is in particular preferably a surfactant containing, in a single molecule thereof, at least one selected from saturated or unsaturated hydrocarbon groups having 10 to 24 carbon atoms, and fluorine-substituted groups thereof.

Specific examples of the betaine surfactant used in the invention are illustrated below.

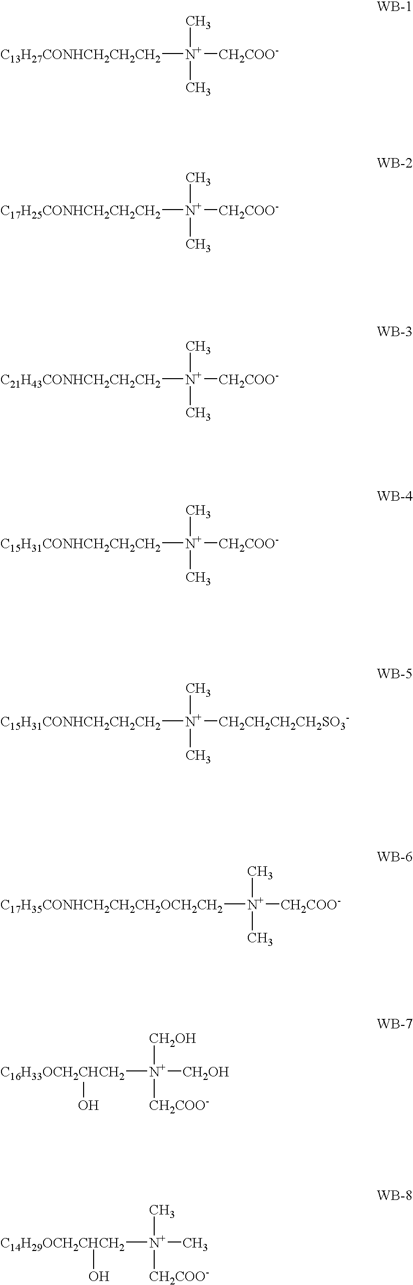

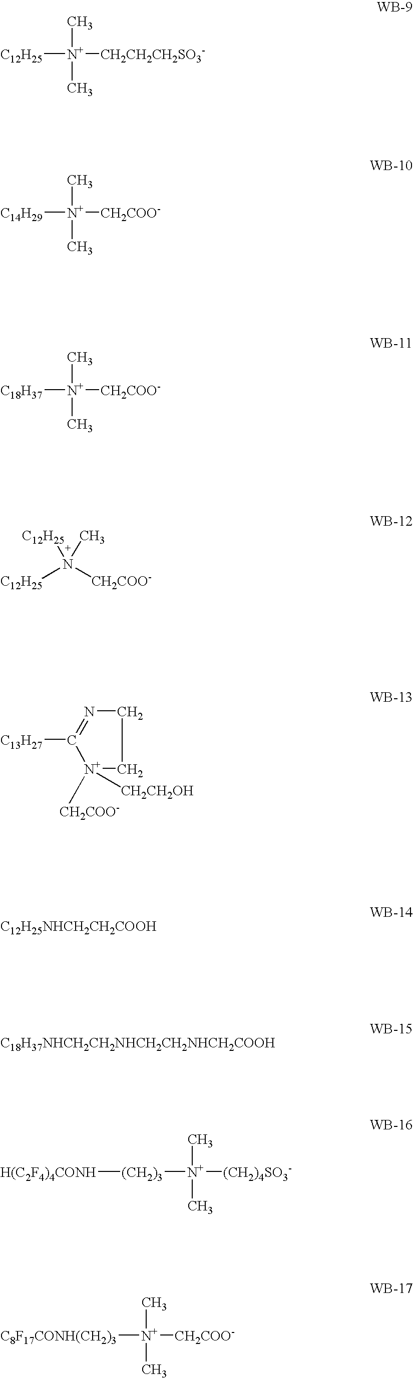

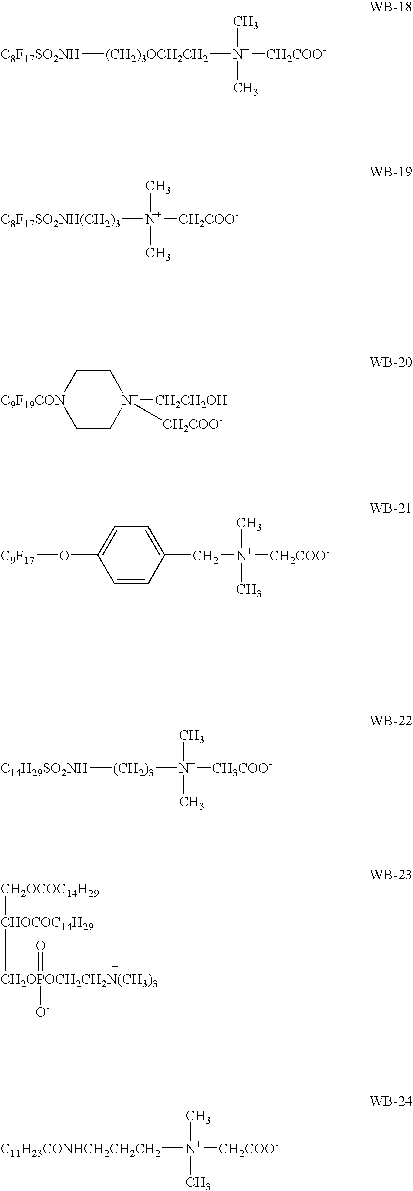

In the invention, a polyvalent metal salt can be preferably used as the dye fixing agent. The polyvalent metal salt used in the invention is a compound which is dissolved in water so as to be ionized, thereby generating a polyvalent metal cation (a bivalent or higher valent metal cation). This metal cation interacts with the water-soluble dye in the film in the invention so as to restrain the dye from being shifted in the film. Examples of the metal species in the polyvalent metal salt include alkaline earth metals, typical metals and transition metals in the groups IIa to VIII and Ib to IIIb in the periodic table. Preferred examples of the metal species include magnesium, calcium, strontium, iron and zinc, and more preferred examples thereof include calcium, and strontium. Examples of the counter anion in the salt include halogen, hydroxyl, sulfate, nitrate, phosphate, carbonate, oxalate, alkanesulfonate, arylsulfonate, alkanecarboxylate, and arylcarboxylate ions. Preferred are carbonate, nitrate, sulfate and alkanecarboxylate ions. More preferred are carbonate, nitrate and alkanecarboxylate ions. Calcium nitrate is particularly preferred since it is water-soluble, can easily be used, and is inactive to other materials in the photothermographic material.

Specific examples of the polyvalent metal salt used in the invention are illustrated below.
MM-1 Ca(NO₃)₂
MM-2 Mg(NO₃)₂
MM-3 BaSO₄
MM-4 Zinc stearate
MM-5 St(NO₃)₂
MM-6 Ca(CH₃CO₂)₂
MM-7 Ni(CH₃CO₂)₂
MM-8 Zn(CH₃CO₂)₂
MM-9 FeCl₃
MM-10 MgCl₂
MM-11 StCl₂
MM-12 CaCl₂

The use amount of the added polyvalent metal salt is essentially 1.5×10⁻⁵ mol/m² or more, and is preferably from 2×10⁻⁵ mol/m² to 1×10⁻² mol/m². When the polyvalent metal salt is calcium nitrate, the use amount thereof is preferably from 1×10⁻⁵ mol/m² to 1×10⁻² mol/m².

The method for adding the metal salt may be a method of preparing an aqueous solution of the metal salt and then adding the solution, or a method of making particles of the metal salt into fine particles and then adding the fine particles. The former method is preferred.

(Non-Dissociating Polymer Latex)

The layer containing the fixing agent in the invention preferably contains a polymer latex. The incorporation of the polymer latex causes an improvement in curl balance between the layer containing the fixing agent and other layers. Furthermore, it has been found out as an unexpected advantageous effect that in the image forming method of performing image exposure and thermal development of a photothermographic material while transporting the material, transportation troubles such as jamming are restrained from being generated.

Any polymer latex that has been hitherto known for photothermographic material may be used as the polymer latex. Preferably, polymer latex contains 3% or less by mole of a monomer having a dissociating group. More preferably, polymer latex does not contain the same monomer at all. The glass transition temperature (Tg) of the polymer latex is preferably 30° C. or lower and −30° C. or higher.

The polymer latex used in the layer containing the fixing agent in the invention is preferably a latex giving a small interaction with the fixing agent or cationic and anionic charges of the water-soluble dye.

If the polymer latex contains more than 3% by mole of the monomer having a dissociating group, the interaction becomes intense. As a result, the coating solution may aggregate partially, the condition of the resultant coating surface may deteriorate, and further the addition effect of the polymer latex may be lost.

The following will describe a preferable non-dissociating polymer latex used in the invention.

The preferable non-dissociating polymer latex is a polymer latex containing a butadiene or isoprene component, and may be a homopolymer or a copolymer. Examples of other components of the copolymer include acrylic acid esters, methacrylic acid esters, vinyl esters, maleic acid diesters, fumaric acid diesters, itaconic acid diesters, acrylamides, methacrylamides, vinyl ethers, and styrene-based compounds. Styrene-based compounds are particularly preferable.

Preferable specific examples of the latex used in the invention will be shown hereinafter. In the invention, however, the latex is not limited thereto. Two or more kinds of the latex may be used together.

The polymer latex may contain a dissociating group such as acrylic acid or methacrylic acid. However, the percentage of the dissociating group is preferably 3% or less by mole, more preferably 1% or less by mole, and most preferably 0%.

The glass transition temperature of the non-dissociating polymer latex in the invention is preferably from −30° C. to 30° C. (inclusive), more preferably from −10 ° C to −25° C. (inclusive).

In the specification, Tg of any polymer has been calculated based on the following equation:
1/Tg=Σ(Xi/Tgi)

The polymer is a polymer wherein monomer components, the number of which is n from i=1 to i=n, are copolymerized. Xi is the mass fraction of the i^{th} monomer (ΣXi=1), and Tgi is the glass transition temperature (absolute temperature) of a homopolymer made from the i^{th} monomer. The symbol Σ means the summation of given factors from i=1 to i=n. As the value (Tgi) of the glass transition temperature of a homopolymer made from each polymer, the following has been adopted: each value described in J. Brandrup and E. H. Immergut, Polymer Handbook (3^{rd} Edition) (Wiley-Interscience, 1989).

Preferable specific examples of the latex used in the invention will be shown hereinafter. However, the invention is not limited thereto. Two or more kinds of the latex may be used together. 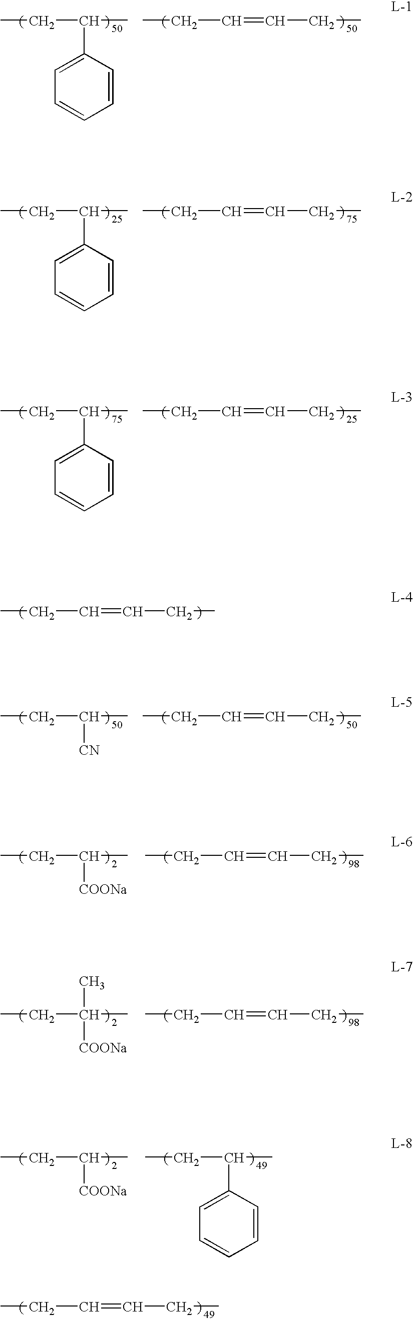 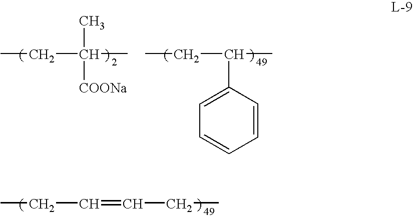
L-11 LX407C, manufactured by Nippon Zeon Co., Ltd.,
L-12 LX407F, manufactured by Nippon Zeon Co., Ltd.,
L-13 LX407C; manufactured by Nippon Zeon Co., Ltd.,
L-14 LX407H, manufactured by Nippon Zeon Co., Ltd.,
L-15 LX407K, manufactured by Nippon Zeon Co., Ltd.,
L-16 LX407S, manufactured by Nippon Zeon Co., Ltd.,
L-17 LX110, manufactured by Nippon Zeon Co., Ltd.,
L-18 LX112, manufactured by Nippon Zeon Co., Ltd.,
L-19 LX119, manufactured by Nippon Zeon Co., Ltd.,
L-20 LX139, manufactured by Nippon Zeon Co., Ltd.,
L-21 LX206, manufactured by Nippon Zeon Co., Ltd.,
L-22 LX209, manufactured by Nippon Zeon Co., Ltd.,
L-23 LX303, manufactured by Nippon Zeon Co., Ltd.,
L-24 LX410, manufactured by Nippon Zeon Co., Ltd.,
L-25 LX415A, manufactured by Nippon Zeon Co., Ltd.,
L-26 LX416, manufactured by Nippon Zeon Co., Ltd.,
L-27 LX426, manufactured by Nippon Zeon Co., Ltd.,
L-28 LX430, manufactured by Nippon Zeon Co., Ltd.,
L-29 LX432A, manufactured by Nippon Zeon Co., Ltd.,
L-30 LX433, manufactured by Nippon Zeon Co., Ltd.,
L-31 LX435, manufactured by Nippon Zeon Co., Ltd.,
L-32 LX438, manufactured by Nippon Zeon Co., Ltd.,
L-33 LX438C, manufactured by Nippon Zeon Co., Ltd.,
L-34 LX472, manufactured by Nippon Zeon Co., Ltd.,
L-35 LX473B, manufactured by Nippon Zeon Co., Ltd.,
L-36 LX476, manufactured by Nippon Zeon Co., Ltd.,
L-37 LX511, manufactured by Nippon Zeon Co., Ltd.,
L-38 LX513, manufactured by Nippon Zeon Co., Ltd.,
L-39 LX517A, manufactured by Nippon Zeon Co., Ltd.,
L-40 LX531, manufactured by Nippon Zeon Co., Ltd.,
L-41 LX540, manufactured by Nippon Zeon Co., Ltd.,
L-42 LX550, manufactured by Nippon Zeon Co., Ltd.,
L-43 LX551, manufactured by Nippon Zeon Co., Ltd., and
L-44 LX111G, manufactured by Nippon Zeon Co., Ltd.

The coating amount of the latex, which is related to the coating amount of the binder, is preferably from 5 to 40% by mass of the binder, more preferably from 10 to 30% by mass thereof. The coating amount is also preferably from about 0.05 to 2 g/m², more preferably from 0.1 to 0.5 g/m².

(Non-Photosensitive Organic Silver Salt)

1) Composition

The organic silver salt which can be used in the present invention is relatively stable to light but serves as to supply silver ions and forms silver images when heated to 80° C. or higher under the presence of an exposed photosensitive silver halide and a reducing agent. The organic silver salt may be any organic material containing a source capable of supplying silver ions that are reducible by a reducing agent. Such non-photosensitive organic silver salt is disclosed, for example, in JP-A No. 10-62899 (paragraph Nos. 0048 to 0049), EP-A No. 0803764A1 (page 18, line 24 to page 19, line 37), EP-A No. 0962812A1, JP-A Nos. 11-349591, 2000-7683, and 2000-72711, and the like. A silver salt of organic acid, particularly, a silver salt of long chained aliphatic carboxylic acid (having 10 to 30 carbon atoms, and preferably having 15 to 28 carbon atoms) is preferable. Preferred examples of the silver salt of fatty acid can include, for example, silver lignocerate, silver behenate, silver arachidinate, silver stearate, silver oleate, silver laurate, silver capronate, silver myristate, silver palmitate, silver erucate and mixtures thereof. In the invention, among these silver salts of fatty acid, it is preferred to use a silver salt of fatty acid with a silver behenate content of 50 to 100 mol %, more preferably, 85 to 100 mol %, and further preferably, 95 to 100 mol %. Further, it is preferred to use a silver salt of fatty acid with a silver erucate content of 2 mol % or less, more preferably, 1 mol % or less, and further preferably, 0.1 mol % or less.

It is preferred that the content of silver stearate is 1 mol % or less. When the content of silver stearate is 1 mol % or less, a silver salt of organic acid having low Dmin, high sensitivity and excellent image storability can be obtained. The above-mentioned content of silver stearate is preferably 0.5 mol % or less, and particularly preferably, silver stearate is not substantially contained.

Further, in the case where the silver salt of organic acid includes silver arachidinate, it is preferred that the content of silver arachidinate is 6 mol % or less in order to obtain a silver salt of organic acid having low Dmin and excellent image storability. The content of silver arachidinate is more preferably 3 mol % or less.

2) Shape

There is no particular restriction on the shape of the organic silver salt usable in the invention and it may needle-like, bar-like, tabular or flaky shape.

In the invention, a flaky shaped organic silver salt is preferred. Short needle-like, rectangular, cuboidal or potato-like indefinite shaped particle with the major axis to minor axis ratio being 5 or less is also used preferably. Such organic silver particle has a feature less suffering from fogging during thermal development compared with long needle-like particles with the major axis to minor axis length ratio of more than 5. Particularly, a particle with the major axis to minor axis ratio of 3 or less is preferred since it can improve the mechanical stability of the coating film. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flaky shape. The relation is preferably: 30≧x (average)≧1.5 and, more preferably, 15≧x (average)≧1.5. By the way, needle-like is expressed as 1≦x (average)<1.5.

In the flaky shaped particle, a can be regarded as a thickness of a tabular particle having a main plate with b and c being as the sides. a in average is preferably 0.01 μm to 0.3 μm and, more preferably, 0.1 μm to 0.23 μm. c/b in average is preferably 1 to 9, more preferably 1 to 6, further preferably 1 to 4 and, most preferably 1 to 3.

By controlling the equivalent spherical diameter to 0.05 μm to 1 μm, it causes less agglomeration in the photothermographic material and image storability is improved. The equivalent spherical diameter is preferably 0.1 μm to 1 μm. In the invention, an equivalent spherical diameter can be measured by a method of photographing a sample directly by using an electron microscope and then image processing the negative images.

In the flaky shaped particle, the equivalent spherical diameter of the particle/a is defined as an aspect ratio. The aspect ratio of the flaky particle is, preferably, 1.1 to 30 and, more preferably, 1.1 to 15 with a viewpoint of causing less agglomeration in the photothermographic material and improving the image storability.

As the particle size distribution of the organic silver salt, monodispersion is preferred. In the monodispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the monodispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. The monodispersion can be determined from particle size (volume weighted mean diameter) obtained, for example, by a measuring method of irradiating a laser beam to organic silver salts dispersed in a liquid, and determining a self correlation function of the fluctuation of scattered light to the change of time.

3) Preparation

Methods known in the art may be applied to the method for producing the organic silver salt used in the invention and to the dispersing method thereof. For example, reference can be made to JP-A No. 10-62899, EP-A Nos. 0803763A1 and 0962812A1, JP-A Nos. 11-349591, 2000-7683, 2000-727,11, 2001-163889, 2001-163890, 2001-163827, 2001-33907, 2001-188313, 2001-83652, 2002-6442, 2002-31870, 2002-107868, and the like.

When a photosensitive silver salt is present together during dispersion of the organic silver salt, fog increases and sensitivity becomes remarkably lower, so that it is more preferred that the photosensitive silver salt is not substantially contained during dispersion. In the invention, the amount of the photosensitive silver salt to be disposed in the aqueous dispersion, is preferably, 1 mol % or less, more preferably, 0.1 mol % or less per 1 mol of the organic acid silver salt in the solution and, further preferably, positive addition of the photosensitive silver salt is not conducted.

In the invention, the photosensitive material can be prepared by mixing an aqueous dispersion of an organic silver salt and an aqueous dispersion of a photosensitive silver salt and the mixing ratio between the organic silver salt and the photosensitive silver salt can be selected depending on the purpose. The ratio of the photosensitive silver salt to the organic silver salt is, preferably, in a range from 1 mol % to 30 mol %, more preferably, from 2 mol % to 20 mol % and, particularly preferably, 3 mol % to 15 mol %. A method of mix two or more kinds of aqueous dispersions of organic silver salts and two or more kinds of aqueous dispersions of photosensitive silver salts upon mixing is used preferably for controlling the photographic properties.

4) Addition Amount

While an organic silver salt in the invention can be used in a desired amount, a total amount of coated silver including silver halide is preferably in a range from 0.1 g/m² to 3.0 g/m², more preferably from 0.5 g/m² to 2.0 g/m², and further preferably from 0.8 g/m² to 1.7 g/m². Particularly, in order to improve image storability, the total amount of coated silver is preferably 1.5 mg/M² or less, and more preferably 1.3 mg/m² or less. When a preferable reducing agent in the invention is used, it is possible to obtain a sufficient image density by even such a low amount of silver.

(Reducing Agent for Organic Silver Salt)

The photothermographic material of the invention contains a reducing agent for the organic silver salt. The reducing agent may be any substance (preferably, organic substance) capable of reducing silver ions into metallic silver. Examples of the reducing agent are described in JP-A No. 11-65021 (column Nos. 0043 to 0045) and EP-A No. 0803764A1 (page 7, line 34 to page 18, line 12).

In the invention, a so-called hindered phenolic reducing agent or a bisphenol reducing agent having a substituent at the ortho-position to the phenolic hydroxy group is preferred. Particularly, the compound represented by the following formula (R) is preferred.

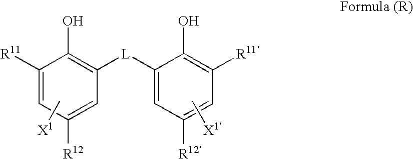

In formula (R), R¹¹ and R^{11′} each independently represent an alkyl group having 1 to 20 carbon atoms. R¹² and R^{12′} each independently represent one selected from a hydrogen atom and a substituent capable of substituting for a hydrogen atom on a benzene ring. L represents one selected from an —S— group and a —CHR¹³— group. R¹³ represents one selected from a hydrogen atom and an alkyl group having 1 to 20 carbon atoms. X¹ and X^{1′} each independently represent one selected from a hydrogen atom and a group capable of substituting for a hydrogen atom on a benzene ring.

Formula (R) is explained in detail.

1) R¹¹ and R^{11′}

R¹¹ and R^{11′} each independently represent a substituted or unsubstituted alkyl group having 1 to 20 carbon atoms. The substituent for the alkyl group has no particular restriction and can include, preferably, an aryl group, a hydroxy group, an alkoxy group, an aryloxy group, an alkylthio group, an arylthio group, an acylamino group, a sulfoneamide group, a sulfonyl group, a phosphoryl group, an acyl group, a carbamoyl group, an ester group, an ureido group, an urethane group, and a halogen atom.

2) R¹² and R^{12′} X¹ and X^{1′}

R¹² and R^{12′} each independently represent one of a hydrogen atom and a group capable of substituting for a hydorgen atom on a benzene ring. X¹ and X^{1′} each independently represent one of a hydrogen atom and a group capable of substituting for a hydorgen atom on a benzene ring. Each of the groups capable of substituting for a hydrogen atom on the benzene ring can include, preferably, an alkyl group, an aryl group, a halogen atom, an alkoxy group, and an acylamino group.

3) L

L represents one of a —S— group and a —CHR¹³— group. R¹³ represents one of a hydrogen atom and an alkyl group having 1 to 20 carbon atoms in which the alkyl group may have a substituent. Specific examples of the unsubstituted alkyl group for R¹³ can include, for example, a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimetyl-3-cyclohexenyl group, a 3,5-dimethyl-3-cyclohexenyl group, and the like. Examples of the substituent for the alkyl group can include, similar to substituent of R¹¹, a halogen atom, an alkoxy group, an alkylthio group, an aryloxy group, an arylthio group, an acylamino group, a sulfoneamide group, a sulfonyl group, a phosphoryl group, an oxycarbonyl group, a carbamoyl group, a sulfamoyl group, and the like.

4) Preferred Subsituents

R¹¹ and R^{11′} are, preferably, a primary, secondary or tertiary alkyl group having 1 to 15 carbon atoms and can include, specifically, a methyl group, an isopropyl group, a t-butyl group, a t-amyl group, a t-octyl group, a cyclohexyl group, a cyclopentyl group, a 1-methylcyclohexyl group, a 1-methylcyclopropyl group and the like. R¹¹ and R^{11′} each represent, more preferably, an alkyl group having 1 to 4 carbon atoms and, among them, a methyl group, a t-butyl group, a t-amyl group, and a 1-methylcyclohexyl group are further preferred and, and a methyl group and a t-butyl group being most preferred.

R¹² and R^{12′} are, preferably, an alkyl group having 1 to 20 carbon atoms and can include, specifically, a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group and the like. More preferred are a methyl group, an ethyl group, a propyl group, an isopropyl group, and a t-butyl group, and particularly preferred are a methyl group and an ethyl group.

X¹ and X^{1′} are, preferably, a hydrogen atom, a halogen atom, or an alkyl group, and more preferably, a hydrogen atom.

L is preferably a —CHR¹³— group.

R¹³ is, preferably, a hydrogen atom or an alkyl group having 1 to 15 carbon atoms. The alkyl group is preferably a chain or a cyclic alkyl group. And, a group which has a C═C bond in these alkyl group is also preferably used. Preferable examples of the alkyl group can include a methyl group, an ethyl group, a propyl group, an isopropyl group, a 2,4,4-trimethylpentyl group, a cyclohexyl group, a 2,4-dimethyl-3-cyclohexenyl group, a 3,5-dimetyl-3-cyclohexenyl group and the like. Particularly preferable R¹³ is a hydrogen atom, a methyl group, an ethyl group, a propyl group, an isopropyl group, or a 2,4-dimethyl-3-cyclohexenyl group.

In the case where R¹¹ and R^{11′} are a tertiary alkyl group and R¹² and R^{12′} are a methyl group, R¹³ preferably is a primary or secondary alkyl group having 1 to 8 carbon atoms (a methyl group, an ethyl group, a propyl group, an isopropyl group, a 2,4-dimethyl-3-cyclohexenyl group, or the like).

In the case where R¹¹ and R^{11′} are tertiary alkyl group and R¹² and R^{12′} are an alkyl group other than a methyl group, R¹³ preferably is a hydrogen atom.

In the case where R¹¹ and R^{11′} are not a tertiary alkyl group, R¹³ preferably is a hydrogen atom or a secondary alkyl group, and particularly preferably a secondary alkyl group. As the secondary alkyl group for R¹³, an isopropyl group and a 2,4-dimethyl-3-cyclohexenyl group are preferred.

The reducing agent described above shows different thermal developing performances, color tones of developed silver images, or the like depending on the combination of R¹¹, R^{11′}, R¹², R^{12′}, R¹³. Since these performances can be controlled by using two or more kinds of reducing agents at various mixing ratios, it is preferred to use two or more kinds of reducing agents in combination depending on the purpose.

Specific examples of the reducing agents of the invention including the compounds represented by formula (R) according to the invention are shown below, but the invention is not restricted to them.

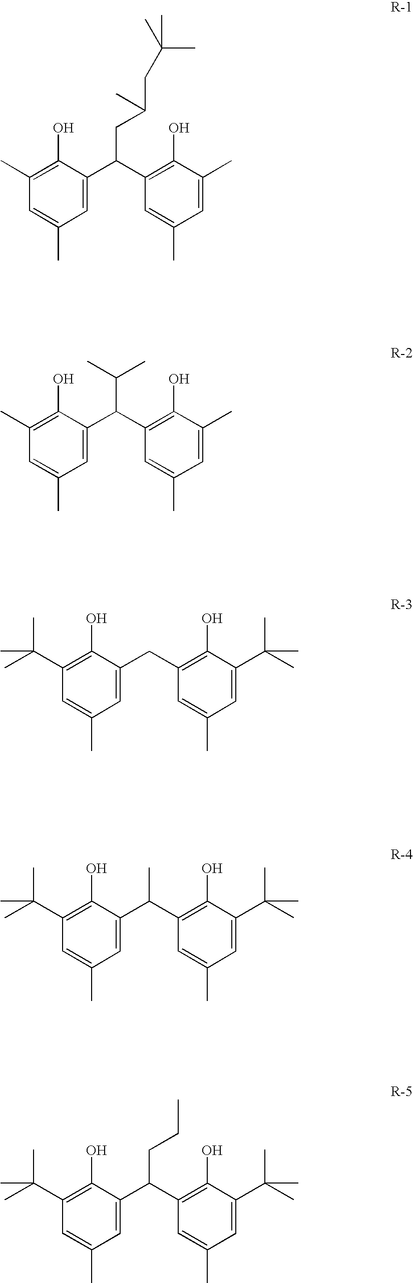

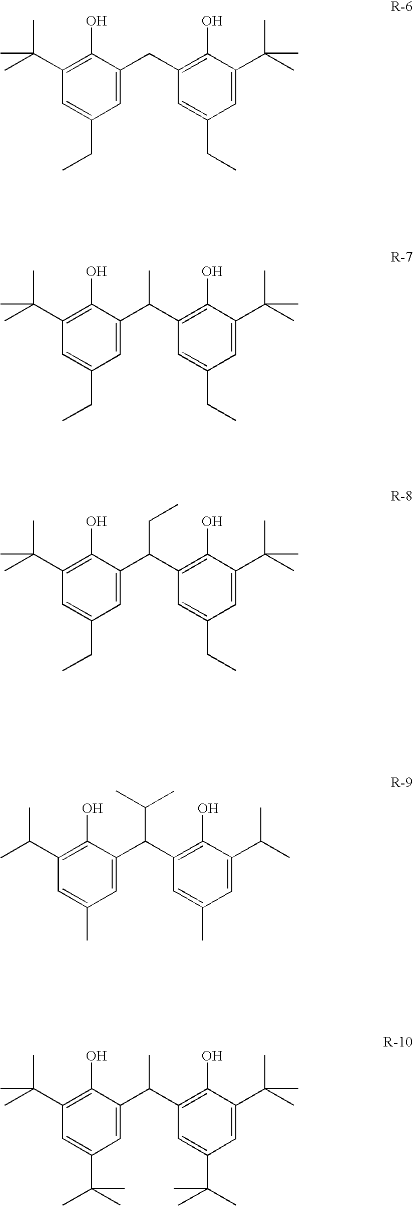

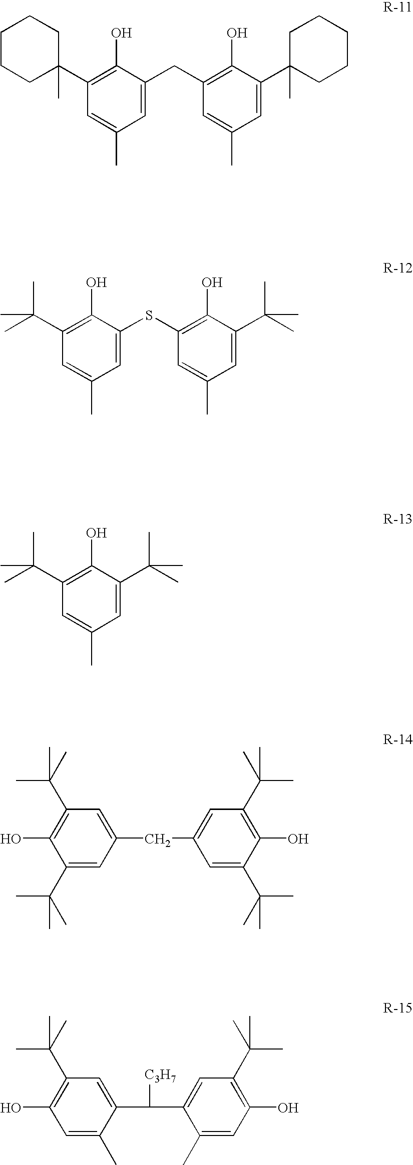

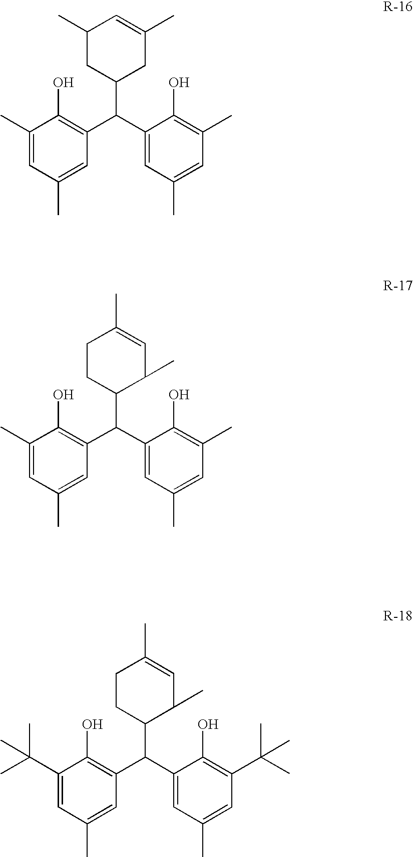

As preferred reducing agents of the invention other than those above, there can be mentioned compounds disclosed in JP-A Nos. 2001-188314, 2001-209145, 2001-350235, and 2002-156727, and EP No. 1278101A2.

In the invention, the addition amount of the reducing agent is, preferably, from 0.1 g/m² to 3.0 g/m², more preferably, 0.2 g/m² to 1.5 g/m² and, further preferably 0.3 g/m² to 1.0 g/m². It is, preferably, contained in a range of 5 mol % to 50 mol %, more preferably, 8 mol % to 30 mol % and, further preferably, 10 mol % to 20 mol % per 1 mol of silver in the surface having the image forming layer. The reducing agent of the invention is preferably contained in the image forming layer.

In the invention, the reducing agent may be incorporated into photothermographic material by being added into the coating solution, such as in the form of solution, emulsion dispersion, solid fine particle dispersion, and the like.

As a well known emulsion dispersing method, there can be mentioned a method comprising dissolving the reducing agent using an oil such as dibutyl phthalate, tricresyl phosphate, glyceryl triacetate, diethyl phthalate, or the like, as well as an auxiliary solvent such as ethyl acetate, cyclohexanone, and the like; from which an emulsion dispersion is mechanically produced.

As solid fine particle dispersing method, there can be mentioned a method comprising dispersing the powder of the reducing agent in a proper medium such as water, by means of ball mill, colloid mill, vibrating ball mill, sand mill, jet mill, roller mill, or ultrasonics, thereby obtaining solid dispersion. In this case, there can also be used a protective colloid (such as polyvinyl alcohol), or a surfactant (for instance, an anionic surfactant such as sodium triisopropylnaphthalenesulfonate (a mixture of compounds having the isopropyl groups in different substitution sites)). In the mills enumerated above, generally used as the dispersion media are beads made of zirconia and the like, and Zr and the like eluting from the beads may be incorporated in the dispersion. Although depending on the dispersing conditions, the amount of Zr and the like generally incorporated in the dispersion is in the range from 1 ppm to 1000 ppm. It is practically acceptable so long as Zr is incorporated in an amount of 0.5 mg or less per 1 g of silver.

Preferably, an antiseptic (for instance, sodium benzoisothiazolinone salt) is added in the water dispersion.

In the invention, furthermore, the reducing agent is preferably used as a solid particle dispersion, and the reducing agent is added in the form of fine particles having mean particle size from 0.01 μm to 10 μm, and more preferably, from 0.05 μm to 5 μm, and further preferably, from 0.1 μm to 2 μm. In the invention, other solid dispersions are preferably used with this particle size range.

(Photosensitive Silver Halide)

1) Halogen Composition

For the photosensitive silver halide used in the invention, there is no particular restriction on the halogen composition and silver chloride, silver bromochloride, silver bromide, silver iodobromide, silver iodochlorobromide and silver iodide can be used. Among them, silver bromide, silver iodobromide and silver iodide are preferred. The distribution of the halogen composition in a grain may be uniform or the halogen composition may be changed stepwise, or it may be changed continuously. Further, a silver halide grain having a core/shell structure can be used preferably. Preferred structure is a twofold to fivefold structure and, more preferably, core/shell grain having a twofold to fourfold structure can be used. Further, a technique of localizing silver bromide or silver iodide to the surface of a silver chloride, silver bromide or silver chlorobromide grains can also be used preferably.

2) Method of Grain Formation

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

3) Grain Size

The grain size of the photosensitive silver halide is preferably small with an aim of suppressing clouding after image formation and, specifically, it is 0.20 μm or less, more preferably, 0.01 μm to 0.15 μm and, further preferably, 0.02 μm to 0.12 μm. The grain size as used herein means an average diameter of a circle converted such that it has a same area as a projected area of the silver halide grain (projected area of a main plane in a case of a tabular grain).

4) Grain Shape

The shape of the silver halide grain can include, for example, cubic, octahedral, tabular, spherical, rod-like or potato-like shape. The cubic grain is particularly preferred in the invention. A silver halide grain rounded at corners can also be used preferably. The surface indices (Miller indices) of the outer surface of a photosensitive silver halide grain is not particularly restricted, and it is preferable that the ratio occupied by the [100] face is rich, because of showing high spectral sensitization efficiency when a spectral sensitizing dye is adsorbed. The ratio is preferably 50% or more, more preferably 65% or more, and further preferably 80% or more. The ratio of the [100] face, Miller indices, can be determined by a method described in T. Tani; J. Imaging Sci., vol. 29, page 165, (1985) utilizing adsorption dependency of the [111] face and [100] face in adsorption of a sensitizing dye.

5) Heavy Metal

The photosensitive silver halide grain of the invention can contain metals or complexes of metals belonging to groups 6 to 13 of the periodic table (showing groups 1 to 18). Preferred are metals or complexes of metals belonging to groups 6 to 10. The metal or the center metal of the metal complex from groups 6 to 10 of the periodic table is preferably ferrum, rhodium, ruthenium or iridium. The metal complex may be used alone, or two or more kinds of complexes comprising identical or different species of metals may be used together. A preferred content is in a range from 1×10⁻⁹ mol to 1×10⁻³ mol per 1 mol of silver. The heavy metals, metal complexes and the adding method thereof are described in JP-A No. 7-225449, in paragraph Nos. 0018 to 0024 of JP-A No. 11-65021 and in paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Pe(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl)ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol and, more preferably, from 1×10⁻⁴ mol to 1×10⁻³ per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion formation step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion formation step.

Addition of the hexacyano complex may be started after addition of 96% by mass of an entire amount of silver nitrate to be added for grain formation, more preferably started after addition of 98% by mass and, particularly preferably, started after addition of 99% by mass.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitizing method are described in paragraph Nos. 0046 to 0050 of JP-A No. 11-84574, in paragraph Nos. 0025 to 0031 of JP-A No. 11-65021, and paragraph Nos. 0242 to 0250 of JP-A No. 11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and gelatin having a molecular weight of 10,000 to 1,000,000 is preferably used. And phthalated gelatin is also preferably used. These gelatins may be used at grain formation step or at the time of dispersion after desalting treatment and it is preferably used at grain formation step.

7) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. The sensitizing dyes and the adding method are disclosed, for example, in JP-A No. 11-65021 (paragraph Nos. 0103 to 0109), as a compound represented by the formula (II) in JP-A No. 10-186572, as dyes represented by the formula (I) in JP-A No. 11-119374 (paragraph No. 0106), as dyes described in U.S. Pat. Nos. 5,510,236 and 3,871,887 (Example 5), as dyes disclosed in JP-A Nos. 2-96131 and 59-48753, as well as in page 19, line 38 to page 20, line 35 of EP-A No. 0803764A1, and in JP-A Nos.2001-272747, 2001-290238 and 2002-23306. The sensitizing dyes described above may be used alone or two or more of them may be used in combination. In the invention, sensitizing dye can be added to the silver halide emulsion preferably after desalting step and before coating step, and more preferably after desalting step and before the completion of chemical ripening.

In the invention, the sensitizing dye may be added at any amount according to the property of sensitivity and fogging, but it is preferably added from 10⁻⁶ mol to 1 mol, and more preferably from 10⁻⁴ mol to 10⁻¹ mol, per 1 mol of silver halide in the image forming layer.

The photothermographic material of the invention may also contain super sensitizers in order to improve spectral sensitizing effect.

The super sensitizers usable in the invention can include those compounds described in EP-A No. 587338, U.S. Pat. Nos. 3,877,943 and 4,873,184 and JP-A Nos. 5-341432, 11-109547, and 10-111543.

8) Chemical Sensitization

The photosensitive silver halide grain in the invention is preferably chemically sensitized by sulfur sensitizing method, selenium sensitizing method or tellurium sensitizing method. As the compound used preferably for sulfur sensitizing method, selenium sensitizing method and tellurium sensitizing method, known compounds, for example, compounds described in JP-A No. 7-128768 can be used. Particularly, tellurium sensitization is preferred in the invention and compounds described in the literature cited in paragraph No. 0030 in JP-A No. 11-65021 and compounds shown by formulae (II), (III), and (IV) in JP-A No. 5-313284 are more preferred.

The photosensitive silver halide grain in the invention is preferably chemically sensitized by gold sensitizing method alone or in combination with the chalcogen sensitization described above. As the gold sensitizer, those having a pxidation number of gold of either +1 or +3 are preferred and those gold compounds used usually as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating and it can be applied, after desalting, (1) before spectral sensitization, (2) simultaneously with spectral sensitization, (3) after spectral sensitization and (4) just before coating.

The amount of sulfur, selenium and tellurium sensitizer used in the invention may vary depending on the silver halide grain used, the chemical ripening condition and the like and it is used by about 10⁻⁸ mol to 10⁻² mol, preferably, 10⁻⁷ mol to 10⁻³ mol per 1 mol of silver halide.

The addition amount of the gold sensitizer may vary depending on various conditions and it is generally about 10⁻⁷ mol to 10⁻³ mol and, more preferably, 10⁻⁶ mol to 5×10^{4 -}mol per 1 mol of silver halide.

There is no particular restriction on the condition for the chemical sensitization in the invention and, appropriately, pH is 5 to 8, pAg is 6 to 11 and temperature is at 40° C. to 95° C.

In the silver halide emulsion used in the invention, a thiosulfonic acid compound may be added by the method shown in EP-A No. 293917.

A reductive compound is used preferably for the photosensitive silver halide grain in the invention. As the specific compound for the reduction sensitization, ascorbic acid or thiourea dioxide is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 7 or higher or pAg to 8.3 or lower for the emulsion, and it is also preferred to apply reduction sensitization by introducing a single addition portion of silver ions during grain formation.

9) Compound that can be One-Electron-Oxidized to Provide a One-Electron Oxidation Product which Releases One or More Electrons

The photothermographic material of the invention preferably contains a compound that can be one-electron-oxidized to provide a one-electron oxidation product which releases one or more electrons. The said compound can be used alone or in combination with various chemical sensitizers described above to increase the sensitivity of silver halide.

As the compound that can be one-electron-oxidized to provide a one-electron oxidation product which releases one or more electrons is a compound selected from the following Groups 1 and 2.

(Group 1) a compound that can be one-electron-oxidized to provide a one-electron oxidation product which further releases one or more electrons, due to being subjected to a subsequent bond cleavage reaction;

(Group 2) a compound that can be one-electron-oxidized to provide a one-electron oxidation product, which further releases one or more electrons after being subjected to a subsequent bond formation.

The compound of Group 1 will be explained below.

In the compound of Group 1, as for a compound that can be one-electron-oxidized to provide a one-electron oxidation product which further releases one electron, due to being subjected to a subsequent bond cleavage reaction, specific examples include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV 1 to 36); JP-W No. 2001-500996 (Compound 1 to 74, 80 to 87, and 92 to 122); U.S. Pat. Nos. 5,747,235 and 5,747,236; EP No. 786692A1 (Compound INV 1 to 35); EP No. 893732A1; U.S. Pat. Nos. 6,054,260 and 5,994,051; etc. Preferred ranges of these compounds are the same as the preferred ranges described in the quoted specifications.

In the compound of Group 1, as for a compound that can be one-electron-oxidized to provide a one-electron oxidation product which further releases one or more electrons, due to being subjected to a subsequent bond cleavage reaction, specific examples include the compounds represented by formula (1) (same as formula (1) described in JP-A No. 2003-114487), formula (2) (same as formula (2) described in JP-A No. 2003-114487), formula (3) (same as formula (1) described in JP-A No. 2003-114488), formula (4) (same as formula (2) described in JP-A No. 2003-114488), formula (5) (same as formula (3) described in JP-A No. 2003-114488), formula (6) (same as formula (1) described in JP-A No. 2003-75950), formula (7) (same as formula (2) described in JP-A No. 2003-75950), and formula (8) (same as formula (1) described in JP2004-239943), and the compound represented by formula (9) (same as formula (3) described in JP2004-245929) among the compounds which can undergo the chemical reaction represented by reaction formula (1). And the preferable range of these compounds is the same as the preferable range described in the quoted specification.

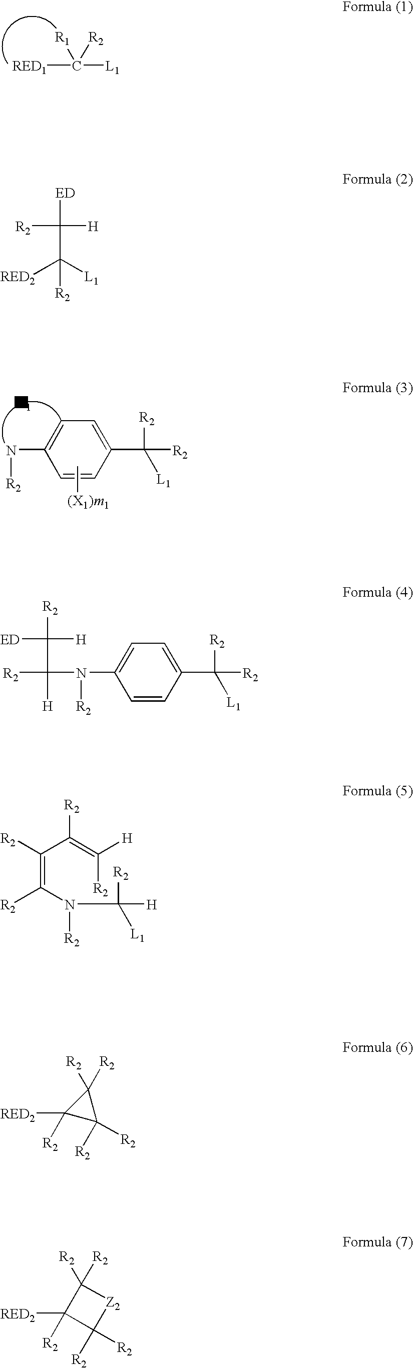

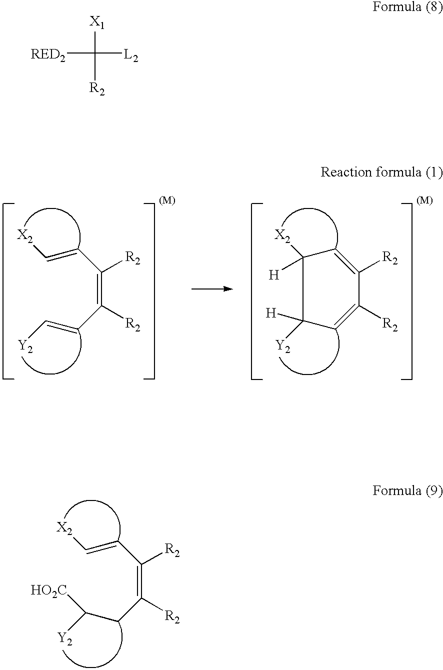

In the formulae, RED₁ and RED₂ represent a reducible group. R₁ represents a nonmetallic atomic group forming a cyclic structure equivalent to a tetrahydro derivative or an octahydro derivative of a 5 or 6 membered aromatic ring (including a hetero aromatic ring) with a carbon atom (C) and RED₁. R₂ represents a hydrogen atom or a substituent. In the case where plural R₂ exist in a same molecule, these may be identical or different from each other. L₁ represents a leaving group. ED represents an electron-donating group. Z, represents an atomic group capable to form a 6 membered ring with a nitrogen atom and two carbon atoms of a benzene ring. X₁ represents a substituent, and m₁ represents an integer of 0 to 3. Z₂ represents one selected from —CR₁₁R₁₂—, —NR₁₃—, or —O—. R₁₁ and R₁₂ each independently represent a hydrogen atom or a substituent. R₁₃ represents one selected from a hydrogen atom, an alkyl group, an aryl group, and a heterocyclic group. X₁ represents one selected from an alkoxy group, an aryloxy group, a heterocyclic oxy group, an alkylthio group, an arylthio group, a heterocyclic thio group, an alkylamino group, an arylamino group, and a heterocyclic amino group. L₂ represents a carboxyl group or a salt thereof, or a hydrogen atom. X₂ represents a group to form a 5 membered heterocycle with C═C. Y2 represents a group to form a 5 or 6 membered aryl or heterocyclic group with C═C. M represents one selected from a radical, a radical cation, and a cation.

Next, the compound of Group 2 is explained.

In the compound of Group 2, as for a compound that can be one-electron-oxidized to provide a one-electron oxidation product which further releases one or more electrons, after being subjected to a subsequent bond cleavage reaction, specific examples can include the compound represented by formula (10) (same as formula (1) described in JP-A No. 2003-140287), and the compound represented by formula (11) (same as formula (2) described in JP-A No. 2004-245929) which can undergo the chemical reaction represented by reaction formula (1). The preferable range of these compounds is the same as the preferable range described in the quoted specification.

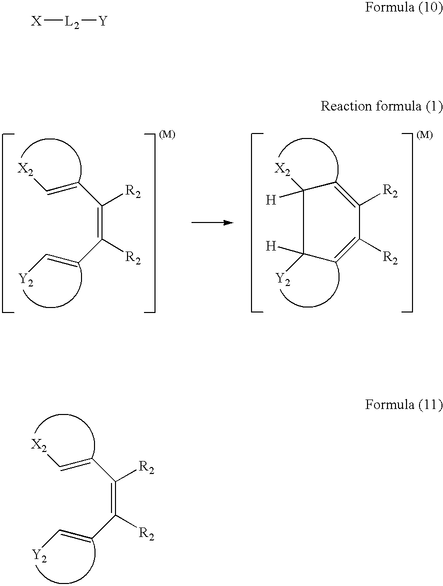

In the formulae described above, X represents a reducible group which can be one-electron-oxidized. Y represents a reactive group containing a carbon-carbon double bond part, a carbon-carbon triple bond part, an aromatic group part or benzo-condensed nonaromatic heterocyclic group which can react with one-electron-oxidized product formed by one-electron-oxidation of X to form a new bond. L₂ represents a linking group to link X and Y R₂ represents a hydrogen atom or a substituent. In the case where plural R₂ exist in a same molecule, these may be identical or different from each other. X₂ represents a group to form a 5 membered heterocycle with C═C. Y₂ represents a group to form a 5 or 6 membered aryl group or heterocyclic group with C═C. M represents one selected from a radical, a radical cation, and a cation.

The compounds of Groups 1 and 2 preferably are “the compound having an adsorptive group to silver halide in a molecule” or “the compound having a partial structure of a spectral sensitizing dye in a molecule”. The representative adsorptive group to silver halide is the group described in JP-A No. 2003-156823, page 16 right, line 1 to page 17 right, line 12. A partial structure of a spectral sensitizing dye is the structure described in JP-A No. 2003-156823, page 17 right, line 34 to page 18 right, line 6.

As the compound of Groups 1 and 2, “the compound having at least one adsorptive group to silver halide in a molecule” is more preferred, and “the compound having two or more adsorptive groups to silver halide in a molecule” is further preferred. In the case where two or more adsorptive groups exist in a single molecule, those adsorptive groups may be identical or different with each other.

As preferable adsorptive group, a nitrogen containing heterocyclic group substituted by a mercapto group (e.g., a 2-mercaptothiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group and the like) or a nitrogen containing heterocyclic group having —NH— group as a partial structure of heterocycle capable to form a silver imidate (>NAg) (e.g., a benzotriazole group, a benzimidazole group, an indazole group and the like) are described. A 5-mercaptotetrazole group, a 3-mercapto-1,2,4-triazole group and a benzotriazole group are particularly preferable and a 3-mercapto-1,2,4-triazole group and a 5-mercaptotetrazole group are most preferable.

As an adsorptive group, the group which has two or more mercapto groups as a partial structure in a molecule is also particularly preferable. Herein, a mercapto group (—SH) may become a thione group in the case where it can tautomerize. As preferred examples of adsorptive group having two or more mercapto groups as a partial structure (dimercapto-substituted nitrogen containing heterocyclic group and the like), a 2,4-dimercaptopyrimidine group, a 2,4-dimercaptotriazine group and a 3,5-dimercapto-1,2,4-triazole group are described.

Further, a quaternary salt structure of nitrogen or phosphorus is also preferably used as an adsorptive group. As typical quaternary salt structure of nitrogen, an ammonio group (a trialkylammonio group, a dialkylarylammonio group, a dialkylheteroarylammonio group, an alkyldiarylammonio group, an alkyldiheteroarylammonio group and the like) and a nitrogen containing heterocyclic group containing quaternary nitrogen atom are described. As a quaternary salt structure of phosphorus, a phosphonio group (a trialkylphosphonio group, a dialkylarylphosphonio group, a dialkylheteroarylphosphonio group, an alkyldiarylphosphonio group, an alkyldiheteroarylphosphonio group, a triarylphosphonio group, a triheteroarylphosphonio group and the like) are described. A quaternary salt structure of nitrogen is more preferably used and a 5 or 6 membered aromatic heterocyclic group containing a quaternary nitrogen atom is further preferably used. Particularly preferably, a pyrydinio group, a quinolinio group and an isoquinolinio group are used. These nitrogen containing heterocyclic groups containing a quaternary nitrogen atom may have any substituent.

As examples of counter anion of quaternary salt, halogen ion, carboxylate ion, sulfonate ion, sulfate ion, perchlorate ion, carbonate ion, nitrate ion, BF₄⁻, PF₆⁻, Ph₄B⁻ and the like are described. In the case where the group having negative charge at carboxylate group and the like exists in a molecule, an inner salt may be formed with it. As a counter anion outside of a molecule, chloro ion, bromo ion and methanesulfonate ion are particularly preferable.

The preferred structure of the compound represented by Group 1 and 2 compound having a quaternary salt of nitrogen or phosphorus as an adsorptive group is represented by formula (X).
(P-Q₁-)ᵢ-R(-Q₂-S)ⱼ Formula (X)

In formula (X), P and R each independently represent a quaternary salt structure of nitrogen or phosphorus, which is not a partial structure of a spectral sensitizing dye. Q₁ and Q₂ each independently represent a linking group and typically represent a single bond, an alkylene group, an arylene group, a heterocyclic group, —O—, —S—, —NR_{N}, —C(═O)—, —SO₂—, —SO—, —P(═O)— and the group which consists of combination of these groups. Herein, R_{N} represents one selected from a hydrogen atom, an alkyl group, an aryl group, and a heterocyclic group. S represents a residue which is obtained by removing one atom from the compound represented by Group 1 or 2. i and j are an integer of one or more and are selected in a range of i+j=2 to 6. The case where i is 1 to 3 and j is 1 to 2 is preferable, the case where i is 1 or 2 and j is 1 is more preferable, and the case where i is 1 and j is 1 is particularly preferable. The compound represented by formula (X) preferably has 10 to 100 carbon atoms in total, more preferably 10 to 70 carbon atoms, further preferably 11 to 60 carbon atoms, and particularly preferably 12 to 50 carbon atoms in total.

The compounds of Groups 1 and 2 may be used at any time during preparation of the photosensitive silver halide emulsion and production of the photothermographic material. For example, the compound may be used in a photosensitive silver halide grain formation step, in a desalting step, in a chemical sensitization step, and before coating, etc. The compound may be added in several times, during these steps. The compound is preferably added, after the photosensitive silver halide grain formation step and before the desalting step; in the chemical sensitization step (Oust before the chemical sensitization to immediately after the chemical sensitization); or before coating. The compound is more preferably added, just before the chemical sensitization step to before mixing with the non-photosensitive organic silver salt.

It is preferred that the compound of Groups 1 and 2 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of Groups 1 and 2 used in the invention is preferably used to the image forming layer comprising the photosensitive silver halide and the non-photosensitive organic silver salt. The compound may be added to a surface protective layer, or an intermediate layer, as well as the image forming layer comprising the photosensitive silver halide and the non-photosensitive organic silver salt, to be diffused to the image forming layer in the coating step. The compound may be added before or after addition of a sensitizing dye. Each compound is contained in the image forming layer preferably in an amount of 1×10⁻⁹ mol to 5×10⁻¹ mol, more preferably 1×10⁻⁸ mol to 5×10⁻² mol, per 1 mol of silver halide.

10) Adsorptive Redox Compound having Adsorptive Group and Reducible Group

The photothermographic material of the present invention preferably comprises an adsorptive redox compound having an adsorptive group and a reducible group in a molecule. It is preferred that the adsorptive redox compound having an adsorptive group and a reducible group used in the invention is represented by the following formula (I).
A-(W)n-B Formula (I)

In formula (I), A represents a group capable of adsorption to a silver halide (hereafter, it is called an adsorptive group), W represents a divalent linking group, n represents 0 or 1, and B represents a reducible group.

In formula (I), the adsorptive group represented by A is a group to adsorb directly to a silver halide or a group to promote adsorption to a silver halide. As typical examples, a mercapto group (or a salt thereof), a thione group (—C(═S)—), a heterocyclic group containing at least one atom selected from a nitrogen atom, a sulfur atom, a selenium atom and a tellurium atom, a sulfide group, a disulfide group, a cationic group, an ethynyl group and the like are described.

The mercapto group as an adsorptive group means a mercapto group (and a salt thereof) itself and simultaneously more preferably represents a heterocyclic group or an aryl group or an alkyl group substituted by at least one mercapto group (or a salt thereof). Herein, as the heterocyclic group, a monocyclic or a condensed aromatic or nonaromatic heterocyclic group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic group having a quaternary nitrogen atom may also be adopted, wherein a mercapto group as a substituent may dissociate to form a mesoion. As a counter ion, whereby a mercapto group forms a salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic group comprising a quaternary nitrogen atom, a phosphonium ion and the like are described.

Further, the mercapto group as an adsorptive group may become a thione group by a tautomerization.

The thione group as an adsorptive group may also contain a chain or a cyclic thioamide group, a thioureido group, a thiouretane group or a dithiocarbamic acid ester group.

The heterocyclic group containing at least one atom selected from a nitrogen atom, a sulfur atom, a selenium atom and a tellurium atom represents a nitrogen atom containing heterocyclic group having —NH— group, as a partial structure of heterocycle, capable to form a silver iminate (>NAg) or a heterocyclic group, having —S— group, —Se— group, —Te— group or ═N— group as a partial structure of heterocycle, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described.

The sulfide group or disulfide group as an adsorptive group contains all groups having “—S—” or “—S—S—” as a partial structure.

The cationic group as an adsorptive group means the group containing a quaternary nitrogen atom, such as an ammonio group or a nitrogen containing heterocyclic group including a quaternary nitrogen atom. As examples of the heterocyclic group containing a quaternary nitrogen atom, a pyridinio group, a quinolinio group, an isoquinolinio group, an imidazolio group and the like are described.

The ethynyl group as an adsorptive group means —C≡CH group and the said hydrogen atom may be substituted.

The adsorptive group described above may have any substituent.

Further, as typical examples of an adsorptive group, the compounds described in pages 4 to 7 in the specification of JP-A No. 11-95355 are described.

As an adsorptive group represented by A in formula (I), a heterocyclic group substituted by a mercapto group (e.g., a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazorium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group and the like) or a nitrogen atom containing heterocyclic group having a —NH— group capable to form an imino-silver (>NAg) as a partial structure of heterocycle (e.g., a benzotriazole group, a benzimidazole group, an indazole group and the like) is preferable, and more preferable as an adsorptive group is a 2-mercaptobenzimidazole group or a 3,5-dimercapto-1,2,4-triazole group.

In formula (I), W represents a divalent linking group. The said linking group may be any divalent linking group, as far as it does not give a bad effect toward photographic properties. For example, a divalent linking group, which includes a carbon atom, a hydrogen atom, an oxygen atom a nitrogen atom and a sulfur atom, can be used. As typical examples, an alkylene group having 1 to 20 carbon atoms (e.g., a methylene group, an ethylene group, a trimethylene group, a tetramethylene group, a hexamethylene group and the like), an alkenylene group having 2 to 20 carbon atoms, an alkynylene group having 2 to 20 carbon atoms, an arylene group having 6 to 20 carbon atoms (e.g., a phenylene group, a nephthylene group and the like), —CO—, —SO₂—, —O—, —S—, —NR₁—, and the combination of these linking groups are described. Herein, R₁ represents a hydrogen atom, an alkyl group, a heterocyclic group, or an aryl group.

The linking group represented by W may have any substituent.

In formula (I), a reducible group represented by B represents the group capable to reduce a silver ion. Examples thereof include a formyl group, an amino group, a triple bond group such as an acetylene group, a propargyl group and the like, a mercapto group, and a residue which is obtained by removing one hydrogen atom from each of the compounds such as hydroxylamines, hydroxamic acids, hydroxyureas, hydroxyurethanes, hydroxysemicarbazides, reductones (reductone derivatives are included), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are included), aclhydrazines, carbamoylhydrazines 3-pyrazolidones and the like. They may have any substituent.

The oxidation potential of a reducible group represented by B in formula (I), can be measured by using the measuring method described in Akira Fujishima, “DENKIKAGAKU SOKUTEIHO”, pages 150 to 208, GIHODO SHUPPAN and The Chemical Society of Japan, “ZIKKEN KAGAKUKOZA”, 4th ed., vol. 9, pages 282 to 344, MARUZEN. For example, the method of rotating disc voltammetry can be used; namely the sample is dissolved in the solution (methanol: pH 6.5 Britton-Robinson buffer=10% : 90% (% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E½) can be calculated by that obtained voltamograph.

When a reducible group represented by B in the present invention is measured by the method described above, an oxidation potential is preferably in a range of about −0.3 V to about 1.0 V, more preferably about −0.1 V to about 0.8 V, and particularly preferably about 0 V to about 0.7 V.

In formula (I), a reducible group represented by B preferably is preferably a residue which is obtained by removing one hydrogen atom from a hydroxylamine, hydroxamic acid, hydroxyurea, hydroxysemicarbazide, reductone, phenol, acylhydrazine, carbamoylhydrazine, 3-pyrazolidone or the like.

The compound of formula (I) in the present invention may have the ballasted group or polymer chain in it generally used in the non-moving photographic additives as a coupler. And as a polymer, for example, the polymer described in JP-A No. 1-100530 can be described.

The compound of formula (I) in the present invention may be bis or tris type of compound. The molecular weight of the compound represented by formula (I) in the present invention is preferably 100 to 10,000 and more preferably 120 to 1,000 and particularly preferably 150 to 500.

The examples of the compound represented by formula (I) in the present invention are shown below, but the present invention is not limited in these.

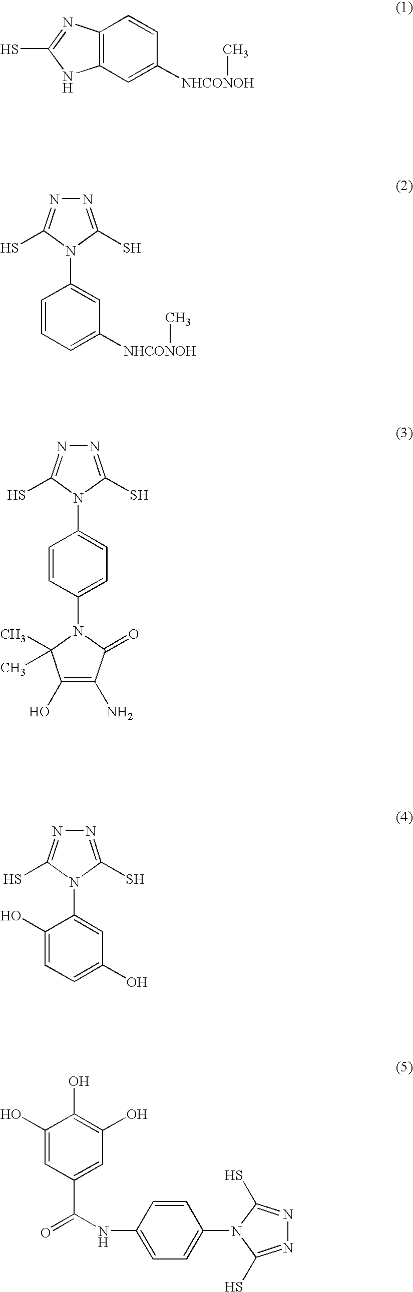

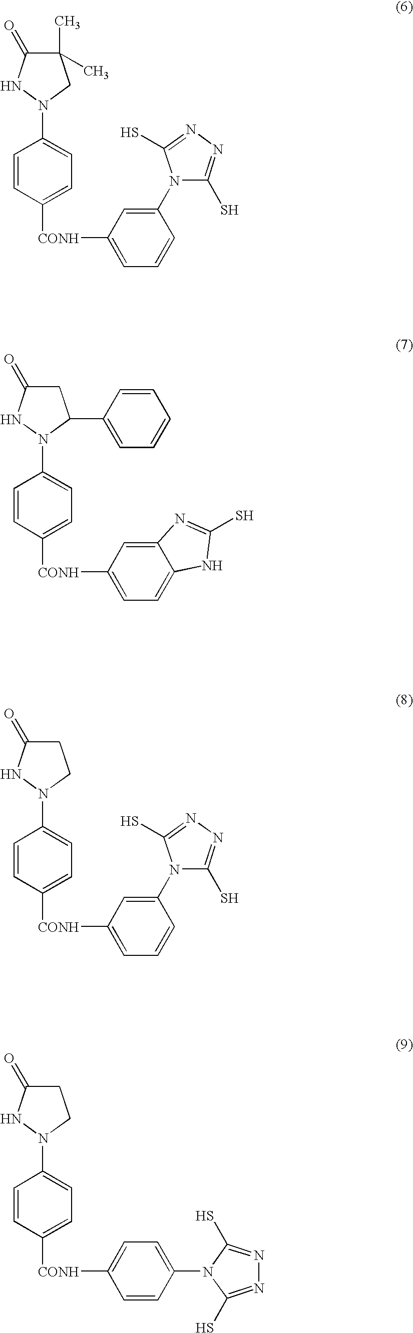

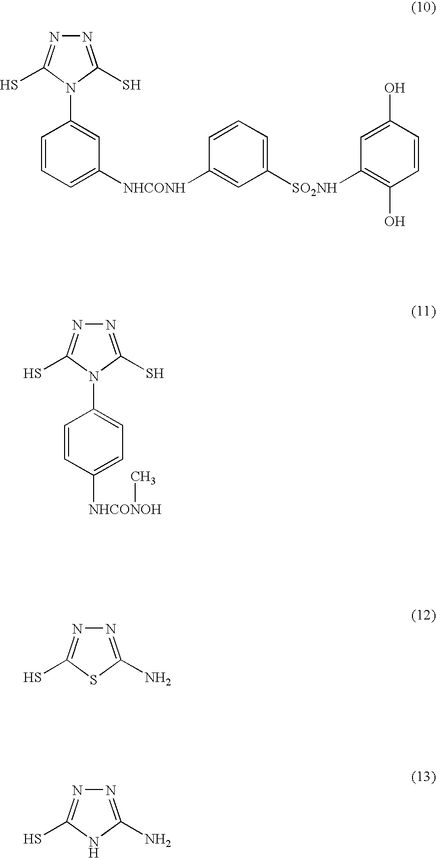

Further, example compounds 1 to 30 and 1″-1 to 1″-77 shown in EP-A No. 1308776A2, pages 73 to 87 are also described as preferable examples of the compound having an adsorptive group and a reducible group according to the invention.

These compounds can be easily synthesized by the known method. The compound of formula (I) in the present invention can be used alone, but it is preferred to use two or more kinds of the compounds in combination. When two or more kinds of the compounds are used in combination, those may be added to the same layer or the different layers, whereby adding methods may be different from each other.

The compound represented by formula (I) in the present invention preferably is added to an image forming layer and more preferably is to be added at an emulsion preparing process. In the case, wherein these compounds are added at an emulsion preparing process, these compounds may be added at any step in the process. For example, the silver halide grain forming step, the step before starting of desalting step, the desalting step, the step before starting of chemical ripening, the chemical ripening step, the step before preparing a final emulsion and the like are described. Also, the addition can be performed in plural times during the process. It is preferred to be added in an image forming layer, but also to be diffused at a coating step from a protective layer or an intermediate layer adjacent to the image forming layer, wherein these compounds are added in the protective layer or the intermediate layer in combination with their addition to the image forming layer.

The preferred addition amount is largely depend on the adding method described above or the kind of the compound, but generally 1×10⁻⁶ mol to 1 mol per 1 mol of photosensitive silver halide, preferably 1×10⁻⁵ mol to 5×10⁻¹ mol, and more preferably 1×10⁻⁴ mol to 1×10⁻¹ mol.

The compound represented by formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added as an emulsified dispersion by dissolving them in an organic solvent having a high boiling point and also may be added as a solid dispersion.

11) Combined Use of a Plurality of Silver Halides

The photosensitive silver halide emulsion in the photothermographic material used in the invention may be used alone, or two or more kinds of them (for example, those of different average particle sizes, different halogen compositions, of different crystal habits and of different conditions for chemical sensitization) may be used together. Gradation can be controlled by using plural kinds of photosensitive silver halide of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

12) Coating Amount

The addition amount of the photosensitive silver halide, when expressed by the amount of coated silver per 1 m² of the photothermographic material, is preferably from 0.03 g/m² to 0.6 g/m², more preferably, from 0.05 g/m² to 0.4 g/m² and, further preferably, from 0.07 g/m² to 0.3 g/m². The photosensitive silver halide is preferably used in the range from 0.01 mol to 0.5 mol, more preferably, from 0.02 mol to 0.3 mol, and further preferably from 0.03 mol to 0.2 mol, per 1 mol of the organic silver salt.

13) Mixing Silver Halide and Organic Silver Salt

The method of mixing the silver halide and the organic silver salt can include a method of mixing a separately prepared photosensitive silver halide and an organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. Any method may be used as far as the effect of the invention can be obtained preferably. Further, a method of mixing two or more kinds of aqueous dispersions of organic silver salts and two or more kinds of aqueous dispersions of photosensitive silver salts upon mixing is used preferably for controlling the photographic properties.

14) Mixing Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai Kongo Gijutu” by N. Hamby and M. F. Edwards, translated by Koji Takahashi (Nikkan Kogyo Shinbunsha, 1989).

(Preferred Solvent for Coating Solution)

In the invention, an aqueous solvent containing water in an amount of 30% by mass or more is preferably used as a solvent (“solvent” means a solvent or a dispersion medium) for a coating solution for an imaging forming layer. The aqueous solution may include as a component, besides water, any water-admixing organic solvent such as methyl alcohol, ethyl alcohol, isopropyl alcohol, methyl cellosolve, ethyl cellosolve, dimethyl formamide, ethyl acetate, or the like. The water content of the solvent for the coating solution is preferably 50% by mass or more, more preferably 70% by mass or more. Preferable examples of the composition of the solvent include, water, water/methyl alcohol=90/10, water/methyl alcohol=70/30, water/methyl alcohol/dimethyl fomamide=80/15/5, water/methyl alcohol/ethyl cellosolve=85/10/5, water/methyl alcohol/isopropyl alcohol=85/10/5 (% by mass).

(Development Accelerator)

In the photothermographic material of the invention, sulfoneamide phenolic compounds described in the specification of JP-A No. 2000-267222, and represented by formula (A) described in the specification of JP-A No. 2000-330234; hindered phenolic compounds represented by formula (II) described in JP-A No. 2001-92075; hydrazine compounds described in the specification of JP-A No. 10-62895, represented by formula (1) described in the specification of JP-A No. 11-15116, represented by formula (D) described in the specification of JP-A No. 2002-156727, and represented by formula (1) described in the specification of JP-A No. 2002-278017; and phenolic or naphthalic compounds represented by formula (2) described in the specification of JP-A No. 2001-264929 are used preferably as a development accelerator. The development accelerator described above is used in a range from 0.1 mol % to 20 mol %, preferably, in a range from 0.5 mol % to 10 mol % and, more preferably, in a range from 1 mol % to 5 mol % with respect to the reducing agent. The introducing methods to the photothermographic material can include, the same methods as those for the reducing agent and, it is particularly preferred to add as a solid dispersion or an emulsion dispersion. In a case of adding as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

In the present invention, it is more preferred to use as a development accelerator, hydrazine compounds represented by formula (D) described in the specification of JP-A No. 2002-156727, and phenolic or naphtholic compounds represented by formula (2) described in the specification of JP-A No. 2001-264929.

Particularly preferred development accelerators of the invention are compounds represented by the following formulae (A-1) and (A-2).

Formula (A-1)

Q₁-NHNH-Q₂

(wherein, Q₁ represents an aromatic group or a heterocyclic group which bonds to —NHNH-Q₂ at a carbon atom, and Q₂ represents one selected from a carbamoyl group, an acyl group, an alkoxycarbonyl group, an aryloxycarbonyl group, a sulfonyl group, and a sulfamoyl group).

In formula (A-1), the aromatic group or the heterocyclic group represented by Q₁ is, preferably, 5 to 7 membered unsaturated ring. Preferred examples include benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene ring. Condensed rings in which the rings described above are condensed to each other are also preferred.

The rings described above may have substituents and in a case where they have two or more substituents, the substituents may be identical or different from each other. Examples of the substituents can include a halogen atom, an alkyl group, an aryl group, a carboamide group, an alkylsulfoneamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case where the substituents are groups capable of substitution, they may have further substituents and examples of preferred substituents can include a halogen atom, an alkyl group, an aryl group, a carbonamide group, an alkylsulfoneamide group, an arylsulfoneamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The carbamoyl group represented by Q₂ is a carbamoyl group preferably having 1 to 50 carbon atoms and, more preferably, having 6 to 40 carbon atoms, and examples can include unsubstituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbaoyl, N-3-pyridylcarbamoyl and N-benzylcarbamoyl.

The acyl group represented by Q₂ is an acyl group, preferably having 1 to 50 carbon atoms and, more preferably 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. The alkoxycarbonyl group represented by Q₂ is an alkoxycarbonyl group, preferably, of 2 to 50 carbon atom and, more preferably, of 6 to 40 carbon atoms and can include, for example, methoxycarbonyl, ethoxycarbonyl, isobutyloxycarbonyl, cyclohexyloxycarbonyl, dodecyloxycarbonyl and benzyloxycarbonyl.

The aryloxy carbonyl group represented by Q₂ is an aryloxycarbonyl group, preferably, having 7 to 50 carbon atoms and, more preferably, having 7 to 40 carbon atoms and can include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group, preferably having 1 to 50 carbon atoms and, more preferably, having 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q₂ is a sulfamoyl group, preferably having 0 to 50 carbon atoms, more preferably, 6 to 40 carbon atoms and can include, for example, unsubstituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The group represented by Q₂ may further have a group mentioned as the example of the substituent of 5 to 7-membered unsaturated ring represented by Q₁ at the position capable of substitution. In a case where the group has two or more substituents, such substituents may be identical or different from each other.

Then, preferred range for the compounds represented by formula (A-1) is to be described. 5 or 6 membered unsaturated ring is preferred for Q₁, and benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring and a ring in which the ring described above is condensed with a benzene ring or unsaturated hetero ring are further preferred. Further, Q₂ is preferably a carbamoyl group and, particularly, a carbamoyl group having a hydrogen atom on the nitrogen atom is particularly preferred.

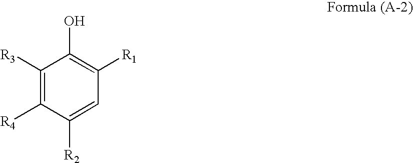

In formula (A-2), R₁ represents one selected from an alkyl group, an acyl group, an acylamino group, a sulfoneamide group, an alkoxycarbonyl group, and a carbamoyl group. R₂ represents one selected from a hydrogen atom, a halogen atom, an alkyl group, an alkoxy group, an aryloxy group, an alkylthio group, an arylthio group, an acyloxy group, and a carbonate ester group. R₃ and R₄ each independently represent a group capable of substituting for a hydrogen atom on a benzene ring which is mentioned as the example of the substituent for formula (A-1). R₃ and R₄ may link together to form a condensed ring.

R₁ is, preferably, an alkyl group having 1 to 20 carbon atoms (for example, a methyl group, an ethyl group, an isopropyl group, a butyl group, a tert-octyl group, a cyclohexyl group, or the like), an acylamino group (for example, an acetylamino group, a benzoylamino group, a methylureido group, a 4-cyanophenylureido group, or the like), or a carbamoyl group (for example, a n-butylcarbamoyl group, an N,N-diethylcarbamoyl group, a phenylcarbamoyl group, a 2-chlorophenylcarbamoyl group, a 2,4-dichlorophenylcarbamoyl group, or the like). An acylamino group (including an ureido group and an urethane group) is more preferred. R₂ is, preferably, a halogen atom (more preferably, a chlorine atom or a bromine atom), an alkoxy group (for example, a methoxy group, a butoxy group, an n-hexyloxy group, an n-decyloxy group, a cyclohexyloxy group, a benzyloxy group, or the like), or an aryloxy group (for example, a phenoxy group, a naphthoxy group, or the like).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Examples of the preferred substituent thereof are identical with those for R₁. In the case where R₄ is an acylamino group, R₄ may preferably link with R₃ to form a carbostyryl ring.

In the case where R₃ and R₄ in formula (A-2) link together to form a condensed ring, a naphthalene ring is particularly preferred as the condensed ring. The same substituent as the example of the substituent referred to for formula (A-1) may bond to the naphthalene ring. In the case where formula (A-2) is a naphtholic compound, R₁ is preferably a carbamoyl group. Among them, benzoyl group is particularly preferred. R₂ is preferably an alkoxy group or an aryloxy group and, particularly preferably an alkoxy group.

Preferred specific examples for the development accelerator of the invention are to be described below. The invention is not restricted to them.

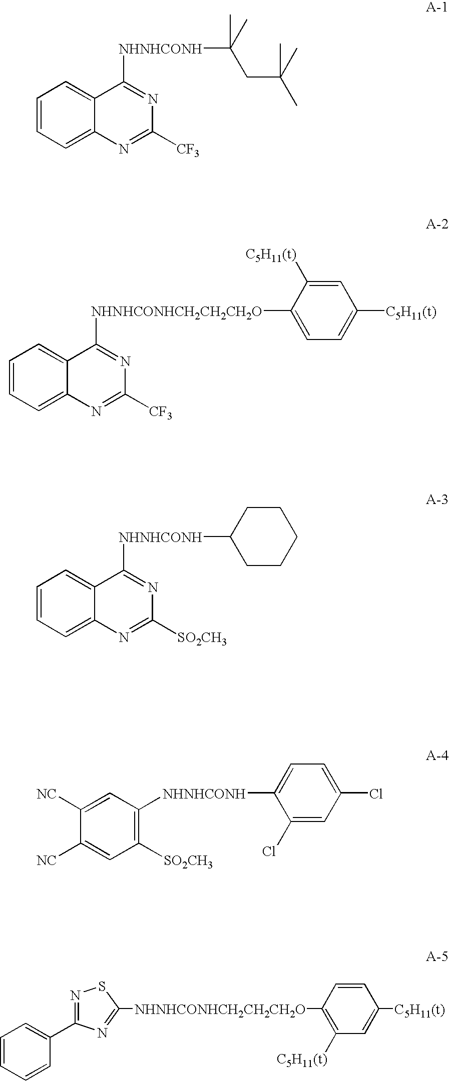

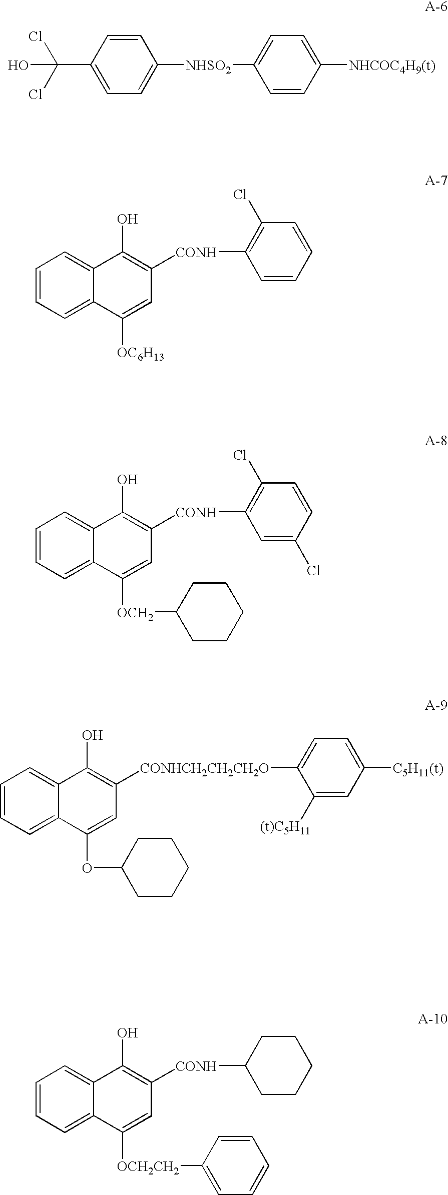

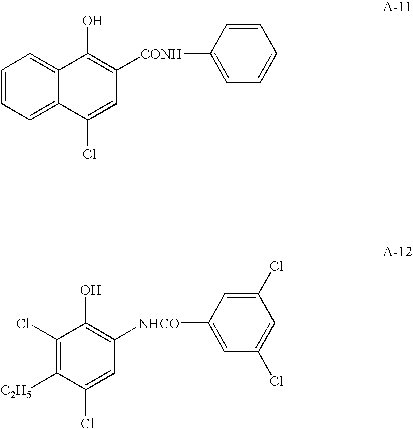

(Hydrogen Bonding Compound)

In the invention, in the case where the reducing agent has an aromatic hydroxy group (—OH) or an amino group (—NHR, R represents each one of a hydrogen atom and an alkyl group), particularly in the case where the reducing agent is a bisphenol described above, it is preferred to use in combination, a non-reducing compound having a group capable of reacting with these groups of the reducing agent, and that is also capable of forming a hydrogen bond therewith.

As a group forming a hydrogen bond with a hydroxyl group or an amino group, there can be mentioned a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferred among them is a phosphoryl group, a sulfoxido group, an amido group (not having >N—H moiety but being blocked in the form of >N—Ra (where, Ra represents a substituent other than H)), an urethane group (not having >N—H moiety but being blocked in the form of >N—Ra (where, Ra represents a substituent other than H)), and an ureido group (not having >N—H moiety but being blocked in the form of >N—Ra (where, Ra represents a substituent other than H)).

In the invention, particularly preferable as the hydrogen bonding compound is the compound expressed by formula (D) shown below.

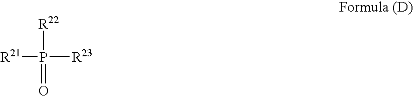

In formula (D), R²¹ to R²³ each independently represent one selected from an alkyl group, an aryl group, an alkoxy group, an aryloxy group, an amino group, and a heterocyclic group, which may be substituted or unsubstituted.

In the case where R²¹ to R²³ contain a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., a methyl group, an ethyl group, an isopropyl group, a t-butyl group, a t-octyl group, a phenyl group, a 4-alkoxyphenyl group, a 4-acyloxyphenyl group, and the like.

Specific examples of an alkyl group expressed by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, a 2-phenoxypropyl group, and the like.

As an aryl group, there can be mentioned a phenyl group, a cresyl group, a xylyl group, a naphthyl group, a 4-t-butylphenyl group, a 4-t-octylphenyl group, a 4-anisidyl group, a 3,5-dichlorophenyl group, and the like.

As an alkoxyl group, there can be mentioned a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

As an aryloxy group, there can be mentioned a phenoxy group, a cresyloxy group, an isopropylphenoxy group, a 4-t-butylphenoxy group, a naphthoxy group, a biphenyloxy group, and the like.

As an amino group, there can be mentioned are a dimethylamino group, a diethylamino group, a dibutylamino group, a dioctylamino group, an N-methyl-N-hexylamino group, a dicyclohexylamino group, a diphenylamino group, an N-methyl-N-phenylamino, and the like.

Preferred as R²¹ to R²³ is an alkyl group, an aryl group, an alkoxy group, or an aryloxy group. Concerning the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

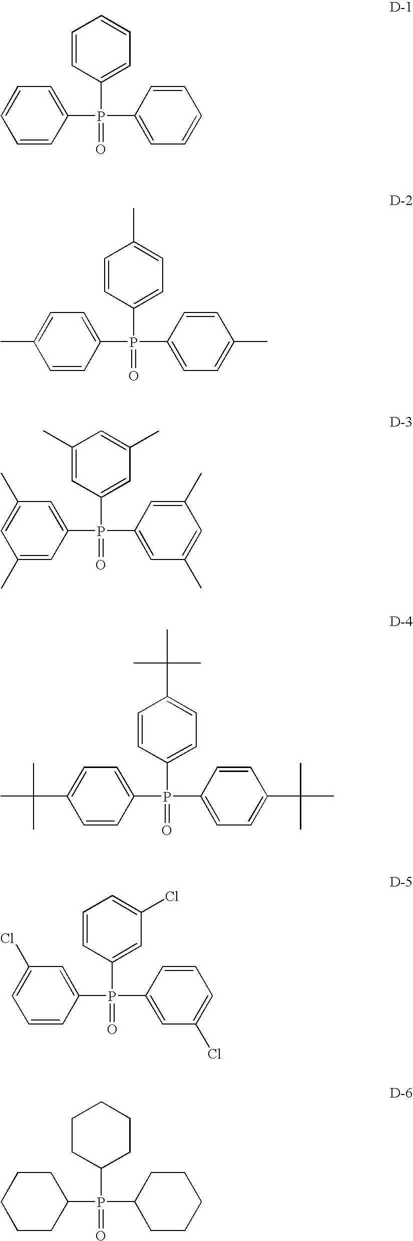

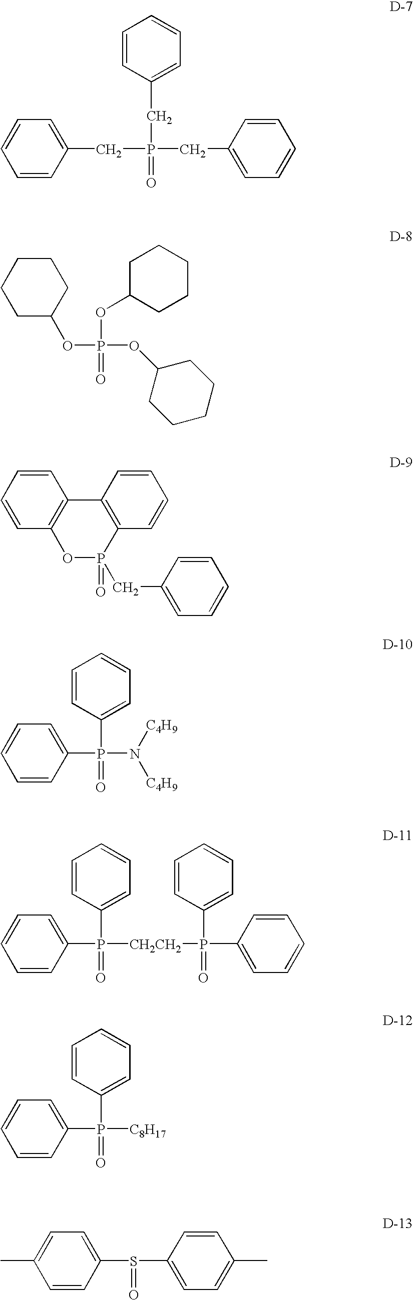

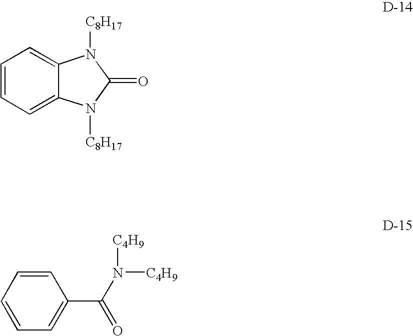

Specific examples of hydrogen bonding compounds other than those enumerated above can be found in those described in EP No. 1096310 and in JP-A Nos. 2002-156727 and 2002-318431.

The compound expressed by formula (D) used in the invention can be used in the photothermographic material by being incorporated into the coating solution in the form of solution, emulsion dispersion, or solid fine particle dispersion similar to the case of reducing agent, however, it is preferred to be used in the form of solid dispersion. In the solution, the compound expressed by formula (D) forms a hydrogen-bonded complex with a compound having a phenolic hydroxyl group or an amino group, and can be isolated as a complex in crystalline state depending on the combination of the reducing agent and the compound expressed by formula (D).

It is particularly preferred to use the crystal powder thus isolated in the form of solid fine particle dispersion, because it provides stable performance. Further, it is also preferred to use a method of leading to form complex during dispersion by mixing the reducing agent and the compound expressed by formula (D) in the form of powders and dispersing them with a proper dispersion agent using sand grinder mill or the like.

The compound expressed by formula (D) is preferably used in a range from 1 mol % to 200 mol %, more preferably from 10 mol % to 150 mol %, and further preferably, from 20 mol % to 100 mol %, with respect to the reducing agent.

(Binder)

Any kind of hydrophobic polymer may be used as the hydrophobic binder for the image forming layer in the photothermographic material. Suitable as the binder are those that are transparent or translucent, and that are generally colorless, such as natural resin or polymer and their copolymers; synthetic resin or polymer and their copolymer; or media forming a film; for example, included are rubber, cellulose acetate, cellulose acetate butyrate, poly(vinyl chloride), poly(methacrylic acid), styrene-maleic anhydride copolymers, styrene-acrylonitrile copolymers, styrene-butadiene copolymers, poly(vinyl acetal) (e.g., poly(vinyl formal) and poly(vinyl butyral)), polyester, polyurethane, phenoxy resin, poly(vinylidene chloride), polyepoxide, polycarbonate, poly(vinyl acetate), polyolefin, cellulose esters, and polyamide. A binder may be used with water, an organic solvent or emulsion to form a coating solution.

In the invention, the glass transition temperature (Tg) of the binder which can be used in combination for the image forming layer is preferably in a range from 0° C. to 80° C. (hereinafter, may be referred to as a “high Tg binder”), more preferably from 10° C. to 70° C. and, even more preferably from 15° C. to 60° C.

In the specification, Tg is calculated according to the following equation.
1/Tg=ρ(Xi/Tgi)

Where, the polymer is obtained by copolymerization of n monomer compounds (from i=1 to i=n); Xi represents the mass fraction of the ith monomer (ΣXi=1), and Tgi is the glass transition temperature (absolute temperature) of the homopolymer obtained with the ith monomer. The symbol Σ stands for the summation from i=1 to i=n. Values for the glass transition temperature (Tgi) of the homopolymers derived from each of the monomers were obtained from J. Brandrup and E. H. Immergut, Polymer Handbook (3rd Edition) (Wiley-Interscience, 1989).

The binder may be of two or more kinds of polymers, when necessary. And, the polymer having Tg of 20° C. or more and the polymer having Tg of less than 20° C. can be used in combination. In the case where two or more kinds of polymers differing in Tg may be blended for use, it is preferred that the mass-average Tg is in the range mentioned above.

In the invention, it is preferred that the image forming layer is formed by first applying a coating solution containing 30% by mass or more of water in the solvent and by then drying.

In the case where the image forming layer is formed by first applying a coating solution containing 30% by mass or more of water in the solvent and by then drying, furthermore, in the case where the binder of the image forming layer is soluble or dispersible in an aqueous solvent (water solvent), and particularly in the case where a polymer latex having an equilibrium water content of 2% by mass or lower under 25° C. and 60% RH is used, the performance can be ameliorated. Most preferred embodiment is such prepared to yield an ion conductivity of 2.5 mS/cm or lower, and as such a preparing method, there can be mentioned a refining treatment using a separation function membrane after synthesizing the polymer.

The aqueous solvent in which the polymer is soluble or dispersible, as referred herein, signifies water or water containing mixed therein 70% by mass or less of a water-admixing organic solvent. As water-admixing organic solvents, there can be mentioned, for example, alcohols such as methyl alcohol, ethyl alcohol, propyl alcohol, and the like; cellosolves such as methyl cellosolve, ethyl cellosolve, butyl cellosolve, and the like; ethyl acetate, dimethylformamide, and the like.

The term aqueous solvent is also used in the case the polymer is not thermodynamically dissolved, but is present in a so-called dispersed state.

The term “equilibrium water content under 25° C. and 60% RH” as referred herein can be expressed as follows:
Equilibrium water content under 25° C. and 60% RH=[(W1−W0)/W0]×100(% by mass)

wherein, W1 is the mass of the polymer in moisture-controlled equilibrium under the atmosphere of 25° C. and 60% RH, and W0 is the absolutely dried mass at 25° C. of the polymer.

For the definition and the method of measurement for water content, reference can be made to Polymer Engineering Series 14, “Testing methods for polymeric materials” (The Society of Polymer Science, Japan, published by Chijin Shokan).

The equilibrium water content under 25° C. and 60% RH is preferably 2% by mass or lower, but is more preferably, 0.01% by mass to 1.5% by mass, and is most preferably, 0.02% by mass to 1% by mass.

The binders used in the invention are, particularly preferably, polymers capable of being dispersed in aqueous solvent. Examples of dispersed states may include a latex, in which water-insoluble fine particles of hydrophobic polymer are dispersed, or such in which polymer molecules are dispersed in molecular states or by forming micelles, but preferred are latex-dispersed particles. The average particle size of the dispersed particles is in the range from 1 nm to 50,000 nm, preferably from 5 nm to 1,000 nm, more preferably 10 nm to 500 nm, and even more preferably 50 nm to 200 nm. There is no particular limitation concerning particle size distribution of the dispersed particles, and may be widely distributed or may exhibit a monodisperse particle size distribution. From the viewpoint of controlling the physical properties of the coating solution, preferred mode of usage includes mixing two or more types of particles each having monodisperse particle distribution.

In the invention, preferred embodiment of the polymers capable of being dispersed in aqueous solvent includes hydrophobic polymers such as acrylic polymers, polyester, rubber (e.g., SBR resin), polyurethane, poly(vinyl chloride), poly(vinyl acetate), poly(vinylidene chloride), polyolefin, and the like. As the polymers above, usable are straight chain polymers, branched polymers, or crosslinked polymers; also usable are the so-called homopolymers in which one kind of monomer is polymerized, or copolymers in which two or more kinds of monomers are polymerized. In the case of a copolymer, it may be a random copolymer or a block copolymer. The molecular weight of these polymers is, in number average molecular weight, in a range from 5,000 to 1,000,000, preferably from 10,000 to 200,000. Those having too small molecular weight exhibit insufficient mechanical strength on forming the image forming layer, and those having too large molecular weight are also not preferred because the filming properties result poor. Further, a polymer latex having crosslinking property is particularly preferably used.

<Specific Examples of Latex>

Specific examples of preferred polymer latex are given below, which are expressed by the starting monomers with % by mass given in parenthesis. The molecular weight is given in number average molecular weight. In the case polyfunctional monomer is used, the concept of molecular weight is not applicable because they build a crosslinked structure. Hence, they are denoted as “crosslinking”, and the molecular weight is omitted. Tg represents glass transition temperature.

P-1; Latex of—MMA(70)—EA(27}MAA(3)—(molecular weight 37000, Tg 61° C.)

P-2; Latex of—MMA(70)—2EHA(20)—St(5)—AA(5)—(molecular weight 40000, Tg 59° C.)

P-3; Latex of—St(50)—Bu(47)—MAA(3)—(crosslinking, Tg −17° C.)

P-4; Latex of—St(68)—Bu(29)—AA(3)—(crosslinking, Tg 17° C.)

P-5; Latex of—St(71)—Bu(26)—AA(3)—(crosslinking, Tg 24° C.)

P-6; Latex of—St(70)—Bu(27)—IA(3)—(crosslinking)

P-7; Latex of—St(75)—Bu(24)—AA(1)—(crosslinking, Tg 29° C.)

P-8; Latex of—St(60)—Bu(35)—DVB(3)—MAA(2)—(crosslinking)

P-9; Latex of—St(70)—Bu(25)—DVB(2)—AA(3)—(crosslinking)

P-10; Latex of—VC(50)—MMA(20)—EA(20)—AN(5)—AA(5)—(molecular weight 80000)

P-11; Latex of—VDC(85)—MMA(5)—EA(5)—MAA(5)—(molecular weight 67000)

P-12; Latex of—Et(90)—MAA(10)—(molecular weight 12000)

P-13; Latex of—St(70)—2EHA(27)—AA(3)—(molecular weight 130000, Tg 43° C.)

P-14; Latex of—MMA(63)—EA(35)—AA(2)—(molecular weight 33000, Tg 47° C.)

P-15; Latex of—St(70.5)—Bu(26.5)—AA(3)—(crosslinking, Tg 23° C.)

P-16; Latex of—St(69.5)—Bu(27.5)—AA(3)—(crosslinking, Tg 20.5° C.)

In the structures above, abbreviations represent monomers as follows. MMA: methyl metacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid.

The polymer latexes above are commercially available, and polymers below are usable. As examples of acrylic polymers, there can be mentioned Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; as examples of polyester, there can be mentioned FINETEX ES650, 611, 675, and 850 (all manufactured by Dainippon Ink and Chemicals, Inc.), WD-size and WMS (all manufactured by Eastman Chemical Co.), and the like; as examples of polyurethane, there can be mentioned HYDRAN AP10, 20, 30, and 40 (all manufactured by Dainippon Ink and Chemicals, Inc.), and the like; as examples of rubber, there can be mentioned LACSTAR 7310K, 3307B, 4700H, and 7132C (all manufactured by Dainippon Ink and Chemicals, Inc.), Nipol Lx416,410, 438C, and 2507 (all manufactured by Nippon Zeon Co., Ltd.), and the like; as examples of poly(vinyl chloride), there can be mentioned G351 and G576 (all manufactured by Nippon Zeon Co., Ltd.), and the like; as examples of poly(vinylidene chloride), there can be mentioned L502 and L513 (all manufactured by Asahi Chemical Industry Co., Ltd.), and the like; as examples of polyolefin, there can be mentioned Chemipearl S120 and SA100 (all manufactured by Mitsui Petrochemical Industries, Ltd.), and the like.

The polymer latex above may be used alone, or may be used by blending two or more kinds depending on needs.

<Preferable Latex>

Particularly preferable as the polymer latex for use in the invention is that of styrene-butadiene copolymer. The mass ratio of monomer unit for styrene to that of butadiene constituting the styrene-butadiene copolymer is preferably in the range of from 40:60 to 95:5. Further, the monomer unit of styrene and that of butadiene preferably account for 60% by mass to 99% by mass with respect to the copolymer. Further, the polymer latex of the invention preferably contains acrylic acid or methacrylic acid in a range from 1% by mass to 6% by mass with respect to the sum of styrene and butadiene, and more preferably from 2% by mass to 5% by mass.

The polymer latex of the invention preferably contains acrylic acid. Preferable range of molecular weight is similar to that described above.

As the latex of styrene-butadiene copolymer preferably used in the invention, there can be mentioned P-3 to P-8 and P-15, or commercially available LACSTAR-3307B, 7132C, Nipol Lx416, and the like.

In the image forming layer of the photothermographic material according to the invention, if necessary, there can be added hydrophilic polymers such as gelatin, polyvinyl alcohol, methyl cellulose, hydroxypropyl cellulose, carboxymethyl cellulose, and the like. These hydrophilic polymers are added at an amount of 30% by mass or less, and preferably 20% by mass or less, with respect to the total mass of the binder incorporated in the image forming layer.

According to the invention, the layer containing organic silver salt (image forming layer) is preferably formed by using polymer latex for the binder. According to the amount of the binder for the image forming layer, the mass ratio for total binder to organic silver salt (total binder/organic silver salt) is in a range of from 1/10 to 10/1, preferably from 1/3 to 5/1, and more preferably from 1/1 to 3/1.

The layer containing organic solver salt is, in general, a image forming layer (emulsion layer) containing a photosensitive silver halide, i.e., the photosensitive silver salt; in such a case, the mass ratio for total binder to silver halide (total binder/silver halide) is in the range of from 400 to 5, more preferably, from 200 to 10.

The total amount of binder in the image forming layer of the invention is preferably in the range from 0.2 g/m² to 30 g/m², more preferably from 1 g/m² to 15 g/m², and further preferably from 2 g/m² to 10 g/m². As for the image forming layer of the invention, there may be added a crosslinking agent for crosslinking, or a surfactant and the like to improve coating properties.

(Antifoggant)

1) Organic Polyhalogen Compound

Preferable organic polyhalogen compound that can be used in the invention is explained specifically below. In the invention, preferred organic polyhalogen compounds are the compounds expressed by the following formula (H).
Q-(Y)n-C(Z₁)(Z₂)X Formula (H)

In formula (H), Q represents one selected from an alkyl group, an aryl group, and a heterocyclic group; Y represents a divalent linking group; n represents 0 or 1; Z, and Z₂ each represent a halogen atom; and X represents one of a hydrogen atom and an electron-attracting group.

In formula (H), Q is preferably an alkyl group having 1 to 6 carbon atoms, an aryl group having 6 to 12 carbon atoms, or a heterocyclic group comprising at least one nitrogen atom (pyridine, quinoline or the like).

In the case where Q is an aryl group in formula (H), Q preferably is a phenyl group substituted by an electron-attracting group whose Hammett substituent constant op yields a positive value. For the details of Hammett substituent constant, reference can be made to Journal of Medicinal Chemistry, vol. 16, No. 11 (1973), pp. 1207 to 1216, and the like. As such electron-attracting groups, examples include, halogen atoms, an alkyl group substituted by an electron-attracting group, an aryl group substituted by an electron-attracting group, a heterocyclic group, an alkyl sulfonyl group, an aryl sulfonyl group, an acyl group, an alkoxycarbonyl group, a carbamoyl group, sulfamoyl group and the like. Preferable as the electron-attracting group is a halogen atom, a carbamoyl group, or an arylsulfonyl group, and particularly preferred among them is a carbamoyl group.

X preferably is an electron-attracting group. As the electron-attracting group, preferable are a halogen atom, an aliphatic sulfonyl group, an aryl sulfonyl group, a heterocyclic sulfonyl group, an aliphatic acyl group, an aryl acyl group, a heterocyclic acyl group, an aliphatic oxycarbonyl group, an aryl oxycarbonyl group, a heterocyclic oxycarbonyl group, a carbamoyl group, and a sulfamoyl group; more preferable are a halogen atom and a carbamoyl group; and particularly preferable is a bromine atom.

Z₁ and Z₂ each are preferably a bromine atom or an iodine atom, and more preferably, a bromine atom.

Y preferably represents —C(═O)—, —SO—, —SO₂—, —C(═O)N(R)—, or —SO₂N(R)—; more preferably, —C(═O)—, —SO₂—, or —C(═O)N(R)—; and particularly preferably, —SO₂— or —C(═O)N(R)—. Herein, R represents one selected from a hydrogen atom, an aryl group, and an alkyl group, preferably a hydrogen atom or an alkyl group, and particularly preferably a hydrogen atom.

n represents 0 or 1, and preferably represents 1.

In formula (H), in the case where Q is an alkyl group, Y is preferably —C(═O)N(R)—. And, in the case where Q is an aryl group or a heterocyclic group, Y is preferably —SO₂—.

In formula (H), the form where the residues, that are obtained by removing a hydrogen atom from the compound, bind each other (generally called as bis type, tris type, or tebrais type) is also preferably used.

In formula (H), the form having a substituent of a dissociative group (for example, a COOH group or a salt thereof, a SO₃H group or a salt thereof, a PO₃H group or a salt thereof, and the like), a group containing a quaternary nitrogen atom (for example, an ammonium group, a pyridinium group, and the like), a polyethyleneoxy group, a hydroxy group, or the like is also preferable.

Specific examples of the compound expressed by formula (H) of the invention are shown below.

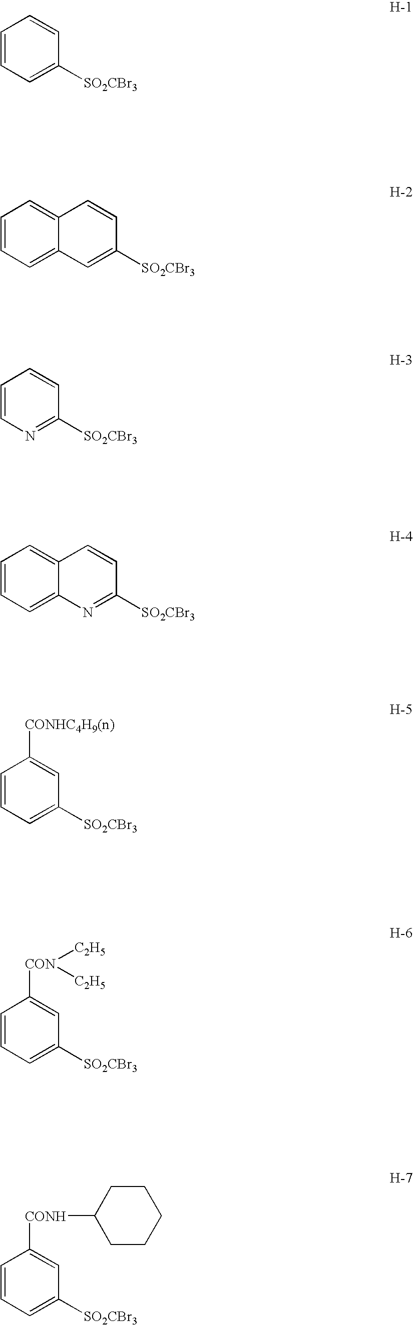

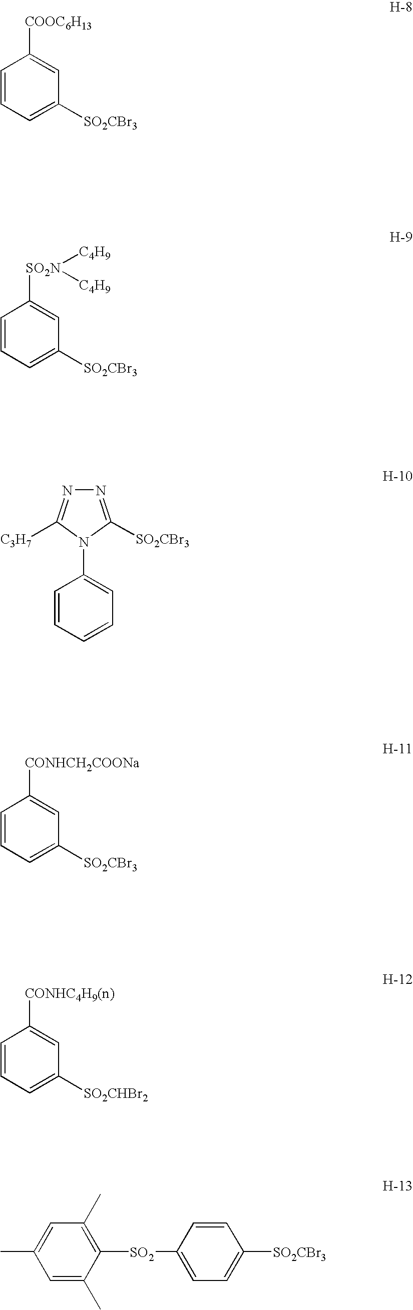

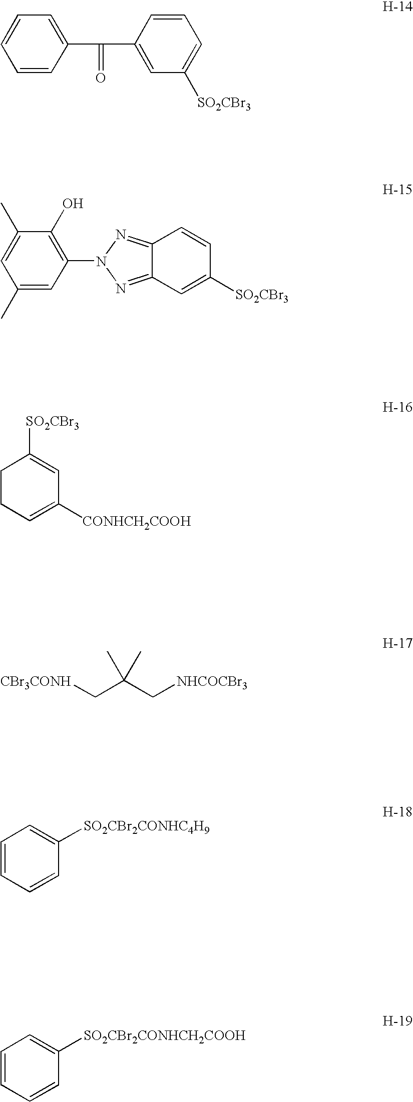

As preferred organic polyhalogen compounds of the invention other than those above, there can be mentioned compounds disclosed in U.S. Pat. Nos. 3,874,946, 4,756,999, 5,340,712, 5,369,000, 5,464,737, and 6,506,548, JP-A Nos. 50-137126, 50-89020, 50-119624, 59-57234, 7-2781, 7-5621, 9-160164, 9-244177, 9-244178, 9-160167, 9-319022, 9-258367, 9-265150,9-319022, 10-197988, 10-197989, 11-242304, 2000-2963, 2000-112070, 2000-284410, 2000-284412, 2001-33911, 2001-31644, 2001-312027, and 2003-50441. Particularly, compounds disclosed in JP-A Nos. 7-2781, 2001-33911 and 20001-312027 are preferable.

The compounds expressed by formula (H) of the invention are preferably used in an amount from 10⁻⁴ mol to 1 mol, more preferably, 10⁻³ mol to 0.5 mol, and further preferably, 1×10⁻² mol to 0.2 mol, per 1 mol of non-photosensitive silver salt incorporated in the image forming layer.

In the invention, usable methods for incorporating the antifoggant into the photothermographic material are those described above in the method for incorporating the reducing agent, and similarly, for the organic polyhalogen compound, it is preferably added in the form of a solid fine particle dispersion.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound of claim 9 of JP-A No. 11-352624, a compound expressed by general formula (III) described in JP-A No. 6-11791, 4-hydroxy-6-methyl-1,3,3a, 7-tetrazaindene and the like.

The photothermographic material of the invention may further contain an azolium salt in order to prevent fogging. As azolium salts, there can be mentioned a compound expressed by formula (XI) as described in JP-A No. 59-193447, a compound described in JP-B No. 55-12581, and a compound expressed by formula (II) in JP-A No. 60-153039. The azolium salt may be added to any part of the photothermographic material, but as the addition layer, preferred is to select a layer on the side having thereon the image forming layer, and more preferred is to select the image forming layer. The azolium salt may be added at any time of the process of preparing the coating solution; in the case where the azolium salt is added into the layer containing the organic silver salt, any time of the process may be selected, from the preparation of the organic silver salt to the preparation of the coating solution, but preferred is to add the salt after preparing the organic silver salt and just before the coating. As the method for adding the azolium salt, any method using a powder, a solution, a fine-particle dispersion, and the like, may be used.

Furthermore, it may be added as a solution having mixed therein other additives such as sensitizing agents, reducing agents, toners, and the like.

In the invention, the azolium salt may be added at any amount, but preferably, it is added in a range from 1×10⁻⁶ mol to 2 mol, and more preferably, from 1×10⁻³ mol to 0.5 mol, per 1 mol of silver.

(Other Additives)

1) Mercapto Compounds, Disulfides and Thiones

In the invention, mercapto compounds, disulfide compounds, and thione compounds may be added in order to control the development by suppressing or enhancing development, to improve spectral sensitizing efficiency, and to improve storability before and after development. Descriptions can be found in paragraph Nos. 0067 to 0069 of JP-A No. 10-62899, a compound expressed by formula (1) of JP-A No. 10-186572 and specific examples thereof shown in paragraph Nos. 0033 to 0052, in lines 36 to 56 in page 20 of EP-A No. 0803764A1. Among them, mercapto-substituted heterocyclic aromatic compounds, which are described in JP-A Nos. 9-297367, 9-304875, 2001-100358, 2002-303954, 2002-303951 and the like, are particularly preferred.

2) Toner

In the photothermographic material of the present invention, the addition of a toner is preferred. The description of the toner can be found in JP-A No. 10-62899 (paragraph Nos. 0054 to 0055), EP-A No. 0803764A1 (page 21, lines 23 to 48), and JP-A Nos. 2000-356317 and 2000-187298. Preferred are phthalazinones (phthalazinone, phthalazinone derivatives and metal salts thereof, e.g., 4-(1-naphthyl)phthalazinone, 6-chlorophthalazinone, 5,7-dimethoxyphthalazinone and 2,3-dihydro-1,4-phthalazinedione); combinations of a phthalazinone and a phthalic acid (e.g., phthalic acid, 4-methylphthalic acid, 4-nitrophthalic acid, diammonium phthalate, sodium phthalate, potassium phthalate and tetrachlorophthalic anhydride); phthalazines (phthalazine, phthalazine derivatives and metal salts thereof, e.g., 4-(1-naphthyl)phthalazine, 6-isopropylphthalazine, 6-ter-butylphthalazine, 6-chlorophthalazine, 5,7-dimethoxyphthalazine and 2,3-dihydrophthalazine); combinations of a phthalazine and a phthalic acid. Particularly preferred is a combination of a phthalazine and a phthalic acid. Among them, particularly preferable are the combination of 6-isopropylphthalazine and phthalic acid, and the combination of 6-isopropylphthalaline and 4-methylphthalic acid.

3) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573.

4) Nucleator

As for the photothermographic material of the invention, it is preferred to add a nucleator into the image forming layer. Details on the nucleators, method of their addition and addition amount can be found in paragraph No. 0118, paragraph Nos. 0136 to 0193 of JP-A No. 11-223898, as compounds expressed by formulae (H), (1) to (3), (A), and (B) in JP-A No. 2000-284399; as for a nucleation accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into the side having thereon the image forming layer containing photosensitive silver halide, at an amount of 5 mmol or less, and preferably, 1 mmol or less per 1 mol of silver.

In the case of using a nuleator in the photothermographic material of the invention, it is preferred to use an acid resulting from hydration of diphosphorus pentaoxide, or a salt thereof in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The addition amount of the acid obtained by hydration of diphoshorus pentaoxide or the salt thereof (i.e., the coating amount per 1 m² of the photothermographic material) may be set as desired depending on sensitivity and fogging, but preferred is an amount of from 0.1 mg/m² to 500 mg/m², and more preferably, from 0.5 mg/m² to 100 mg/m².

(Preparation of Coating Solution and Coating)

The temperature for preparing the coating solution for the image forming layer of the invention is preferably from 30° C to 65° C, more preferably, from 35° C. or more to less than 60° C. and further preferably, from 35° C. to 55° C. Furthermore, the temperature of the coating solution for the image forming layer immediately after adding the polymer latex is preferably maintained in the temperature range of from 30° C. to 65° C.

(Layer Constitution and Other Constituent Components)

The non-photosensitive layers according to the invention can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer which is provided to the side opposite to the image forming layer.

Furthermore, a layer that functions as an optical filter may be provided as (a) or (b) above. An antihalation layer may be provided as (c) or (d) to the photosensitive material.

1) Surface Protective Layer

The photothermographic material of the invention may further comprise a surface protective layer with an object to prevent adhesion of the image forming layer. The surface protective layer may be a single layer, or plural layers.

Description on the surface protective layer may be found in paragraph Nos. 0119 to 0120 of JP-A No. 11-65021 and in JP-A No. 2000-171936.

Preferred as the binder of the surface protective layer of the invention is gelatin, but polyvinyl alcohol (PVA) may be used preferably instead, or in combination. As gelatin, there can be used an inert gelatin (e.g., Nitta gelatin 750), a phthalated gelatin (e.g., Nitta gelatin 801), and the like. Usable as PVA are those described in paragraph Nos. 0009 to 0020 of JP-A No. 2000-171936, and preferred are the completely saponified product PVA-105 and the partially saponified PVA-205 and PVA-335, as well as modified polyvinyl alcohol MP-203 (trade name of products from Kuraray Ltd.). The amount of coated polyvinyl alcohol (per 1 m² of support) in the surface protective layer (per one layer) is preferably in the range from 0.3 g/m² to 4.0 g/m², and more preferably, from 0.3 g/m² to 2.0 g/m².

The total amount of the coated binder (including water-soluble polymer and latex polymer) (per 1 m² of support) in the surface protective layer (per one layer) is preferably in a range from 0.3 g/m² to 5.0 g/m², and more preferably, from 0.3 g/m² to 2.0 g/m².

2) Antihalation Layer

The photothermographic material of the present invention preferably comprises an antihalation layer provided to the side farther from the light source with respect to the image forming layer. Preferably, it is a back layer, or a layer provided between the support and the image forming layer, and more preferably a back layer.

Descriptions on the antihalation layer can be found in paragraph Nos. 0123 to 0124 of JP-A No. 11-65021, in JP-A Nos. 11-223898, 9-230531,10-36695, 10-104779, 11-231457, 11-352625, 11-352626, and the like.

The antihalation layer contains an antihalation dye that has absorption at exposure wavelength. When the exposure wavelength is in infrared region, infrared absorption dye that have maximum absorption in that wavelength region are used In that case, it is preferable to use a dye that does not have absorption in visible region.

It is preferable that the metal phthalocyanine dye is used as the antihalation dye in the photothermographic material according to the invention.

The dye may be added in an amount so as to obtain an optical density measured at the target wavelength of more than 0.1. The optical density is preferably 0.1 to 1.0, and more preferably 0.2 to 0.6. The amount of the dye to obtain such optical density is generally 10 to 150 mg/m², and preferably 20 to 120 mg/m².

3) Back Layer

Back layers usable in the invention are described in paragraph Nos. 0128 to 0130 of JP-A No. 11-65021.

In the photothermographic material according to the invention, a layer containing the phthalocyanine metal compound is preferably used as the antihalation layer.

In the invention, coloring matters having maximum absorption in the wavelength range from 300 nm to 450 nm may be added in order to improve color tone of developed silver images and a deterioration of the images during aging. Such coloring matters are described in JP-A Nos. 62-210458, 63-104046, 63-103235, 63-208846, 63-306436, 63-314535, 01-61745, 2001-100363, and the like.

Such coloring matters are generally added in the range from 0.1 mg/M² to 1 g/m². The coloring matters are preferably added to a back layer disposed on the opposite side of the image forming layer.

In order to adjust the base color tone of the photothermographic material of the invention, it is preferred to use a magenta dye. Specific examples of the dye for this purpose include azo dyes, azomethine dyes, quinone dyes (such as anthraquinone and naphthoquinone dyes), quinoline dyes (such as a quinophthalone dye), methine dyes (such as cyanine, melocyanine, arylidene, styryl, and oxonol dyes), carbonium dyes (such as cationic dyes, e.g., diphenylmethane, triphenylnethane, xanthene and acridine dyes), indigo aniline dyes, azine dyes (such as cationic dyes, e.g., thiazine dyes, oxazine dyes, and phenazine dyes), aza[18] π electron system dyes (such as porphin, tetraazaporphin and phthalocyanine dyes), indigoid dyes (such as indigo, and thioindigo dyes), squalilium dyes, croconium dyes, pyrromethene dyes (which are allowable to form metal complexes), and nitro/nitroso dyes. The method for adding the magenta dye may be any method. For example, the dye may be added in the state of a solution, an emulsion or a solid particle dispersion, or in the state that the dye is mordanted with a polymer mordant.

Of these dyes, azo dyes, azomethine dyes, carbonium dyes and polymethine dyes are preferred, and azomethine dyes are more preferred.

The azomethine dye is preferably the compound represented by the following formula (I). The compound represented by the following formula (I) will be described.

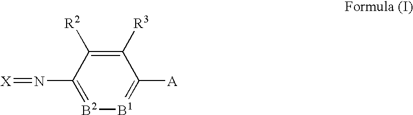

<Substituent>

In formula (I), X represents a residual of a color photograph coupler, A represents —NR⁴R⁵ or a hydroxy group, and R⁴ and R⁵ each independently represent one selected from a hydrogen group, an aliphatic group, an aryl group, and a heterocyclic group. A is preferably —NR⁴R⁵. The above mentioned R⁴ and R⁵ each independently are preferably a hydrogen atom or an aliphatic group, more preferably a hydrogen atom, an alkyl group, or a substituted alkyl group, and further preferably a hydrogen atom, an alkyl group having 1 to 18 carbon atoms, or a substituted alkyl group having 1 to 18 carbon atoms. In more detail, most preferably, both of R⁴ and R⁵ are a methyl group, both of R⁴ and R⁵ are an ethyl group, R⁴ is an ethyl group and R⁵ is a 2-hydroxylethyl group, or R⁴ is an ethyl group and R⁵ is (2-methanesulfonyl amino)ethyl group.

In the aforementioned formula (1), B¹ represents ═C(R⁶)— or ═N—, and B² represents —C(R⁷)═ or —N═. Preferably, B¹ and B² are not —N═ at the same time, and more preferably, B¹ is ═C(R)—, and B² is —C(R⁷)═. In this case, in formula (I), R², R³, R⁶, and R⁷ each independently represent one selected from a hydrogen atom, a halogen atom, an aliphatic group, an aromatic group, a heterocyclic group, a cyano group, —OR^{|}, —SR⁵², —CO₂R⁵³, —OCOR⁵⁴, —NR⁵⁵R⁵⁶ , —CONR⁵⁷R⁵⁸, —SO₂R⁵⁹, —SO₂NR⁶⁰R⁶¹, —NR⁶²CONR⁶³R⁶⁴, —NR⁶⁵CO₂R⁶⁶, —COR⁶⁷, —NR⁶⁸COR⁶⁹, or —NR⁷⁰SO₂R⁷¹. R⁵¹, R⁵², R⁵³, R⁵⁴, R⁵⁵, R⁵⁶, R⁵⁷, R⁵⁸, R⁵⁹, R⁶⁰, R⁶¹, R⁶², R⁶³, R⁶⁴, R⁶⁵, R⁶⁶, R⁶⁷, R⁶⁸ , R⁶⁹, R⁷⁰, and R⁷¹ are each independently one selected from a halogen atom, an aliphatic group, and an aromatic group.

Among them, the aforementioned R² and R⁷ are each independently, preferably, a hydrogen atom, a halogen atom, an aliphatic group, —OR⁵¹, —NR⁶²CONR⁶³R⁶⁴, —NR⁶⁵CO₂R⁶⁶, —NR⁶⁸COR⁶⁹, or —NR⁷⁰SO₂R⁷¹, more preferably a hydrogen atom, a fluorine atom, a chlorine atom, an alkyl group, a substituted alkyl group, —NR⁶²CONR⁶³R⁶⁴, or —NR⁶⁸COR⁶⁹, still more preferably a hydrogen atom, a chlorine atom, an alkyl group having 1 to 10 carbon atoms, or a substituted alkyl group having 1 to 10 carbon atoms, and most preferably a hydrogen atom, an alkyl group having 1 to 4 carbon atoms, or a substituted alkyl group having 1 to 4 carbon atoms. In more detail, most preferably, R represents a hydrogen atom or a methyl group and R⁷ is a hydrogen atom.

R³ and R⁶ are each independently, preferably, a hydrogen atom, a halogen atom, or an aliphatic group, more preferably a hydrogen atom, a fluorine atom, a chlorine atom, an alkyl group, or a substituted alkyl group, further preferably a hydrogen atom, a chlorine atom, an alkyl group having 1 to 10 carbon atoms, a substituted alkyl group having 1 to 10 carbon atoms, and most preferably a hydrogen atom, an alkyl group having 1 to 4 carbon atoms, or a substituted alkyl group having 1 to 4 carbon atoms. In more detail, most preferably, both of R³ and R⁷ represent a hydrogen atom.

In the aforementioned formula (I), R³ and R³, R³ and R⁴, R⁴ and R⁵, R⁵ and R⁶, and R⁶ and R⁷ may bind each other to form a ring. The combination to form a ring is preferably R³ and R⁴, R⁴ and R⁵, or R⁵ and R⁶. The ring which is formed by bonding the aforementioned R² and R³, or R⁶ and R⁷, is preferably a 5 or 6 membered ring. The rings are preferably an aromatic ring (for example, a benzene ring) or unsaturated heterocyclic ring (for example, a pyridine ring, an imidazole ring, a pyrimidine ring, a thiazole ring, a pyrimidine ring, a pyrrole ring or a furan ring). The ring which is formed by bonding the aforementioned R³ and R⁴, or R⁵ and R⁶, is preferably a 5 or 6 membered ring. Examples of the ring include a tetrahydroquinoline ring and a dihydroindole ring. The ring, which is formed by bonding the aforementioned R⁴ and R⁵, is preferably a 5 or 6 membered ring. Examples of rings include a pyrrolizine ring, a piperidine ring, and a morpholine ring.

In the present specification, the aliphatic group means an alkyl group, a substituted alkyl group, an alkenyl group, a substituted alkenyl group, an alkynyl group, a substituted alkynyl group, an aralkyl group, and a substituted aralkyl group. The aforementioned alkyl group may have a branch or may form a ring. The alkyl group preferably has 1 to 20 carbon atoms, and more preferably 1 to 18 carbon atoms. The alkyl moiety in the aforementioned substituted alkyl group is similar to the above mentioned alkyl group. The aforementioned alkenyl group may have a branch or may form a ring. The alkenyl group has preferably 2 to 20 carbon atoms, and more preferably 2 to 18 carbon atoms. The alkenyl moiety in the aforementioned substituted alkenyl group is similar to the above mentioned alkenyl group. The aforementioned alkynyl group may have a branch or may form a ring. The alkynyl group has preferably 2 to 20 carbon atoms, and more preferably 2 to 18 carbon atoms. The alkynyl moiety in the aforementioned substituted alkynyl group is similar to the above mentioned alkynyl group.

The alkyl moiety in the aforementioned aralkyl group and in the aforementioned substituted aralkyl group is similar to the above mentioned alkyl group. The aryl moiety in the aforementioned aralkyl group and in the aforementioned substituted aralkyl group is similar to the aryl group mentioned below. Examples of the substituent of the alkyl moiety in the aforementioned substituted alkyl group, substituted alkenyl group, substituted alkynyl group and substituted aralkyl group include a halogen atom, cyano, nitro, a heterocyclic group, —OR¹⁴¹, —SR¹⁴², —CO₂R¹⁴³, —NR¹⁴⁴R¹⁴⁵, —CONR¹⁴⁶R¹⁴⁷, —SO₂R¹⁴⁸, —SO₃R¹⁴⁹, amd —SO₂NR¹⁵⁰R¹⁵¹. R¹⁴¹, R¹⁴², R¹⁴³, R¹⁴⁴, R¹⁴⁵, R¹⁴⁶, R¹⁴⁷, R¹⁴⁸, R¹⁴⁹, R¹⁵⁰, and R¹⁵¹ are each independently a hydrogen atom, an aliphatic group, or an aromatic group. In addition to these, R¹⁴³ and R¹⁴⁹ may be a metal atom selected from Li, Na, K, Mg and Ca. In this case, Li, Na, and K are preferable, and Na is more preferable. Examples of the substituent of the aryl moiety in the aforementioned substituted aralkyl group are similar to the examples of the substituent of the substituted aryl group described below.

In the present specification, an aromatic group means an aryl group and a substituted aryl group.

The aryl group is preferably phenyl or naphthyl, and particularly preferably phenyl. The aryl moiety of the aforementioned substituted aryl group is similar to the abovementioned aryl group. Examples of the substituent of the aforementioned substituted aryl group include a halogen atom, cyano, nitro, an aliphatic group, a heterocyclic group, —OR¹⁶¹, —SR¹⁶², —CO₂R¹⁶³, —NR¹⁶⁴R¹⁶⁵, —CONR¹⁶⁶R¹⁶⁷, —SO₂R¹⁶⁸, —SO₃R¹⁶⁹ and SO₂NR¹⁷⁰R¹⁷¹. R¹⁶¹, R¹⁶², R¹⁶³, R¹⁶⁴, R¹⁶⁵, R¹⁶⁶, R¹⁶⁷, R¹⁶⁸, R¹⁶⁹, R¹⁷⁰, and R¹⁷¹ are each independently a hydrogen atom, an aliphatic group, or an aromatic group. In addition to these, R¹⁶³ and R¹⁶⁹ may be a metal atom selected from Li, Na, K, Mg, and Ca. In this case, Li, Na, and K are preferable, and Na is more preferable.

In the present specification, a heterocyclic group preferably contains a 5 or 6 membered saturated or unsaturated heterocycle. A heterocycle may be condensed with an aliphatic ring, aromatic ring, or other heterocycle. Examples of the heteroatom in the heterocycle include B, N, O, S, Se and Te. As a heteroatom, N, O, and S are preferable. The heterocycle preferably has a free monovalent carbon atom (the heterocyclic group binds at a carbon atom). Examples of the saturated heterocycle include a pyrrolidine ring, a morpholine ring, 2-bora-1,3-dioxolane ring, and 1,3-thiazoline ring. Examples of the unsaturated heterocycle include an imidazole ring, a thiazole ring, a benzothiazole ring, a benzoxazole ring, a benzotriazole ring, a benzoselenazole ring, a pyridine ring, a pyrimidine ring, and a quinoline ring. The heterocyclic group may have a substituent. Examples of the substituent include a halogen atom, cyano, nitro, an aliphatic group, an aromatic group, a heterocyclic group, —OR¹⁷¹, —SR¹⁷², —CO₂R¹⁷³, —NR¹⁷⁴R¹⁷⁵, —CONR¹⁷⁶R¹⁷⁷, —SO₂R¹⁷⁸, and SO₂NR¹⁷⁹R¹⁸⁰. R¹⁷¹, R¹⁷², R¹⁷³, R¹⁷⁴, R¹⁷⁵, R¹⁷⁶, R¹⁷⁷, R¹⁷⁸, R¹⁷⁹, and R¹⁸⁰ are each independently a hydrogen atom, an aliphatic group, or an aromatic group.

In the aforementioned formula (I), a coupler represented by X is preferably the coupler mention below. U.S. Pat. Nos. 4,310,619 and 4,351,897, European Patent (EP) No. 73636, U.S. Pat. Nos. 3,061,432 and 3,725,067, Research Disclosure Nos. 24220 (June, 1984) and 24230 (June, 1984), JP-A Nos. 60-33552, 6043659, 61-72238, 60-35730, 55-118034, and 60-185951, U.S. Pat. Nos. 4,500,630, 4,540,654, and 4,556,630, WO No. 88/04795, JP-A No. 3-39737 {L-57 (page 11, at the lower right), L-68 (page 12, at the lower right), L-77 (page 13, at the lower right)}, EP No. 456257 {[A4]-63 (page 134), [A-4]-73, -75 (page 139){, EP No. 486965 {M-4, -27)}, EP No. 571959A {M-45 (page 19), JP-A No. 5-204106 (M-1) (page 6)}, JP-A No. 4-362631 (paragraph No. 0237, M-22), and U.S. Pat. Nos. 3,061,432 and 3,725,067.

Specific examples of the compounds are shown below, but the invention is not restricted to them.

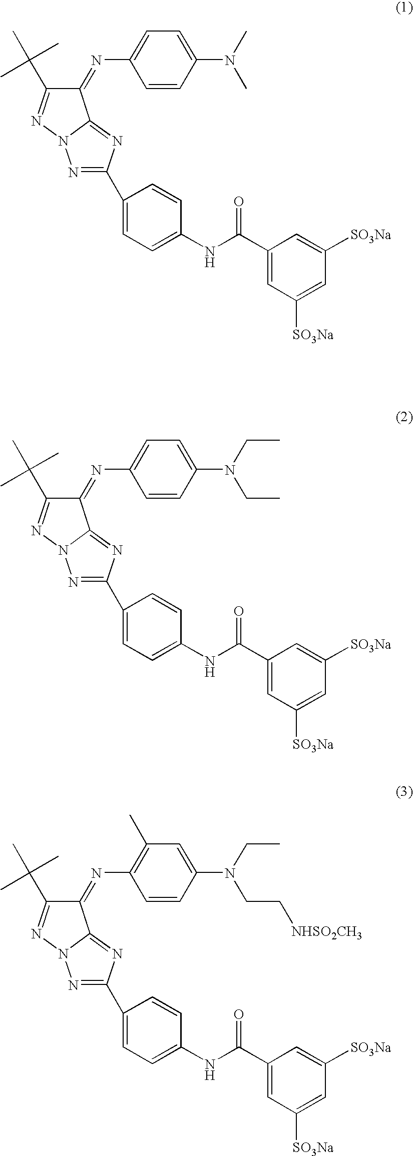

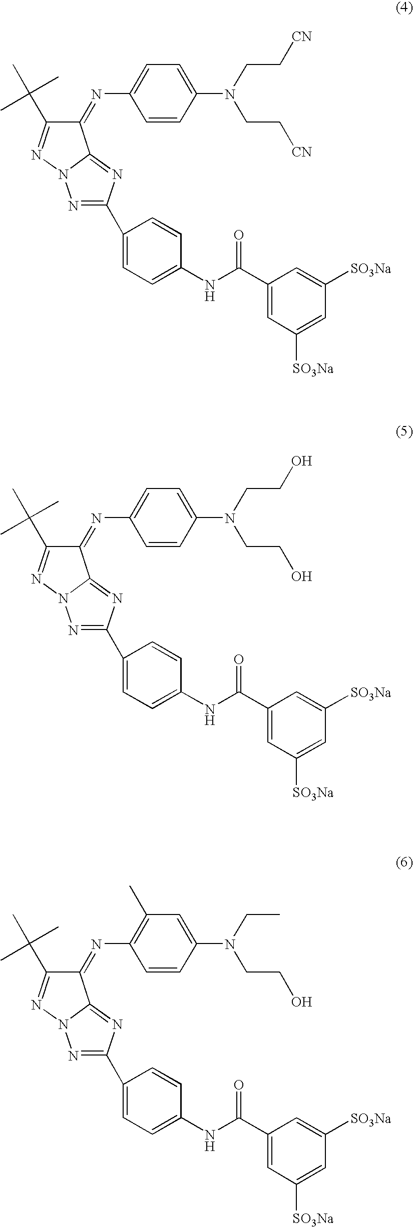

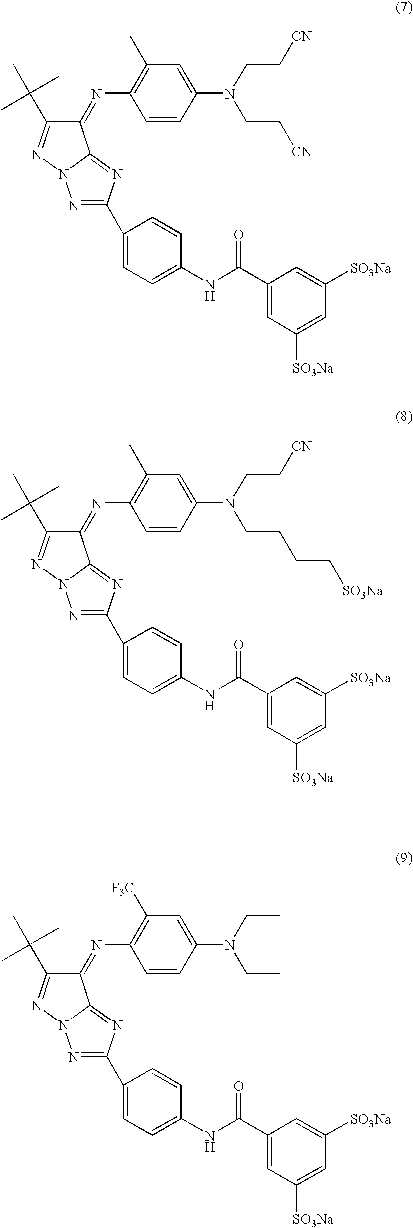

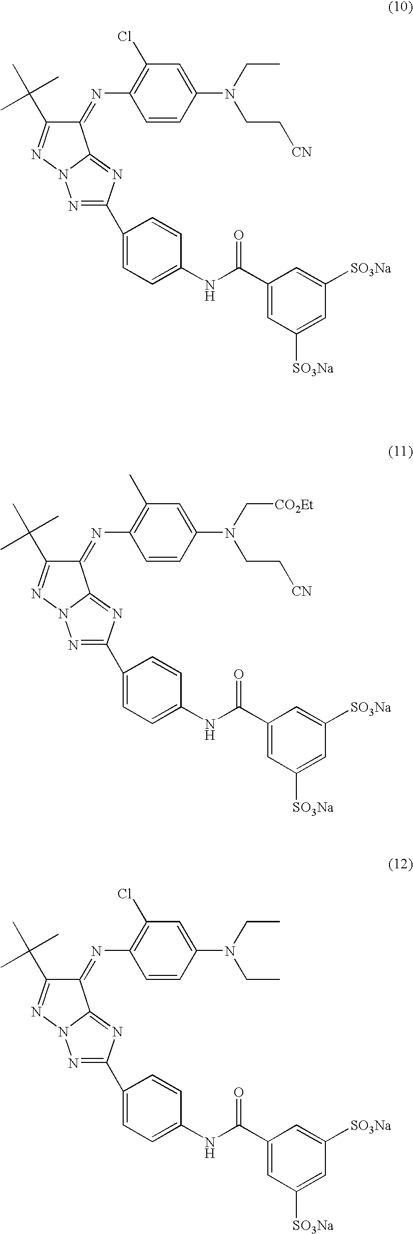

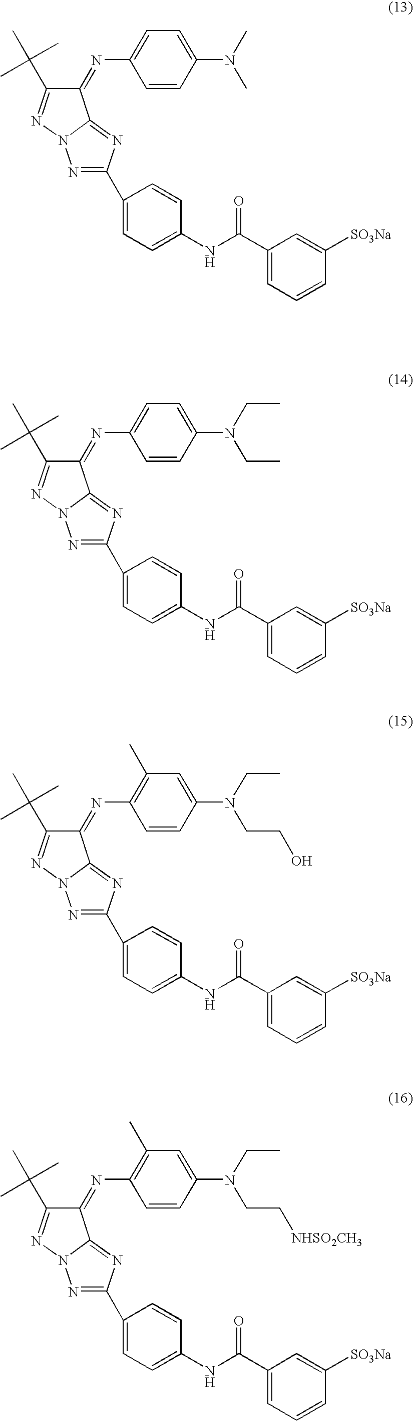

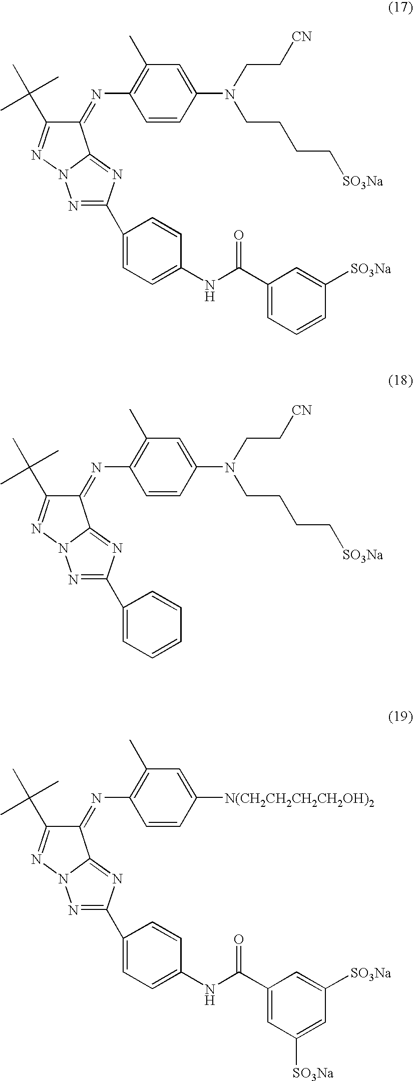

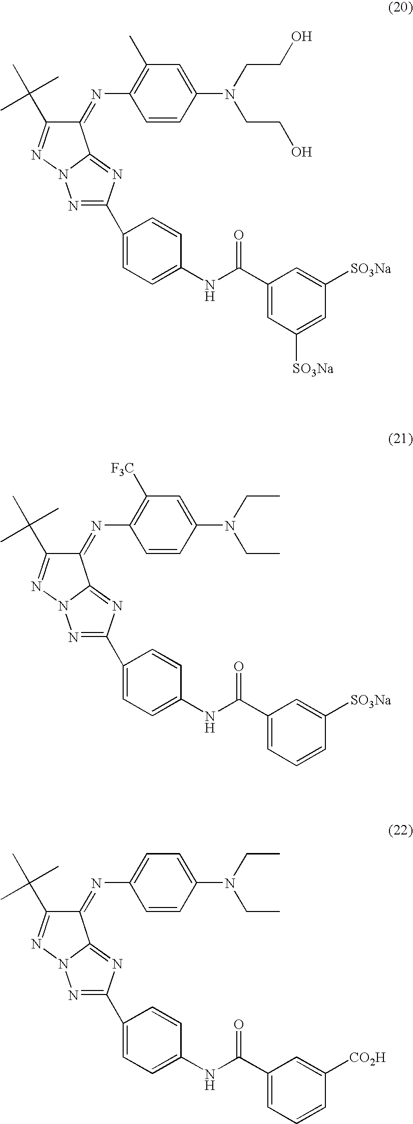

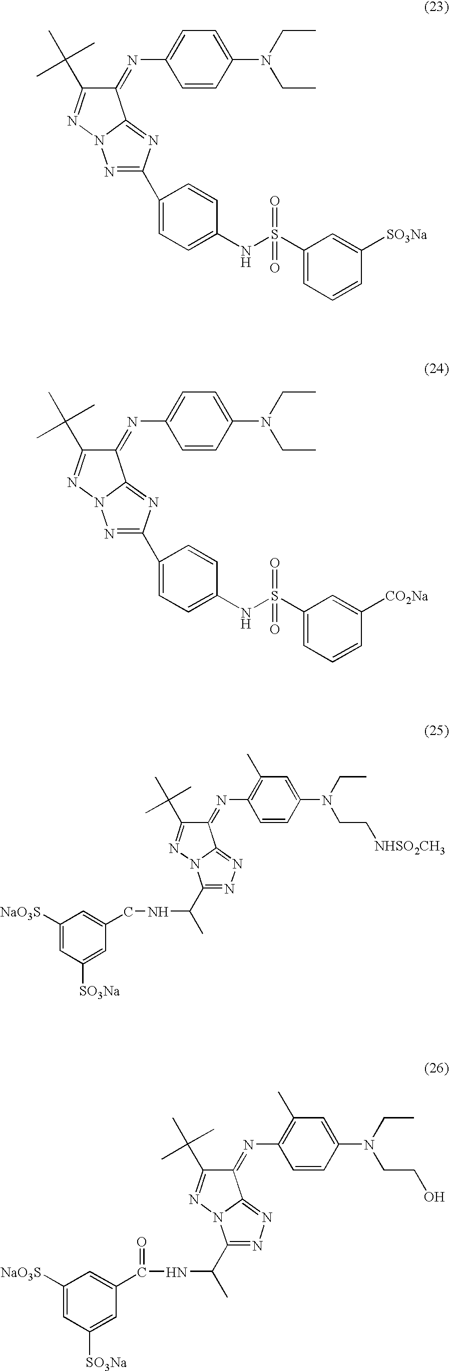

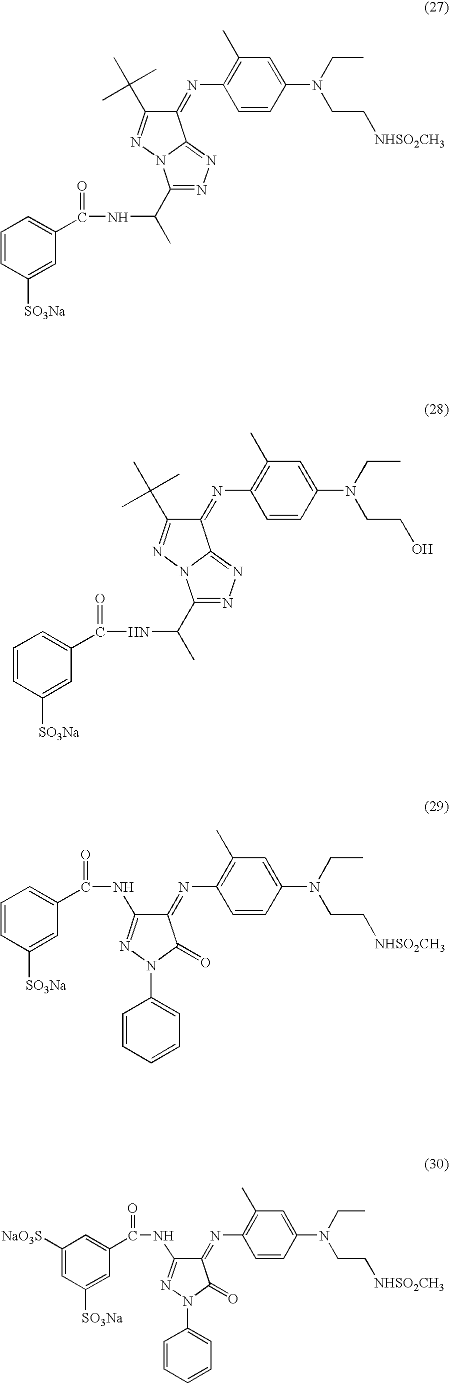

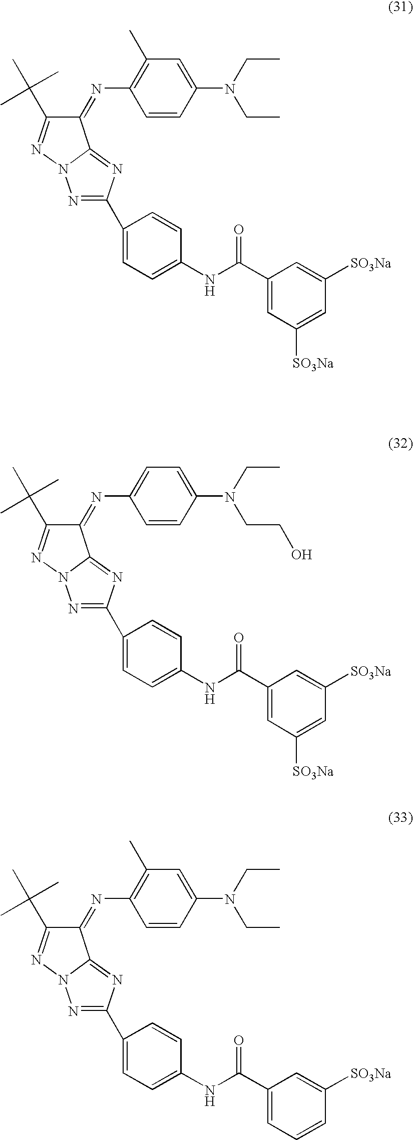

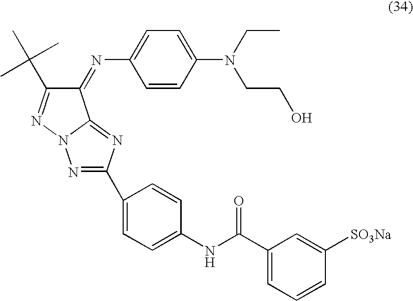

The dyes represented by the aforementioned formula (I) may be synthesized referring to the methods described, for example, in JP-A No. 4-126772, and Japanese Patent Application Publication (JP-B) No. 7-94180.

As other azomethine dyes which can be used in the invention, formula (I) described in JP-A No. 4-247449, formula (I) described in JP-A No. 63-145281, formula (1) described in JP-A No. 2002-256164, formula (I) described in JP-A No. 3-244593, formula (I) described in JP-A No. 3-7386, formulae (II), (III), and (IV) described in JP-A No. 2-252578, formulae (I) and (II) described in JP-A No. 4-359967, formula (I) and (II) described in JP-A No. 4-359968 and the like can be described. Dyes described in these patents can be also included as specific compounds.

Although the dye for the above purpose may be added to any layer, more preferable is to add into a non-photosensitive layer on the image forming layer side, or to the back side.

The photothermographic material of the invention is preferably a so-called single-sided photosensitive material, which comprises at least one image forming layer containing silver halide emulsion on one side of the support, and a back layer on the other side of the support.

4) Matting Agent

A matting agent may be preferably added to the photothermographic material of the invention in order to improve conveyability. Description on the matting agent can be found in paragraphs Nos. 0126 to 0127 of JP-A No. 11-65021. The addition amount of the matting agent is preferably in a range from 1 mg/m² to 400 mg/m², and more preferably, from 5 mg/m² to 300 mg/m², with respect to the coating amount per 1 m² of the photothermographic material.

There is no particular restriction on the shape of the matting agent usable in the invention and it may be fixed form or non-fixed form. Preferred is to use those having fixed form and globular shape. Mean particle size is preferably in a range of from 0.5 μm to 10 μn, more preferably, from 1.0 μm to 8.0 μm, and further preferably, from 2.0 μm to 6.0 μm. Furthermore, the particle size distribution of the matting agent is preferably set as such that the variation coefficient may become 50% or lower, more preferably, 40% or lower, and fiuther preferably, 30% or lower. The variation coefficient, herein, is defined by (the standard deviation of particle diameter)/(mean diameter ofthe particle)×100. Furthermore, it is preferred to use by blending two types of matting agents having low variation coefficient and the ratio of their mean particle sizes is more than 3.

The matt degree on the image forming layer surface is not restricted as far as star-dust trouble does not occur, but the matt degree of 30 seconds to 2000 seconds is preferred, particularly preferred, 40 seconds to 1500 seconds as Bekk smoothness. Bekk smoothness can be easily determined in accordance with Japanese Industrial Standard (JIS) P8119 “Paper and board—Determination of smoothness by Bekk method” or TAPPI Standard Method T479.

The matt degree of the back layer in the invention is preferably in a range of 1200 seconds or less and 10 seconds or more; more preferably, 800 seconds or less and 20 seconds or more; and further preferably, 500 seconds or less and 40 seconds or more when expressed by Bekk smoothness.

In the present invention, a matting agent is preferably contained in an outermost layer, in a layer which can be function as an outermost layer, or in a layer nearer to outer surface, and also preferably is contained in a layer which can function as so-called protective layer.

5) Hydrophobic Polymer Latex

A hydrophobic polymer latex is preferably used as a binder included in at least one layer of the non-photosensitive layers, and preferably constitutes 50% by mass or more of the mass of binder. The non-photosensitive layer including the hydrophobic polymer latex is preferably a surface protective layer disposed on the image forming layer side.

In the invention, the polymer latex contained in the non-photosensitive layer containing a fixing agent is preferably the above-described non-dissociating polymer latex.

As the polymer latex contained in the non-photosensitive layers other than the non-photosensitive layer containing a fixing agent, descriptions can be found in “Gosei Jushi Emulsion (Synthetic resin emulsion)” (Taira Okuda and Hiroshi Inagaki, Eds., published by Kobunshi Kankokai (1978)), “Gosei Latex no Oyo (Application of synthetic latex)” (Takaaki Sugimura, Yasuo Kataoka, Soichi Suzuki, and Keiji Kasahara, Eds., published by Kobunshi Kankokai (1993)), and “Gosei Latex no Kagaku (Chemistry of synthetic latex)” (Soichi Muroi, published by Kobunshi Kankokai (1970)). More specifically, there can be mentioned a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate/methacrylic acid copolymer, a latex of methyl methacrylate (58.9% by mass)/2-ethylhexyl methacrylate (25.4% by mass)/styrene (8.6% by mass)/2-hydroethyl methacrylate (5.1% by mass)/acrylic acid (2.0% by mass) copolymer, a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer, and the like.

Furthermore, as the binder for the surface protective layer, there can be applied the technology described in paragraph Nos. 0021 to 0025 of the specification of JP-A No. 2000-267226, and the technology described in paragraph Nos. 0023 to 0041 of the specification of JP-A No. 2000-19678. The polymer latex in the surface protective layer preferably is contained in an amount of 10% by mass to 90% by mass, particularly preferably, of 20% by mass to 80% by mass of the total mass of binder.

6) Surface pH

The surface pH of the photothermographic material according to the invention preferably yields a pH of 7.0 or lower, and more preferably, 6.6 or lower, before a thermal developing process. Although there is no particular restriction concerning the lower limit, the lower limit of pH value is about 3, and the most preferred surface pH range is from 4 to 6.2. From the viewpoint of reducing the surface pH, it is preferred to use an organic acid such as phthalic acid derivative or a non-volatile acid such as sulfunic acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

7) Hardener

A hardener may be used in each of image forming layer, protective layer, back layer, and the like. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-chloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193 and the like, epoxy compounds of U.S. Pat. No. 4,791,042 and the like, and vinyl sulfone compounds of JP-A No. 62-89048 and the like.

The hardener is added as a solution, and the solution is added to the coating solution for forming the protective layer 180 minutes before coating to just before coating, and preferably 60 minutes before to 10 seconds before coating. However, so long as the effect of the invention is sufficiently exhibited, there is no particular restriction concerning the mixing method and the conditions of mixing. As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Hamby, M. F. Edwards, A. W. Nienow (translated by Koji Takahashi) “Liquid Mixing Technology” (Nikkan Kogyo Shinbunsha, 1989), and the like.

8) Surfactant

As for the surfactant, the solvent, the support, antistatic agent and the electrically conductive layer, and the method for obtaining color images applicable in the invention, there can be mentioned those disclosed in paragraph Nos. 0132, 0133, 0134, 0135, and 0136, respectively, of JP-A No. 11-65021.

In the invention, it is preferred to use a fluorocarbon surfacant. Specific examples of fluorocarbon surfacants can be found in those described in JP-A Nos. 10-197985, 2000-19680, and 2000-214554. Polymer fluorocarbon surfacants described in JP-A 9-281636 can be also used preferably. For the photothermographic material in the invention, the fluorocarbon surfacants described in JP-A Nos. 2002-82411, 2003-57780, and 2001-264110 are preferably used. Especially, the usage of the fluorocarbon surfacants described in JP-A Nos. 2003-57780 and 2001-264110 in an aqueous coating solution is preferred viewed from the standpoint of capacity in static control, stability of the coating surface state and sliding facility. The fluorocarbon surfactant described in JP-A No. 2001-264110 is mostly preferred because of high capacity in static control and that it needs small amount to use.

According to the invention, the fluorocarbon surfactant can be used on either side of the image forming layer side or the back side, but is preferred to use on the both sides. Further, it is particularly preferred to use in combination with electrically conductive layer including metal oxides described below. In this case the amount of the fluorocarbon surfactant on the side of the electrically conductive layer can be reduced or removed.

The addition amount of the fluorocarbon surfactant is preferably in a range of from 0.1 mg/m² to 100 mg/m² on each of the image forming layer side and the back side, more preferably from 0.3 mg/m² to 30 mg/m², and further preferably from 1 mg/m² to 10 mg/m². Especially, the fluorocarbon surfactant described in JP-A No. 2001-264110 is effective, and used preferably in a range of from 0.01 mg/m² to 10 mg/m², and more preferably from 0.1 mg/m² to 5 mg/m².

9) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. As an electrically conductive material of the antistatic layer, metal oxides having enhanced electric conductivity by the method of introducing oxygen defects or different types of metallic atoms into the metal oxides are preferably for use. Examples of metal oxides are preferably selected from ZnO, TiO₂ and SnO₂. As the combination of different types of atoms, preferred are ZnO combined with Al, In; SnO₂ with Sb, Nb, P, halogen atoms, and the like; TiO₂ with Nb, Ta, and the like. Particularly preferred for use is SnO₂ combined with Sb. The addition amount of different types of atoms is preferably in a range of from 0.01 mol % to 30 mol %, and more preferably, in a range of from 0.1 mol % to 10 mol %. The shape of the metal oxides can include, for example, spherical, needle-like, or plate-like shape. The needle-like particles, with the rate of (the major axis)/(the minor axis) is more than 2.0, and more preferably, 3.0 to 50, is preferred viewed from the standpoint of the electric conductivity effect. The metal oxides is used preferably in a range from 1 mg/m² to 1000 mg/m², more preferably from 10 mg/m² to 500 mg/m², and further preferably from 20 mg/m² to 200 mg/m².

The antistatic layer can be disposed on either side of the image forming layer side or the back side, it is preferred to set between the support and the back layer. Examples of the antistatic layer in the invention include described in JP-A Nos. 11-65021 (paragraph No. 0135), 56-143430, 56-143431, 58-62646, and 56-120519, and in paragraph Nos. 0040 to 0051 of JP-A No. 11-84573, U.S. Pat. No. 5,575,957, and in paragraph Nos. 0078 to 0084 of JP-A No. 11-223898.

10) Support

As the transparent support, favorably used is polyester, particularly, polyethylene terephthalate, which is subjected to heat treatment in the temperature range of from 130° C. to 185° C. in order to relax the internal strain caused by biaxial stretching and remaining inside the film, and to remove strain ascribed to heat shrinkage generated during thermal development. In the case of a photothermographic material for medical use, the transparent support may be colored with a blue dye (for instance, dye-1 described in the example of JP-A No. 8-240877), or may be uncolored. As to the support, it is preferred to apply undercoating technology, such as water-soluble polyester described in JP-A No. 11-84574, a styrene-butadiene copolymer described in JP-A No. 10-186565, a vinylidene chloride copolymer described in JP-A No. 2000-39684, and the like. The moisture content of the support is preferably 0.5% by mass or less when the support is coated with a image forming layer and a back layer.

11) Other Additives

Furthermore, antioxidant, stabilizing agent, plasticizer, UV absorbent, or a coating aid may be added to the photothermographic material. Each of the additives is added to either of the image forming layer or the non-photosensitive layer. Reference can be made to WO No. 98/36322, EP-A No. 803764A1, JP-A Nos. 10-186567 and 10-18568, and the like.

12) Coating Method

The photothermographic material of the invention may be coated by any method. More specifically, various types of coating operations including extrusion coating, slide coating, curtain coating, immersion coating, knife coating, flow coating, or an extrusion coating using the type of hopper described in U.S. Pat. No. 2,681,294 are used. Preferably used is extrusion coating or slide coating described in pages 399 to 536 of Stephen E Kistler and Petert M. Shweizer, “LIQUID FILM COATING” (Chapman & Hall, 1997), and most preferably used is slide coating. Example of the shape of the slide coater for use in slide coating is shown in FIG. 11b.1, page 427, of the same literature. If desired, two or more layers can be coated simultaneously by the method described in pages 399 to 536 of the same literature, or by the method described in U.S. Pat. No. 2,761,791 and British Patent No. 837095. Particularly preferred in the invention is the method described in JP-A Nos. 2001-194748, 2002-153808, 2002-153803, and 2002-182333.

The coating solution for the layer containing organic silver salt in the invention is preferably a so-called thixotropic fluid. For the details of this technology, reference can be made to JP-A No. 11-52509. Viscosity of the coating solution for the layer containing organic silver salt in the invention at a shear velocity of 0.1 S⁻¹ is preferably from 400 mPa.s to 100,000 mPa.s, and more preferably, from 500 mPa.s to 20,000 mPa.s. At a shear velocity of 1000 S⁻¹, the viscosity is preferably from 1 mPa.s to 200 mPa.s, and more preferably, from 5 mPa.s to 80 mPa.s.

In the case of mixing two types of liquids on preparing the coating solution of the invention, known in-line mixer and in-plant mixer can be used favorably. Preferred in-line mixer of the invention is described in JP-A No. 2002-85948, and the in-plant mixer is described in JP-A No. 2002-90940.

The coating solution of the invention is preferably subjected to defoaming treatment to maintain the coated surface in a fine state. Preferred defoaming treatment method in the invention is described in JP-A No. 2002-66431.

In the case of applying the coating solution of the invention to the support, it is preferred to perform diselectrification in order to prevent the adhesion of dust, particulates, and the like due to charge up. Preferred example of the method of diselectrification for use in the invention is described in JP-A No. 2002-143747.

Since a non-setting coating solution is used for the image forming layer in the invention, it is important to precisely control the drying wind and the drying temperature. Preferred drying method for use in the invention is described in detail in JP-A Nos. 2001-194749 and 2002-139814.

In order to improve the film-forming properties in the photothermographic material of the invention, it is preferred to apply a heat treatment immediately after coating and drying. The temperature of the heat treatment is preferably in a range of from 60° C. to 100° C. at the film surface, and time period for heating is preferably in a range of from 1 second to 60 seconds. More preferably, heating is performed in a temperature range of from 70° C. to 90° C. at the film surface, and the time period for heating is from 2 seconds to 10 seconds. A preferred method of heat treatment for the invention is described in JP-A No. 2002-107872.

Furthermore, the producing methods described in JP-A Nos. 2002-156728 and 2002-182333 are favorably used in the invention in order to stably and continuously produce the photothermographic material of the invention.

13) Wrapping Material

In order to suppress fluctuation from occurring on the photographic property during a preservation of the invention before thermal development, or in order to improve curling or winding tendencies when the photothermographic material is manufactured in a roll state, it is preferred that a wrapping material having low oxygen permeability and/or water permeability is used. Preferably, oxygen permeability is 50 mL·atm⁻¹m⁻²day⁻¹ or lower at 25° C., more preferably, 10 mL·atm⁻¹m⁻²day⁻¹ or lower, and further preferably, 1.0 mL·atm⁻¹m⁻²day⁻¹ or lower. Preferably, water permeability is 10 g·atm⁻¹m⁻²day⁻¹ or lower, more preferably, 5 g·atm⁻¹m²day⁻¹ or lower, and further preferably, 1 g·atm⁻¹m⁻²day⁻¹ or lower.

As specific examples of a wrapping material having low oxygen permeability and/or water permeability, reference can be made to, for instance, the wrapping material described in JP-A Nos. 8-254793 and 2000-206653.

14) Other Applicable Techniques

Techniques which can be used for the photothermographic material of the invention also include those in EP-A No. 803764A1, EP-A No. 883022A1, WO No. 98/36322, JP-A Nos. 56-62648, 58-62644, JP-A Nos. 0943766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824,10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, JP-A Nos. 2000-187298, 2000-10229, 2000-47345, 2000-206642, 2000-98530, 2000-98531, 2000-112059, 2000-112060, 2000-112104, 2000-112064 and 2000-171936.

(Image Forming Method)

1) Exposure

Although any method may be used for exposure of the photothermographic material of the invention, laser beam is preferably used as a light source.

Preferable examples of laser beam according to the invention include gass laser (Ar⁺, He—Ne, He—Cd), YAG laser, dye laser, semiconductor laser. A semiconductor laser and a harmonic generating device or the like may be used. Although preferred laser is determined in accordance with the absorption peak wavelength of the spectral sensitizing dye included in the photothermographic material, He—Ne laser of red through infrared emission, red laser diode, Ar+, He—Ne, or He—Cd laser of blue through green emission, blue laser diode and the like are preferably used. In recent years, development has been made particularly on a light source module with an SHG (a second harmonic generator) and a laser diode integrated into a single piece whereby a laser output apparatus in a short wavelength region has come into the limelight. A blue laser diode enables high definition image recording and makes it possible to obtain an increase in recording density and a stable output over a long lifetime, which results in expectation of an expanded demand in the future.

Laser beam which oscillates in a longitudinal multiple modulation by a method such as high frequency superposition is also preferably employed.

2) Thermal Development

Although any method may be used for this thermal development process, development of the photothermographic material of the invention is usually performed by elevating the temperature of the photothermographic material exposed imagewise. The temperature for development is preferably 80° C to 250° C., more preferably 100° C. to 140° C., and further preferably 110° C. to 130° C. Time period for development is preferably 1 second to 60 seconds, more preferably 3 seconds to 30 seconds, and further preferably 5 seconds to 25 seconds.

As for the process for thermal development, either drum type heaters or plate type heaters may be used. However, plate type heater processes are more preferred. Preferable process for thermal development by a plate type heater is a process described in JP-A No. 11-133572, which discloses a thermal developing device in which a visible image is obtained by bringing a photothermographic material with a formed latent image into contact with a heating means at a thermal development region, wherein the heating means comprises a plate heater, and plurality of pressing rollers are oppositely provided along one surface of the plate heater, the thermal developing device is characterized in that thermal development is performed by passing the photothermographic material between the pressing rollers and the plate heater. It is preferred that the plate heater is divided into 2 to 6 portions, with the leading end having the lower temperature by 1° C. to 10° C. For example, 4 sets of plate heaters which can be independently subjected to the temperature control are used, and are controlled so that they respectively become 112° C., 119° C., 121° C., and 120° C.

Such a process is also described in JP-A No. 54-30032, which allows for excluding moisture and organic solvents included in the photothermographic material out of the system, and also allows for suppressing the change of shapes of the support of the photothermographic material upon rapid heating the photothermographic material.

It is preferable that the heater is more stably controlled, and top part of one sheet of the photothermographic material is exposed and thermal development of the exposed portion is started before exposure of the end part of the sheet has completed, for downsizing the thermal developing apparatus and for shortening the time period for thermal development.

Preferred imager capable of rapid processing for use in the invention is described in, for example, JP-A Nos. 2002-289804 and 2002-091114.

3)System

Examples of a medical laser imager equipped with a light exposing portion and a thermal developing portion include Fuji Medical Dry Laser Imager FM-DP L and DRYPIX 7000. In connection with FM-DP L, description is found in Fuji Medical Review No. 8, pages 39 to 55. It goes without mentioning that those techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

### APPLICATION OF THE INVENTION

The image forming method in which the photothermographic material of the invention is used is preferably employed as image forming methods for photothermographic materials for use in medical imaging, photothermographic materials for use in industrial photographs, photothermographic materials for use in printing, as well as for COM, through forming black and white images by silver imaging.

### EXAMPLES

The present invention is specifically explained by way of Examples below, which should not be construed as limiting the invention thereto.

### Example 1

(Preparation of PET Support)

1) Film Manufacturing PET having IV (intrinsic viscosity) of 0.66 (measured in phenol/tetrachloroethane=6/4 (mass ratio) at 25° C.) was obtained according to a conventional manner using terephthalic acid and ethylene glycol. The product was pelletized, dried at 130° C. for 4 hours, melted at 300° C. Thereafter, the mixture was extruded from a T-die and rapidly cooled to form a non-tentered film.

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking part was slit off, and both edges of the film were knurled. Then the film was rolled up at the tension of 4 kg/cm, to obtain a roll having the thickness of 175 μm.

2) Surface Corona Discharge Treatment

Both surfaces of the support were treated at room temperature at 20 m/minute using Solid State Corona Discharge Treatment Machine Model 6KVA manufactured by Piller GmbH. It was proven that treatment of 0.375 kV A-minute/m² was executed, judging from the readings of current and voltage on that occasion. The frequency upon this treatment was 9.6 kHz, and the gap clearance between the electrode and dielectric roll was 1.6 mm.

3) Undercoating

<Preparation of Coating Solution for Undercoat Layer>

Formula (1) (for undercoat layer on the image forming layer side)

| | | |
|---|---|---|
| Pesresin A-520 manufactured by Takamatsu Oil & Fat | 59 | g |
| Co., Ltd. (30% by mass solution) | | |
| Polyethyleneglycol monononylphenylether (average | 5.4 | g |
| ethylene oxide number = 8.5) 10% by mass solution | | |
| MP-1000 manufactured by Soken Chemical & Engineering | 0.91 | g |
| Co., Ltd. (polymer fine particle, mean particle | | |
| diameter of 0.4 μm) | | |
| Distilled water | 935 | mL |

Formula (2) (for first layer on the back side)

| | | |
|---|---|---|
| Styrene-butadiene copolymer latex (solid content | 158 | g |
| of 40% by mass, styrene/butadiene mass ratio = 68/32) | | |
| Sodium salt of 2,4-dichloro-6-hydroxy-S-triazine | 20 | g |
| (8% by mass aqueous solution) | | |
| 1% by mass aqueous solution of sodium | 10 | mL |
| laurylbenzenesulfonate | | |
| Distilled water | 854 | mL |

Formula (3) (for second layer on the back side)

| | | |
|---|---|---|
| SnO₂/SbO (9/1 mass ratio, mean | 84 | g |
| particle diameter of 0.038 μm, 17% by mass dispersion) | | |
| Gelatin (10% by mass aqueous solution) | 89.2 | g |
| METOLOSE TC-5 manufactured by Shin-Etsu Chemical | 8.6 | g |
| Co., Ltd. (2% by mass aqueous solution) | | |
| MP-1000 manufactured by Soken Chemical & | 0.01 | g |
| Engineering Co., Ltd | | |
| 1% by mass aqueous solution of sodium | 10 | mL |
| dodecylbenzenesulfonate | | |
| NaOH (1% by mass) | 6 | mL |
| PROXEL (manufactured by Imperial Chemical | 1 | mL |
| Industries PLC) | | |
| Distilled water | 805 | mL |

<Undercoating>

Both surfaces of the biaxially tentered polyethylene terephthalate support having the thickness of 175 μm were subjected to the corona discharge treatment as described above. Thereafter, the aforementioned formula (1) of the coating solution for the undercoat was coated on one surface (image forming layer side) with a wire bar so that the amount of wet coating became 6.6 mL/m² (per one side), and dried at 180° C. for 5 minutes. Then, the aforementioned formula (2) of the coating solution for the undercoat was coated on the reverse face (back side) with a wire bar so that the amount of wet coating became 5.7 mL/m², and dried at 180° C. for 5 minutes. Furthermore, the aforementioned formula (3) of the coating solution for the undercoat was coated on the reverse face (back side) with a wire bar so that the amount of wet coating became 7.7 mL/m², and dried at 180° C. for 6 minutes. Thus, an undercoated support was produced.

(Back Layer)

1) Preparation of Coating Solution 1 for Back Layer (Comparative Example)

The temperature of a container was kept at 40 ° C., and into the container were put 20 g of gelatin, 20 g of the following pigment-1 dispersion, 20 g of mono-dispersed polymethyl methacrylate fine particles (mean particle diameter: 8 μm, and particle diameter standard deviation: 0.4), 0.1 g of benzoisothiazolinone, and 570 mL of water, so as to dissolve the gelatin. Furthermore, the following were incorporated into the solution: 2.3 mL of a 1 mol/L solution of sodium hydroxide in water, 12 mL of a 3% by mass solution of sodium polystyrenesulfonate in water, and 42 g of a 10% by mass SBR latex. Immediately before application of the solution, 80 mL of a 4% by mass solution of N,N-ethylenebis(vinylsulfoneneacetoamide) in water was incorporated into the solution.

<Preparation of Pigment-1 Dispersion>

To 250 g of water were added 64 g of C.I. Pigment Blue 60 and 6.4 g of a Demol N manufactured by Kao Corp., and then the components were sufficiently mixed to prepare a slurry. 800 g of zirconia beads having a mean diameter of 0.5 mm were prepared, and the beads together with the slurry were put into a vessel. A disperser (¼ G Sand Grinder Mill, manufactured by AIMEX Co., Ltd.) was used to disperse the pigment for 25 hours. Water was added thereto so as to adjust the concentration of the pigment into 5% by mass, thereby obtaining a pigment-1 dispersion. The pigment particles contained in the thus-obtained pigment dispersion had a mean particle diameter of 0.21 μm.

2) Preparation of Coating Solution 2 for Back Layer (Comparative Example)

To the back layer coating solution 1 was added a water-soluble dye No. 11 instead of the pigment-1 dispersion so as to give a coating amount shown in Table 1. The dye was added in the state of an aqueous solution thereof.

3) Preparation of Coating Solutions 3 to 10 for Back Layer (the Invention)

Each fixing agent was added to the back layer coating solution 2 (the kind thereof and the addition amount thereof are shown in Table 1).

4) Preparation of Coating Solutions 11 to 12 for Back Layer (the Invention)

In the back layer coating solution 3, the water-soluble dye and the fixing agent were changed (the kind thereof and the addition amount thereof are shown in Table 1).

TABLE 1

| | Kind of dye | | Fixing agent | | |
|---|---|---|---|---|---|
| Back | | Addition | | Addition | |
| layer | | amount | | amount | |
| No. | Kind | (mg/m²) | Kind | (mg/m²) | Notes |
| 1 | Pigment-1 | 40 | — | — | Comparative |
| | | | | | Example |
| 2 | Exemplary | 50 | — | — | Comparative |
| | compound-11 | | | | Example |
| 3 | Exemplary | 50 | B-1 | 90 | The invention |
| | compound-11 | | | | |
| 4 | Exemplary | 50 | B-2 | 90 | The invention |
| | compound-11 | | | | |
| 5 | Exemplary | 50 | B-3 | 90 | The invention |
| | compound-11 | | | | |
| 6 | Exemplary | 50 | WC-1 | 200 | The invention |
| | compound-11 | | | | |
| 7 | Exemplary | 50 | WC-5 | 150 | The invention |
| | compound-11 | | | | |
| 8 | Exemplary | 50 | WB-1 | 200 | The invention |
| | compound-11 | | | | |
| 9 | Exemplary | 50 | MM-1 | 100 | The invention |
| | compound-11 | | | | |
| 10 | Exemplary | 50 | MM-11 | 113 | The invention |
| | compound-11 | | | | |
| 11 | Exemplary | 50 | B-1 | 90 | The invention |
| | compound-32 | | | | |
| 12 | Exemplary | 50 | B-1 | 90 | The invention |
| | compound-32 | | | | |

Dye fixing agents according to the invention 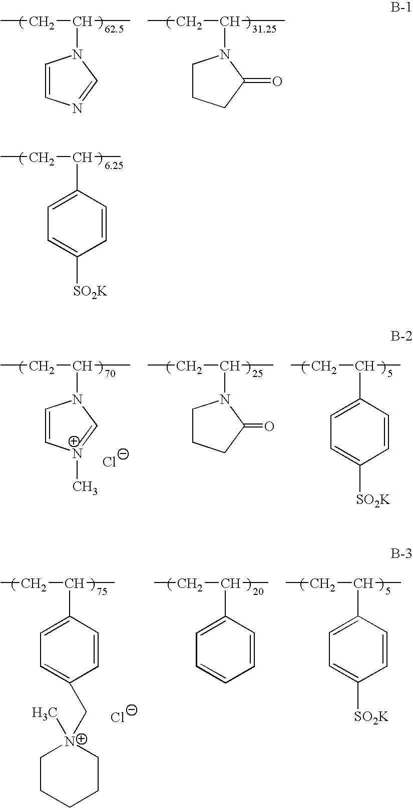
5) Preparation of Coating Solution for Back Face Protective Layer

The temperature of a container was kept at 40° C., and into the container were put 40 g of gelatin, 35 mg of benzoisothiazolinone, and 840 mL of water, so as to dissolve the gelatin. Furthermore, the following were incorporated into the solution: 5.8 mL of a 1 mol/L solution of sodium hydroxide in water, 1.5 g of a liquid paraffin emulsion as a liquid paraffin, 10 mL of a 5% by mass solution of a sodium salt of di(2-ethylhexyl)sulfosuccinate in water, 20 mL of a 3% by mass solution of sodium polystyrenesulfonate in water, 2.4 mL of a 2% by mass solution of a fluorine-containing surfactant (F-1), 2.4 mL of a 2% by mass solution of a fluorine-containing surfactant (F-2), and 32 g of a 19% by mass latex solution of a methyl methacrylate/styrene/butyl acrylate/hydroxyethyl methacrylate/acrylic acid copolymer (copolymerization ratio by mass: 57/8/28/5/2). Immediately before application of the solution, 25 mL of a 4% by mass solution of N,N-ethylenebis(vinylsulfoneacetoamide) in water was incorporated into the solution, so as to yield a back face protective layer coating solution.

6) Application of Back Layer

By simultaneous multi-coating, the back layer coating solution was applied onto the back face side of the undercoated support to set the coating amount of the dye into a value shown in Table 1 and the back face protective layer coating solution was applied onto the same side to set the coating amount of the gelatin to 0.52 g/m², and then the solutions were dried to form a back layer.

(Image Forming Layer, Intermediate Layer, and Surface Protective Layer)

1. Preparation of Materials for Coating

1) Silver Halide Emulsion

<<Preparation of Silver Halide Emulsion-1>>

To 1421 mL of distilled water was added 3.1 mL of a 1% by mass potassium bromide solution. Further, a liquid added with 3.5 mL of 0.5 mol/L sulfuric acid and 31.7 g of phthalated gelatin was kept at 30° C. while stirring in a stainless steel reaction vessel, and thereto were added total amount of: solution A prepared through diluting 22.22 g of silver nitrate by adding distilled water to give the volume of 95.4 mL; and solution B prepared through diluting 15.3 g of potassium bromide and 0.8 g of potassium iodide with distilled water to give the volume of 97.4 mL, over 45 seconds at a constant flow rate. Thereafter, 10 mL of a 3.5% by mass aqueous solution of hydrogen peroxide was added thereto, and 10.8 mL of a 10% by mass aqueous solution of benzimidazole was further added. Moreover, a solution C prepared through diluting 51.86 g of silver nitrate by adding distilled water to give the volume of 317.5 mL and a solution D prepared through diluting 44.2 g of potassium bromide and 2.2 g of potassium iodide with distilled water to give the volume of 400 mL were added. A controlled double jet method was executed through adding total amount of the solution C at a constant flow rate over 20 minutes, accompanied by adding the solution D while maintaining the pAg at 8.1. Potassium hexachloroiridate (III) was added in its entirely to give 1×10⁻⁴ mol per 1 mol of silver, at 10 minutes post initiation of the addition of the solution C and the solution D. Moreover, at 5 seconds after completing the addition of the solution C, a potassium hexacyanoferrate (II) in an aqueous solution was added in its entirety to give 3×10⁻⁴ mol per 1 mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-described silver halide dispersion was kept at 38° C. with stirring, and thereto was added 5 mL of a 0.34% by mass methanol solution of 1,2-benzoisothiazoline-3-one, followed by elevating the temperature to 47° C. at 40 minutes thereafter. At 20 minutes after elevating the temperature, sodium benzene thiosulfonate in a methanol solution was added at 7.6×10⁻⁵ mol per 1 mol of silver. At additional 5 minutes later, a tellurium sensitizer C in a methanol solution was added at 2.9×10⁻⁴ mol per 1 mol of silver and subjected to ripening for 91 minutes. Thereafter, a methanol solution of a spectral sensitizing dye A and a spectral sensitizing dye B with a molar ratio of 3:1 was added thereto at 1.2×10⁻³ mol in total of the spectral sensitizing dye A and B per 1 mol of silver. At 1 minute later, 1.3 mL of a 0.8% by mass methanol solution of N,N′-dihydroxy-N″,N″-diethylmelamine was added thereto, and at additional 4 minutes thereafter, 5-methyl-2-mercaptobenzimidazole in a methanol solution at 4.8×10⁻³ mol per 1 mol of silver, 1-phenyl-2-heptyl-5-mercapto-1,3,4-triazole in a methanol solution at 5.4×10⁻⁻³ mol per 1 mol of silver, and 1-(3-methylureidophenyl)-5-mercaptotetrazole in an aqueous solution at 8.5×10⁻³ mol per 1 mol of silver were added to produce a silver halide emulsion-1.

Grains in thus prepared silver halide emulsion were silver iodobromide grains having a mean equivalent spherical diameter of 0.042 μm, a variation coefficient of an equivalent spherical diameter distribution of 20%, which uniformly include iodine at 3.5 mol %. Grain size and the like were determined from the average of 1000 grains using an electron microscope. The {100} face ratio of these grains was found to be 80% using a Kubelka-Munk method.

<<Preparation of Silver Halide Emulsion-2>>

Preparation of silver halide emulsion-2 was conducted in a similar manner to the process in the preparation of the silver halide emulsion-1 except that: the temperature of the liquid upon the grain forming process was altered from 30° C. to 47° C.; the solution B was changed to that prepared through diluting 15.9 g of potassium bromide with distilled water to give the volume of 97.4 mL; the solution D was changed to that prepared through diluting 45.8 g of potassium bromide with distilled water to give the volume of 400 mL; time period for adding the solution C was changed to 30 minutes; and potassium hexacyanoferrate (II) was deleted. The precipitation/desalting/water washing/dispersion were carried out similarly to the silver halide emulsion-1. Furthermore, the spectral sensitization, chemical sensitization, and addition of 5-methyl-2-mercaptobenzimidazole and 1-phenyl-2-heptyl-5-mercapto-1,3,4-triazole was executed similarly to the emulsion-1 except that: the amount of the tellurium sensitizer C to be added was changed to 1.1×10⁻⁴ mol per 1 mol of silver; the amount of the methanol solution of the spectral sensitizing dye A and a spectral sensitizing dye B with a molar ratio of 3:1 to be added was changed to 7.0×10⁻⁴ mol in total of the spectral sensitizing dye A and the spectral sensitizing dye B per 1 mol of silver; the addition of 1-phenyl-2-heptyl-5-mercapto-1,3,4-triazole was changed to give 3.3×10⁻³ mol per 1 mol of silver; and the addition of 1-(3-methylureidophenyl)-5-mercaptotetrazole was changed to give 4.7×10⁻³ mol per 1 mol of silver, to produce silver halide emulsion-2. The grains in the silver halide emulsion-2 were pure cubic silver bromide grains having a mean equivalent spherical diameter of 0.080 μm and a variation coefficient of an equivalent spherical diameter distribution of 20%.

<<Preparation of Silver Halide Emulsion-3>>

Preparation of silver halide emulsion-3 was conducted in a similar manner to the process in the preparation of the silver halide emulsion-1 except that the temperature of the liquid upon the grain forming process was altered from 30° C. to 27° C. In addition, the precipitation/desalting/water washing/dispersion were carried out similarly to the silver halide emulsion-1. Silver halide emulsion-3 was obtained similarly to the emulsion-1 except that: the addition of the methanol solution of the spectral sensitizing dye A and the spectral sensitizing dye B was changed to the solid dispersion (aqueous gelatin solution) at a molar ratio of 1:1 with the amount to be added being 6.0×10⁻³ mol in total of the spectral sensitizing dye A and spectral sensitizing dye B per 1 mol of silver; the amount of the tellurium sensitizer C to be added was changed to 5.2×10⁻⁴ mol per 1 mol of silver; and bromoauric acid at 5×10⁻⁴ mol per 1 mol of silver and potassium thiocyanate at 2×10⁻³ mol per 1 mol of silver were added at 3 minutes following the addition of the tellurium sensitizer. The grains in the silver halide emulsion-3 were silver iodide bromide grains having a mean equivalent spherical diameter of 0.034 μm and a variation coefficient of an equivalent spherical diameter distribution of 20%, which uniformly include iodine at 3.5 mol %.

<<Preparation of Mixed Emulsion A for Coating Solution>>

The silver halide emulsion-1 at 70% by mass, the silver halide emulsion-2 at 15% by mass, and the silver halide emulsion-3 at 15% by mass were dissolved, and thereto was added a 1% by mass aqueous solution of benzothiazolium iodide to give 7×10⁻³ mol per 1 mol of silver. Further, water was added thereto to give the content of silver of 38.2 g per 1 kg of the mixed emulsion for a coating solution, and 1-(3-methylureidophenyl)-5-mercaptotetrazole was added to give 0.34 g per 1 kg of the mixed emulsion for a coating solution.

Further, as “a compound that can be one-electron-oxidized to provide a one-electron oxidation product, which releases one or more electrons”, the compounds Nos. 2, 20, and 26 were added respectively in an amount of 2×10⁻³ mol per 1 mol of silver contained in silver halide.

2) Preparations of Dispersion of Silver Salt of Fatty Acid

<Preparation of Recrystallized Behenic Acid>

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystalization was controlled to be 3° C./hour. The resulting crystal was subjected to centrifgal filtration, and washing was performed with 100 kg of isopropyl alcohol. Thereafter, the crystal was dried. The resulting crystal was esterified, and subjected to GC-FID analysis to give the results of the content of behenic acid being 96 mol %, lignoceric acid 2 mol %, and arachidic acid 2 mol %. In addition, erucic acid was included at 0.001 mol %.

<Preparation of Dispersion of Silver Salt of Fatty Acid>

88 kg of the recrystallized behenic acid, 422 L of distilled water, 49.2 L of 5 mol/L sodium hydroxide aqueous solution, 120 L of t-butyl alcohol were admixed, and subjected to a reaction with stirring at 75° C. for one hour to give a solution of sodium behenate. Separately, 206.2 L of an aqueous solution of 40.4 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution of sodium behenate and the total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. The addition of the solution of sodium behenate was thereafter started, and during 14 minutes and 15 seconds following the completion of adding the aqueous silver nitrate solution, the added material was restricted to the solution of sodium behenate alone. The temperature inside of the reaction vessel was then set to be 30° C., and the temperature outside was controlled so that the liquid temperature could be kept constant. In addition, the temperature of a pipeline for the addition system of the solution of sodium behenate was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the solution of sodium behenate was added and the position, at which the aqueous silver nitrate solution was added, was arranged symmetrically with a shaft for stirring located at a center. Moreover, both of the positions were adjusted to avoid contact with the reaction liquid.

After completing the addition of the solution of sodium behenate, the mixture was left to stand at the temperature as it was for 20 minutes. The temperature of the mixture was then elevated to 35° C. over 30 minutes followed by ripening for 210 minutes. Immediately after completing the ripening, solid matters were filtered out with centrifugal filtration. The solid matters were washed with water until the electric conductivity of the filtrated water became 30 μS/cm. A silver salt of fatty acid was thus obtained. The resulting solid matters were stored as a wet cake without drying.

When the shape of the resulting particles of the silver behenate was evaluated by an electron micrography, a crystal was revealed having a=0.21 μm, b=0.4 μm and c=0.4 μm on the average value, with a mean aspect ratio of 2.1, and a variation coefficient of an equivalent spherical diameter distribution of 11% (a, b and c are as defined aforementioned.).

To the wet cake corresponding to 260 kg of a dry solid matter content, were added 19.3 kg of polyvinyl alcohol (trade name: PVA-217) and water to give the total amount of 1000 kg. Then, a slurry was obtained from the mixture using a dissolver blade. Additionally, the slurry was subjected to preliminary dispersion with a pipeline mixer (manufactured by MIZUHO Industrial Co., Ltd.: PM-10 type).

Next, a stock liquid after the preliminary dispersion was treated three times using a dispersing machine (trade name: Microfluidizer M-610, manufactured by Microfluidex International Corporation, using Z type Interaction Chamber) with the pressure controlled to be 1150 kg/cm² to give a dispersion of the silver behenate. For the cooling manipulation, coiled heat exchangers were equipped in front of and behind the interaction chamber respectively, and accordingly, the temperature for the dispersion was set to be 18° C. by regulating the temperature of the cooling medium.

3) Preparations of Reducing Agent Dispersion

<<Reducing Agent-1 Dispersion>>

To 10 kg of reducing agent-1 (2,2′-methylenebis-(4-ethyl-6-tert-butylphenol)) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours. Thereafter, 0.2 g of a benzoisothiazolinone sodium salt and water were added thereto, thereby adjusting the concentration of the reducing agent to be 25% by mass. This dispersion was subjected to heat treatment at 60° C. for 5 hours to obtain reducing agent-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

<<Reducing Agent-2 Dispersion>>

To 10 kg of reducing agent-2 (6,6′-di-t-butyl-4,4′-dimethyl-2,2′-butylidenediphenol)) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minutes. Thereafter, 0.2 g of a benzoisothiazolinone sodium salt and water were added thereto, thereby adjusting the concentration of the reducing agent to be 25% by mass. This dispersion was warmed at 40° C. for one hour, followed by a subsequent heat treatment at 80° C. for one hour to obtain reducing agent-2 dispersion. Particles of the reducing agent included in the resulting reducing agent-2 dispersion had a median diameter of 0.50 μm, and a maximum particle diameter of 1.6 μm or less. The resultant reducing agent-2 dispersion was subjected to filtration with a polypropylene filter having a pore size of 3.0 μm to remove foreign substances such as dust, and stored.

4) Preparation of Hydrogen Bonding Compound-1 Dispersion

To 10 kg of hydrogen bonding compound-1 (tri(4-t-butylphenyl)phosphineoxide) and 16 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 4 hours. Thereafter, 0.2 g of a benzoisothiazolinone sodium salt and water were added thereto, thereby adjusting the concentration of the hydrogen bonding compound to be 25% by mass. This dispersion was warmed at 40° C. for one hour, followed by a subsequent heat treatment at 80° C. for one hour to obtain hydrogen bonding compound-1 dispersion. Particles of the hydrogen bonding compound included in the resulting hydrogen bonding compound dispersion had a median diameter of 0.45 μm, and a maximum particle diameter of 1.3 μm or less. The resultant hydrogen bonding compound dispersion was subjected to filtration with a polypropylene filter having a pore size of 3.0 μm to remove foreign substances such as dust, and stored.

5) Preparations of Development Accelerator-1 Dispersion

To 10 kg of development accelerator-1 and 20 kg of a 10% by mass aqueous solution of modified polyvinyl alcohol (manufactured by Kuraray Co., Ltd., Poval MP203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by mass. Accordingly, development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

6) Preparations of Dispersions of Development Accelerator-2 and Color-Tone-Adjusting Agent-1

Also concerning solid dispersions of development accelerator-2 and color-tone-adjusting agent-1, dispersion was executed in a similar manner to the development accelerator-1, and thus dispersions of 20% by mass and 15% by mass were respectively obtained.

7) Preparations of Organic Polyhalogen Compound Dispersion

<<Organic Polyhalogen Compound-1 Dispersion>>

10 kg of organic polyhalogen compound-1 (tribromomethane sulfonylbenzene), 10 kg of a 20% by mass aqueous solution of modified polyvinyl alcohol (manufactured by Kuraray Co., Ltd., Poval MP203), 0.4 kg of a 20% by mass aqueous solution of sodium triisopropylnaphthalenesulfonate and 14 kg of water were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzoisothiazolinone sodium salt and water were added thereto, thereby adjusting the concentration of the organic polyhalogen compound to be 26% by mass. Accordingly, organic polyhalogen compound-1 dispersion was obtained. Particles of the organic polyhalogen compound included in the resulting organic polyhalogen compound dispersion had a median diameter of 0.41 μm, and a maximum particle diameter of 2.0 μm or less. The resultant organic polyhalogen compound dispersion was subjected to filtration with a polypropylene filter having a pore size of 10.0 μm to remove foreign substances such as dust, and stored.

<<Organic Polyhalogen Compound-2 Dispersion>>

10 kg of organic polyhalogen compound-2 (N-butyl-3-tribromomethane sulfonylbenzoamide), 20 kg of a 10% by mass aqueous solution of modified polyvinyl alcohol (manufactured by Kuraray Co., Ltd., Poval MP203) and 0.4 kg of a 20% by mass aqueous solution of sodium triisopropylnaphthalenesulfonate were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzoisothiazolinone sodium salt and water were added thereto, thereby adjusting the concentration of the organic polyhalogen compound to be 30% by mass. This fluid dispersion was heated at 40° C. for 5 hours to obtain organic polyhalogen compound-2 dispersion. Particles of the organic polyhalogen compound included in the resulting organic polyhalogen compound dispersion had a median diameter of 0.40 μm, and a maximum particle diameter of 1.3 μm or less. The resultant organic polyhalogen compound dispersion was subjected to filtration with a polypropylene filter having a pore size of 3.0 μm to remove foreign substances such as dust, and stored.

8) Preparation of Phthalazine Compound-1 Solution

Modified polyvinyl alcohol MP203 (manufactured by Kuraray Co., Ltd.) in an amount of 8 kg was dissolved in 174.57 kg of water, and then thereto were added 3.15 kg of a 20% by mass aqueous solution of sodium triisopropylnaphthalenesulfonate and 14.28 kg of a 70% by mass aqueous solution of phthalazine compound-1 (6-isopropyl phthalazine) to prepare a 5% by mass phthalazine compound-1 solution.

9) Preparations of Aqueous Solution of Mercapto Compound

<<Aqueous Solution of Mercapto Compound-1>>

Mercapto compound-1 (1-(3-sulfophenyl)-5-mercaptotetrazole sodium salt) in an amount of 7 g was dissolved in 993 g of water to give a 0.7% by mass aqueous solution.

<Aqueous Solution of Mercapto Compound-2>

Mercapto compound-2 (1-(3-methylureidophenyl)-5-mercaptotetrazole) in an amount of 20 g was dissolved in 980 g of water to give a 2.0% by mass aqueous solution.

10) Preparation of SBR Latex Solution

To a polymerization tank of a gas monomer reaction apparatus (manufactured by Taiatsu Techno Corporation, TAS-2J type), were charged 287 g of distilled water, 7.73 g of a surfactant (Pionin A43-S (manufactured by TAKEMOTO OIL & FAT CO., LTD.): solid matter content of 48.5% by mass), 14.06 mL of 1 mol/L sodium hydroxide, 0.15 g of ethylenediarnine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Thereto was injected 108.75 g of 1,3-butadiene, and the inner temperature was elevated to 60° C. Thereto was added a solution of 1.875 g of ammonium persulfate dissolved in 50 mL of water, and the mixture was stirred for 5 hours as it stands. The temperature was further elevated to 90° C., followed by stirring for 3 hours. After completing the reaction, the inner temperature was lowered to reach to the room temperature, and thereafter the mixture was treated by adding 1 mol/L sodium hydroxide and ammonium hydroxide to give the molar ration of Na⁺ ion: NH₄⁺ ion=1:5.3, and thus, the pH of the mixture was adjusted to 8.4. Thereafter, filtration with a polypropylene filter having the pore size of 1.0 μm was conducted to remove foreign substances such as dust followed by storage. Accordingly, SBR latex was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had a mean particle diameter of 90 nm, Tg of 17° C., solid matter concentration of 44% by mass, the equilibrium moisture content at 25° C. and 60% RH of 0.6% by mass, ionic conductance of 4.80 mS/cm (measurement of the ionic conductance performed using a conductivity meter CM-30S manufactured by Toa Electronics Ltd. for the latex stock solution (44% by mass) at 25° C.).

2. Preparation of Coating Solution

1) Preparation of Coating Solution for Image Forming Layer

To 1000 g of the fatty acid silver salt dispersion were successively added the organic polyhalogen compound-1 dispersion, the organic polyhalogen compound-2 dispersion, the phthalazine compound-1 solution, the SBR latex (Tg: 17° C.) solution, the reducing agent-1 dispersion, the reducing agent-2 dispersion, the hydrogen bonding compound-1 dispersion, the development accelerator-1 dispersion, the mercapto compound-1 aqueous solution, the mercapto compound-2 aqueous solution, and distilled water. Immediately before application thereof, the silver halide mixed emulsion A was added thereto and then the components were sufficiently mixed. The resultant image forming layer coating solution was sent, as it was, to a coating die.

2) Preparation of Coating Solution for Intermediate Layer

Water was added to 1000 g of a polyvinyl alcohol PVA-205 (manufactured by Kuraray Co., Ltd.), 163 g of the pigment-1 dispersion, 27 ml of a 5% solution of a sodium salt of di(2-ethylhexyl)sulfosuccinate in water, 4200 mL of a 19% by mass latex solution of a methyl methacrylate/styrene/butyl acrylate/hydroxyethyl methacrylate/acrylic acid copolymer (copolymerization ratio by mass: 57/8/28/5/2), 27 mL of a 5% by mass solution of an aerosol (trade name: Aerosol OT, manufactured by American Cyanamid Co.), and 135 mL of a 20% by mass solution of diammonium phthalate, so as to set the total weight to 10000 g. The pH of the solution was adjusted into 7.5 with NaOH, so as to prepare an intermediate layer coating solution. This solution was sent to the coating die so as to give a coating amount of 8.9 mL/m².

The viscosity of the coating solution was 58 mPa.s at 40° C. with a B type viscometer (using a No. 1 rotor at 60 rpm).

3) Preparation of Coating Solution for First Surface Protective Layer

Into 840 mL of water were dissolved 100 g of inert gelatin and 10 mg of benzoisothiazolinone, and then the following were added to the solution and mixed: 180 g of a 19% by mass latex of a methyl methacrylate/styrene/butyl acrylate/hydroxyethyl methacrylate/acrylic acid copolymer (copolymerization ratio by mass: 57/8/28/5/2), 46 mL of a 15% by mass solution of phthalic acid in methanol, and 5.4 mL of a 5% by mass solution of a sodium salt of di(2-ethylhexyl) sulfosuccinate in water. Immediately before application thereof, 40 mL of 4% by mass chromium alum was mixed with the above-mentioned solution by means of a static mixer, and the mixture was sent to the coating die so as to give a coating solution amount of 26.1 mL/m².

The viscosity of the coating solution was 20 mPa.s at 40° C. with a B type viscometer (using a No. 1 rotor at 60 rpm).

4) Preparation of Coating Solution for Second Surface Protective Layer

Into 800 mL of water were dissolved 100 g of inert gelatin and 10 mg of benzoisothiazolinone, and then the following were added to the solution and mixed: 8.0 g of a liquid paraffin emulsion as a liquid paraffin, 180 g of a 19% by mass latex solution of a methyl methacrylate/styrene/butyl acrylate/hydroxyethyl methacrylate/acrylic acid copolymer (copolymerization ratio by mass: 57/8/28/5/2), 40 mL of a 15% by mass solution of phthalic acid in methanol, 5.5 mL of a 1% by mass solution of the fluorine-containing surfactant (F-1), 5.5 mL of a 1% by mass solution of the fluorine-containing surfactant (F-2), 28 mL of a 5% by mass solution of a sodium salt of di(2-ethylhexyl)sulfosuccinate in water, 4 g of polymethyl methacrylate fine particles (mean particle diameter: 0.7 μm), and 21 g of polymethyl methacrylate fine particles (mean particle diameter: 4.5 μm). The thus-obtained surface protective layer coating solution was sent to the coating die so as to give a coating solution amount of 8.3 m]L/m².

The viscosity of the coating solution was 19 mPa.s at 40° C. with a B type viscometer (using a No. 1 rotor at 60 rpm).

3. Formation of Photothermographic Materials

1) Formation of Photothermographic Materials 101 to 110

The image forming layer coating solution, the intermediate layer coating solution, the first surface protective layer coating solution and the second surface protective layer coating solution were applied onto the face opposite to the back face, in order of the described solutions from on the undercoated face, by simultaneous multi-coating in a slide bead manner, so as to form a sample of each photothermographic material. The resultant samples corresponding to the back layers 1 to 10 were named samples 101 to 110, respectively. At this time, the temperatures of the image forming layer coating solution and the intermediate layer coating solution were adjusted to 31° C., and the temperature of the first surface protective layer coating solution and that of the second surface protective layer coating solution were adjusted to 36° C. and 37° C., respectively.

The coating amount (g/m²) of each of the compounds in the image forming layer was as follows:
Fatty acid silver salt 5.42
Polyhalogen compound-1 0.12
Polyhalogen compound-2 0.25
Phthalazine compound-1 0.18
SBR latex 9.70
Reducing agent-b 1 0.40
Reducing agent-2 0.40
Hydrogen bonding compound 0.58
Development accelerator-1 0.019
Development accelerator-2 0.016
Mercapto compound-1 0.002
Mercapto compound-2 0.012
Silver halide (as the amount of Ag) 0.10

Conditions for the coating and drying are as follows.

The coating was performed at a rate of 160 m/min. The interval between the tip of the coating die and each of the supports was set into the range of 0.10 mm to 0.30 mm, and the pressure in a pressure-reduced chamber was set to a pressure 196Pa-882 Pa lower than the atmospheric pressure. The support was exposed to ionizing wind before the coating to remove electrical charge therefrom. Subsequently, the applied solutions were cooled with wind having a dry-bulb temperature of 10 to 20° C. in a chilling zone, and then the support was shifted to a helical non-contact type drying machine by non-contact type conveyance. In this machine, the applied solutions were dried with dry wind having a dry-bulb temperature of 23° C. to 45° C. and a dry-bulb temperature of 15° C. to 21° C. After the drying, the resultant was conditioned at 25° C. and a humidity of 40% to 60% RH, and then heated to set the temperature of the film face thereof into the range of 70° C. to 90° C. Thereafter, the film face was cooled to 25° C.

About the mat degree of the formed photothermographic material, the image forming layer side surface thereof had a Bekk smoothness of 550 seconds, and the back face thereof had a Bekk smoothness of 130 seconds. The pH of the image forming layer side surface was measured. It was 6.0.

Chemical structures of the compounds used in the working examples of the invention are illustrated below.

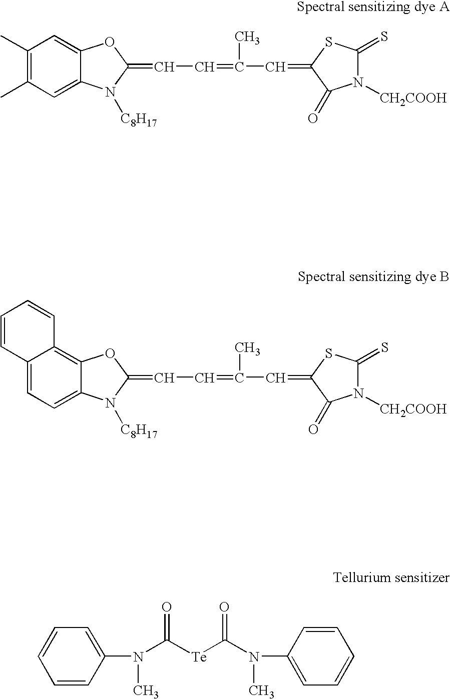

Compound 2 that can be one-electron-oxidized to provide a one-electron oxidation product, which releases one or more electrons

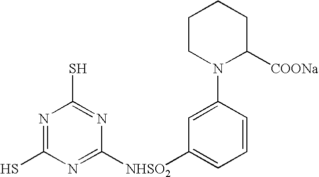

Compound 20 that can be one-electron-oxidized to provide a one-electron oxidation product, which releases one or more electrons

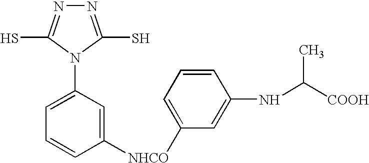

Compound 26 that can be one-electron-oxidized to provide a one-electron oxidation product, which releases one or more electrons 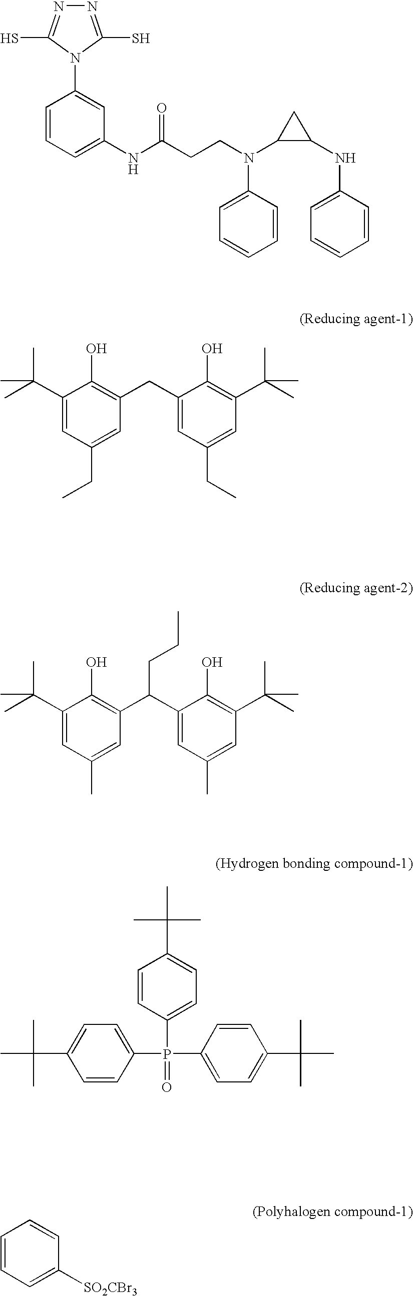 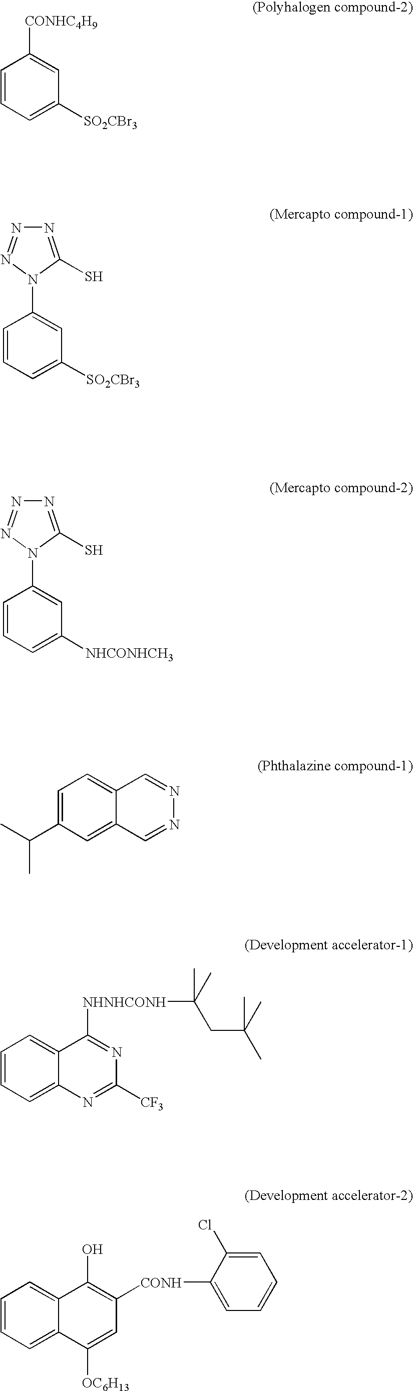 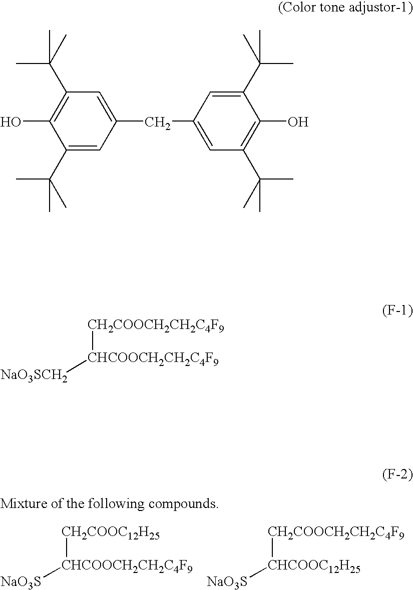
4. Evaluation of Photographic Performances
1) Preparation

Each of the resultant samples was cut into a half cut size, and wrapped with the following wrapping material at 25° C. and 50% RH. The resultant was stored at ambient temperature for 2 weeks to evaluate the following items.

<Wrapping Material>

Laminate film made of PET (10 μm)/PE (12 μm)/aluminum foil (9 μm)/Ny (15 μm)/polyethylene containing 20% by mass of carbon (50 μm) having the following properties:

oxygen permeability: 0.02 mL/atm·m²·25° C.·day, and

water permeability: 0.10 g/atm·m²·25° C.·day.

2) Exposure of Photothermographic Materials to Light, and Development Thereof

Each of the samples was exposed to light with a Dry Laser Imager DRYPIX 7000 (having a mounted 660-nm semiconductor laser giving a maximum power of 50 mW (IIIB)) manufactured by Fuji Film Medical Co., Ltd., and thermally developed (with three panel heaters, the temperatures of which were set to 107° C., 121° C. and 121 ° C, respectively, in a total time of 14 seconds). The resultant image was evaluated with a densitometer.

3) Evaluated Items

<Fogging>

The density of the region exposed to no laser in the developed sample was rendered Dmin.

<Color Tone of Highlight Region>

Highlight regions of the resultant images were subjected to sensory evaluation by five examinees. The score of the sample regarded as relatively preferred one was rendered 10. Evaluation scores of each of the samples were averaged, and the average color tone evaluation thereof was ranked into one out of 5 levels. The results are shown in Table 1. Level 5 is most preferred, level 1 is poorest, and level 3 is poorer than level 5, but is a level such that no problem is caused for practical use.

<Discoloration Defect Test>

This is a test for examining color unevenness generated when water droplets adhere to the image formed on each of the samples.

A water droplet of 0.5 cc volume was dropped on each of the image forming layer side surface and the back layer surface of each of the thermally-developed sensitive materials. After 10 seconds, the water droplets were wiped out. At this time, a sensory evaluation was made about the degree of discoloration defects so as to rank the degree into one out of 5 levels. Level 5 is most preferred, level 1 is poorest, and level 3 is poorer than level 5, but is a level such that no problem is caused for practical use.

<Sharpness>

Each of the samples was subjected to exposure based on an exposure pattern having a density of 1.2 on a high density side thereof and a density of 0.7 on a low density side thereof When this exposure was defined as one set, ten sets of exposures were performed. In each of the ten sets, two kinds of exposures were performed, wherein a pattern width of 2 cm and that of 1 cm were used. The density difference between the high density side and the low density side when the width of 2 cm was used to make the exposure was regarded as 100; the value of the density difference when the width of 1 cm was used to make the exposure was represented as a value relative thereto. Each of the densities was measured with a micro-densitometer having an aperture diameter of 50 μm.

<Image Storability>

A change in the color tone of the highlight region of each of the samples was evaluated after it was stored.

The sample was cut, in the highlight regions thereof, into halves. One of the halves was stored in a refrigerator while the other was allowed to stand still on a desk in a room conditioned into a temperature of 25° C. and a humidity of 60% RH under a luminance of 1000 lux from a fluorescent lamp, so as not to overlap with any other sample.

Thereafter, the sample stored in the refrigerator was shifted to a dark place so as to return the temperature thereof to room temperature. The two were arranged on a standard light box, and the degree of change in the highlight color tone was subjected to sensory evaluation with the naked eye. The result was ranked into one out of 5 levels.

Level 5 is a level such that a problem is not caused at all, level 1 is a level such that a problem is caused for practical use, and level 3 is the lowest level out of levels such that no problem is caused for practical use.

4) Results

The obtained results are shown in Table 2

The samples of the invention were low in the degree of fogging and excellent in color tone, and had excellent performances for preventing discoloration defects and improving sharpness and image storability.

TABLE 2

| | | | Dis- | | | |
|---|---|---|---|---|---|---|
| Sample | Fog- | Color | coloration | Sharp- | Image | |
| No. | ging | tone | defect | ness | storability | Notes |
| 1 | 0.19 | 2 | 5 | 90 | 2 | Comparative |
| | | | | | | Example |
| 2 | 0.17 | 4 | 2 | 91 | 2 | Comparative |
| | | | | | | Example |
| 3 | 0.17 | 5 | 5 | 96 | 5 | The invention |
| 4 | 0.17 | 5 | 5 | 95 | 5 | The invention |
| 5 | 0.17 | 4 | 4 | 95 | 4 | The invention |
| 6 | 0.17 | 5 | 4 | 94 | 5 | The invention |
| 7 | 0.17 | 5 | 5 | 94 | 5 | The invention |
| 8 | 0.17 | 4 | 4 | 95 | 4 | The invention |
| 9 | 0.17 | 5 | 4 | 95 | 4 | The invention |
| 10 | 0.17 | 5 | 5 | 94 | 5 | The invention |
| 11 | 0.17 | 4 | 5 | 95 | 4 | The invention |
| 12 | 0.17 | 5 | 5 | 95 | 4 | The invention |

### Example 2

1. Preparation of Samples

Samples No. 21 to No. 30 were each prepared in the same way for preparing the sample No. 3 in Example 1 except that each polymer latex shown in Table 3 was added to the back layer.

2. Performance Evaluation

About the resultant samples, the same performance evaluation as in Example 1 was made. The results are shown in Table 3. All of the samples exhibited excellent performances in the same manner as in Example 1.

Furthermore, the curl property and the conveyability thereof were evaluated by the following methods. The results are also shown in Table 3.

1) Curling Property Evaluation

The samples were each cut into a 25×35 cm sheet. The sheet was subjected to the above-mentioned thermal development. Thereafter, the sheet was put onto a flat stand at 25° C. and 80% RH in the state that the image forming layer surface thereof was faced upward. About each of the four corners of the sheet, the height thereof from the stand was measured. The value obtained by averaging the four measured values was defined as the curl value of the sample.

2) Conveyability Evaluation

A part of its conveying rollers was adjusted to make the nip pressure therebetween small using the dry laser imager DRYPIX 7000 manufactured by FujiFilm Medical Co., Ltd. thereby setting the device into a condition that conveyance failure would easily be caused. Under the condition, the samples were each subjected to the same thermal development as in Example 1.

For each of the samples, 100 sheets were processed. The evaluation value of the conveyability was determined based on the number of the sheets which conveyance failure was caused.

The obtained results are also shown in Table 3.

The results in Table 3 demonstrate that the samples containing the polymer latex of the invention favorably had good curl balance so as to be flat in various environments. On the other hand, the comparative samples gave a large curl, so that conveyance failure was caused.

TABLE 3

| | | Polymer latex | | | | Color | | | | | |
|---|---|---|---|---|---|---|---|---|---|---|---|
| | Back | | | Addition | | falling- | | | | | |
| Sample | layer | | | amount | | out | | Image | | Convey- | |
| No. | No. | Kind | Tg(° C.) | (mg/m²) | Fogging | failure | Sharpness | storability | Curl | ability | Notes |
| 3 | 3 | — | — | — | 0.17 | 4 | 96 | 5 | 3 | 5 | Present |
| | | | | | | | | | | | invention |
| 21 | 21 | L-1 | −23 | 100 | 0.17 | 5 | 96 | 5 | 4 | 1 | Present |
| | | | | | | | | | | | invention |
| 22 | 22 | L-1 | −23 | 200 | 0.17 | 5 | 96 | 5 | 5 | 0 | Present |
| | | | | | | | | | | | invention |
| 23 | 23 | L-1 | −23 | 500 | 0.17 | 5 | 96 | 5 | 5 | 0 | Present |
| | | | | | | | | | | | invention |
| 24 | 24 | L-2 | −58 | 100 | 0.17 | 5 | 96 | 5 | 5 | 2 | Present |
| | | | | | | | | | | | invention |
| 25 | 25 | L-2 | −58 | 200 | 0.17 | 5 | 96 | 5 | 5 | 1 | Present |
| | | | | | | | | | | | invention |
| 26 | 26 | L-3 | 26 | 100 | 0.17 | 5 | 96 | 5 | 4 | 0 | Present |
| | | | | | | | | | | | invention |
| 27 | 27 | L-3 | 26 | 200 | 0.17 | 5 | 96 | 5 | 5 | 0 | Present |
| | | | | | | | | | | | invention |
| 28 | 28 | L-32 | 10 | 100 | 0.17 | 5 | 96 | 5 | 4 | 0 | Present |
| | | | | | | | | | | | invention |
| 29 | 29 | L-32 | 10 | 200 | 0.17 | 5 | 96 | 5 | 5 | 0 | Present |
| | | | | | | | | | | | invention |
| 30 | 30 | L-32 | 10 | 500 | 0.17 | 5 | 96 | 5 | 5 | 0 | Present |
| | | | | | | | | | | | invention |

According to the invention, provided is a photothermographic material which gives high image quality and an excellent image storability.

What is claimed is:

1. A photothermographic material comprising, on at least one side of a support, an image forming layer comprising a photosensitive silver halide, a non-photosensitive organic silver salt and a reducing agent for the organic silver salt, and at least one non-photosensitive layer, wherein the photothermographic material comprises a water-soluble dye and a fixing agent for the water-soluble dye.

2. The photothermographic material according to claim 1, wherein the fixing agent is at least one selected from compounds having a tertiary amino group or a quaternary amino group, and polyvalent metal salts.

3. The photothermographic material according to claim 2, wherein the fixing agent is a polymer compound comprising at least one vinyl monomer unit having a tertiary amino group or a quaternary amino group and represented by the following formulae (FX-1), (FX-2), (FX-3) or (FX-4): 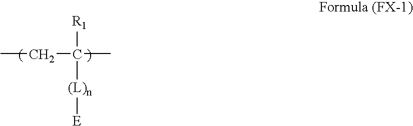
wherein R₁ represents a hydrogen atom or a lower alkyl group having 1 to 6 carbon atoms; L represents a bivalent linking group having 1 to 20 carbon atoms; E represents a heterocyclic group containing, as a constituent component thereof, a nitrogen atom having a double bond to a carbon atom; and n is 0 or 1; 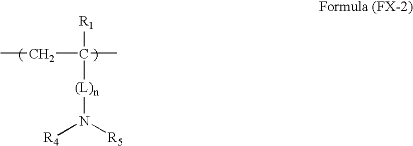
wherein R₁, L and n have the same respective meanings as in the formula (FX-1); and R₄ and R₅ each independently represent an alkyl group having 1 to 12 carbon atoms, or an aralkyl group having 7 to 20 carbon atoms, and R₄ and R₅ may link to each other to form, together with a nitrogen atom, a cyclic structure; 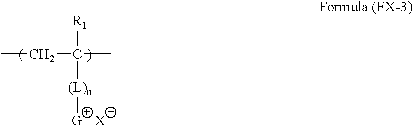
wherein R₁, L and n have the same respective meanings as in the formula (FX-1); G⁺ represents a heterocycle containing, as a constituent component thereof, a quaternary nitrogen atom having a double bond to a carbon atom; and X⁻ represents a monovalent anion; 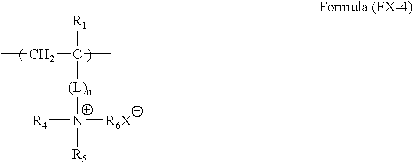
wherein R₁, L and n have the same respective meanings as in the formula (FX-1); R₄ and R₅ have the same respective meanings as in the formula (FX-2); R₆ is selected from the same groups as represented by R₄ and R₅; X⁻ has the same meaning as in the formula (FX-3); and any of R₄, R₅ and R₆ may link to each other to form, together with a nitrogen atom, a cyclic structure.

4. The photothermographic material according to claim 2, wherein the fixing agent is a cationic surfactant or a betaine surfactant.

5. The photothermographic material according to claim 2, wherein the fixing agent is the polyvalent metal salt.

6. The photothermographic material according to claim 1, wherein the image forming layer comprises the water-soluble dye and the fixing agent for the water-soluble dye.

7. The photothermographic material according to claim 1, wherein the non-photosensitive layer comprises the water-soluble dye and the fixing agent for the water-soluble dye.

8. The photothermographic material according to claim 7, wherein the non-photosensitive layer is a back layer.

9. The photothermographic material according to claim 1, wherein the water-soluble dye is a metal phthalocyanine dye represented by the following formula (PC-1): 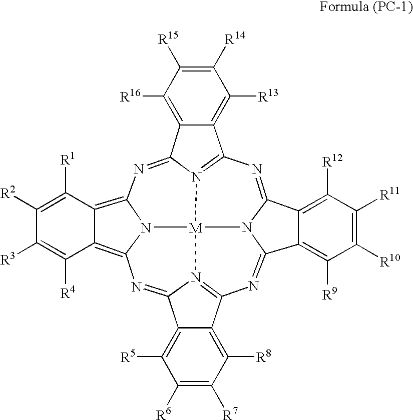
wherein M represents a metal atom; R¹, R⁴, R⁵, R⁸, R⁹, R¹², R¹³ and R¹⁶ each independently represent a hydrogen atom or a substituent, and at least one out of R¹, R⁴, R⁵, R⁸, R⁹, R¹², R¹³ and R¹⁶ is an electron-attracting group; and R², R³, R⁶, R⁷, R¹⁰, R¹¹, R¹⁴ and R¹⁵ each independently represent a hydrogen atom or a substituent.

10. The photothermographic material according to claim 9, wherein at least one out of R¹, R⁴, R⁵, R⁸, R⁹, R¹², R¹³ and R¹⁶ in the metal phthalocyanine represented by the formula (PC-1) is a group represented by the following formula (II):
-L¹-R¹⁷ Formula (II)
wherein L¹ represents **—SO₂—*, **—SO₃—*, **—SO₂NR_{N}—*, **—SO—*, **—CO—*, **—CONR_{N}—*, **—COO—*, **—COCO—*, **—COCO₂—*, or **—COCONR_{N}—* wherein ** means that the group links to the phthalocyanine skeleton at this position, * means that the group links to R¹⁷ at this position, and R_{N} represents a hydrogen atom, an alkyl group, an aryl group, a heterocyclic group, an acyl group, an alkoxycarbonyl group, a carbamoyl group, a sulfonyl group, or a sulfamoyl group; and R¹⁷ represents a hydrogen atom, an alkyl group, an aryl group or a heterocyclic group.

11. The photothermographic material according to claim 10, wherein four or more out of R¹, R⁴, R⁵, R⁸, R⁹, R¹², R¹³ and R¹⁶ in the metal phthalocyanine compound represented by the formula (PC-1) are each a group represented by the formula (II).

12. The photothermographic material according to claim 1, wherein the layer containing the fixing agent contains a polymer latex.

13. The photothermographic material according to claim 12, wherein the polymer latex contains, as a monomer component, 3% or more by mole of a monomer having a dissociating group.

14. The photothermographic material according to claim 12, wherein the glass transition temperature (Tg) of the polymer latex is from −30 to 30° C.

15. The photothermographic material according to claim 12, wherein the layer containing the fixing agent contains the polymer latex in an amount of 5% to 40% by mass with respect to a binder in the layer.
